(19) United States
(12) Patent Application Publication
(10) Pub. No.: US 2005/0057941 A1
(43) Pub. Date: Mar. 17, 2005

(54) 360 Degree pod warning light signal

(75) Inventors: John C. Pederson, St. Cloud, MN (US); Greg Pederson, Sartell, MN (US); Roman Marjamaa, St. Cloud, MN (US)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: 911EP, Inc., Jacksonville Beach, FL (US)

(21) Appl. No.: 10/625,387

(22) Filed: Jul. 23, 2003

Related U.S. Application Data
(63) Continuation-in-part of application No. 10/017,348, filed on Dec. 14, 2001, now Pat. No. 6,623,151.
(63) Continuation-in-part of application No. 09/627,867, filed on Jul. 28, 2000, now Pat. No. 6,461,008.
(60) Provisional application No. 60/292,470, filed on May 21, 2001.
(60) Provisional application No. 60/147,240, filed on Aug. 4, 1999.

(51) Int. Cl. B60Q 1/26

(52) U.S. Cl. 362/542

(57) ABSTRACT

A light emitting diode (LED) 360 degree pod warning signal light is disclosed. The 306 degree pod includes a controller for generating a plurality of observable light signals. The controller may regulate the illumination of LED's to a desired pattern, sequence, and/or combination of simultaneous and/or individual light signals. The 360 degree pod includes a support frame which is adapted to receivingly hold an LED light source assembly through the use of affixation clips. A plurality of light directors are positioned proximate to the LED Light sources which in conjunction with the cover function to direct and focus the light emitted from the LED's in a desired direction or area.

The present invention is a Continuation-In-Part Application of, and claims priority to, U.S. patent application Ser. No. 10/017,348 entitled “DOUBLE LIGHT BAR” filed Dec. 14, 2001, which is a utility patent application claiming priority to U.S. Provisional Patent Application entitled “DOUBLE LIGHT BAR” Ser. No. 60/292,470 filed May 21, 2001, and which is a Continuation-In-Part of U.S. utility application Ser. No. 09/627,867 filed Jul. 29, 2000, entitled “LED LIGHT BAR” which claimed priority to U.S. provisional application Ser. No. 60/147,240 filed Aug. 4, 1999, entitled “ALLEY LIGHT, TAKE-DOWN LIGHT, INTERSECTION CLEARING LIGHT, LIGHT BAR, PERSONAL WARNING SIGNAL LIGHT, AND PAR 36 LED LAMP” all of which are incorporated herein by reference in their entireties.

### BACKGROUND OF THE INVENTION

Emergency lights of the type used on emergency vehicles such as fire trucks, police cars, motorcycles, snow plows, highway maintenance vehicles, dump trucks and/or ambulances, utilize warning signal lights to produce a variety of light signals. These light signals may involve the use of various colors and patterns. Generally, these warning signal lights in the past have been formed of incandescent and halogen light sources having reflective back support members and colored filters.

Many problems exist with the known methods for producing warning light signals. One particular problem with known light sources is their reliance on mechanical components to revolve or oscillate the lamps to produce the desired light signal or lighting effect. Additionally, these components increase the size of the light bar or emergency light support which may adversely affect the vehicles aerodynamic characteristics. Moreover, because of the relatively poor reliability of conventional lighting, and the complexity of the present strobe rotational systems, there is an increased likelihood that a breakdown of the light bar or light source will occur requiring the repair or replacement of the defective component. Finally, conventional light bars and light supports require a relatively large amount of electrical current during operation. The demands upon the electrical power system for a vehicle may therefore exceed available electrical resources reducing optimization of performance or worse, generating a potential hazard from shorted or over heated systems.

Halogen lamps or gaseous discharge xenon lamps generally emanate large amounts of heat which is difficult to dissipate from a sealed light enclosure or emergency light and which may damage the electronic circuitry contained therein. In addition, these lamps consume large amounts of current requiring a large power supply, battery, or electrical source which may be especially problematic for use with a vehicle. These lamps also generate substantial electromagnetic emissions which may interfere with radio communications for a vehicle. Finally, these lamps, which are not rugged, have relatively short life cycles necessitating frequent replacement.

Another problem with the known warning signal lights is the use of filters to produce a desired color. Filtering techniques produce more heat that must be dissipated. Moreover, changing the color of a light source requires the physical removal of the filter from the light source or emergency light and the replacement with a new filter. Furthermore, filters fade or flake over time rendering the filters unable to consistently produce a desired color for observation in an emergency situation.

These problems associated with traditional signaling lamps are exacerbated by the fact that creating multiple light signals requires multiple signaling lamps. Further, there is little flexibility in modifying the light signal created by a lamp. For example, changing a stationary lamp into one that rotates or oscillates would require a substantial modification to the light bar or light support which may not be physically or economically possible.

The present invention generally relates to electrical lamps and to high brightness light-emitting diode or “LED” technology which operates to replace gaseous discharge or incandescent lamps as used with vehicle warning signal light sources.

In the past, the xenon gaseous discharge lamps have utilized a sealed compartment, usually a gas tube, which may have been filled with a particular gas known to have good illuminating characteristics. One such gas used for this purpose was xenon gas, which provides illumination when it becomes ionized by the appropriate voltage application. Xenon gas discharge lamps are used in the automotive industry to provide high intensity lighting and are used on emergency vehicles to provide a visible emergency signal light.

A xenon gas discharge lamp usually comprises a gas-filled tube which has an anode element at one end and a cathode element at the other end, with both ends of the tube being sealed. The anode and cathode elements each have an electrical conductor attached, which passes through the sealed gas end of the lamp exterior. An ionizing trigger wire is typically wound in a helical manner about the exterior of the glass tube, and this wire is connected to a high voltage power source typically on the order of 10-12 kilowatts (kw). The anode and cathode connections are connected to a lower level voltage source which is sufficient to maintain illumination of the lamp once the interior gas has been ionized by the high voltage source. The gas remains ignited until the anode/cathode voltage is removed; and once the gas ionization is stopped, the lamp may be ignited again by reapplying the anode/cathode voltage and reapplying the high voltage to the trigger wire via a voltage pulse.

Xenon gas lamps are frequently made from glass tubes which are formed into semicircular loops to increase the relative light intensity from the lamp while maintaining a relatively small form factor. These lamps generate extremely high heat intensity, and therefore, require positioning of the lamps so as to not cause heat buildup in nearby components. The glass tube of a xenon lamp is usually mounted on a light-based pedestal which is sized to fit into an opening in the light fixture and to hold the heat generating tube surface in a light fixture compartment which is separated from other interior compartment surfaces or components. In a vehicle application, the light and base pedestal are typically sized to fit through an opening in the light fixture which is about 1 inch in diameter. The light fixture component may have a glass or plastic cover made from colored material so as to produce a colored lighting effect when the lamp is ignited. Xenon gas discharge lamps naturally produce white light, which may be modified to produce a colored light, of lesser intensity, by placing the xenon lamp in a fixture having a colored lens. The glass tube of the xenon lamp may also be painted or otherwise colored to produce a similar result, although the light illumination from the tube tends to dominate the coloring; and the light may actually have a colored tint appearance rather than a solid colored light. The color blue is particularly hard to produce in this manner.

Because a preferred use of xenon lamps is in connection with emergency vehicles, it is particularly important that the lamp be capable of producing intense coloring associated with emergency vehicles, i.e., red, blue, amber, green, and clear.

When xenon lamps are mounted in vehicles, some care must be taken to reduce the corroding effects of water and various chemicals, including road salt, which might contaminate the light fixture. Corrosive effects may destroy the trigger wire and the wire contacts leading to the anode and cathode. Corrosion is enhanced because of the high heat generating characteristics of the lamp which may heat the air inside the lamp fixture when the lamp is in use, and this heated air may condense when the lamp is off resulting in moisture buildup inside the fixture. The buildup of moisture may result in the shorting out of the electrical wires and degrade the performance of the emission wire, sometimes preventing proper ionization of the gas within the xenon gas discharge lamp.

Another problem with the known warning signal lights is the use of rotational and/or oscillating mechanisms which are utilized to impart a rotational or oscillating movement to a light source for observation during emergency situations. These mechanical devices are frequently cumbersome and difficult to incorporate and couple onto various locations about a vehicle due to the size of the device. These mechanical devices also frequently require a relatively large power source to impart rotational and/or oscillating movement for a light source.

Another problem with the known warning signal lights is the absence of flexibility for the provision of variable illumination intensity for the light sources to increase the number of available distinct and independent visual light effects. In certain situations it may be desirable to provide variable illumination intensity for a light signal, or a modulated illumination intensity for a light signal, to provide a unique light effect to facilitate observation by an individual. In addition, the provision of a variable or modulated light intensity for a light signal may further enhance the ability to provide a unique desired light effect for observation by an individual.

No known warning light systems utilize a variable or modulated light intensity to modify a standard lighting effect nor do they have the design flexibility to easily make those changes. The warning lights as known are generally limited to a flashing light signal. Alternatively, other warning signal lights may provide a sequential illumination of light sources. No warning or utility light signals are known which simultaneously provide for modulated and/or variable light intensity for a known type of light signal to create a unique and desirable type of lighting effect or combination light effect.

No warning signal lights are known which provide irregular or random light intensity to a warning signal light to provide a desired lighting effect. Also, no warning light signals are known which provide a regular pattern of variable or modulated light intensity for a warning signal light to provide a desired type of lighting effect. It has also not been known to provide a warning light signal which combines either irregular variable light intensity or regular modulated light intensity to provide a unique and desired combination lighting effect.

It has also not been known to provide alternative colored LED light sources which may be electrically controlled for the provision of any desired pattern of light signal such as flashing, pulsating, oscillating, modulating, variable, rotational, alternating, strobe, sequential, and/or combination light effects. In this regard, a need exists to provide a spatially and electrically efficient LED light source for use on an emergency or utility vehicle which provides the appearance of rotation, or other types of light signals.

In view of the above, there is a need for a warning signal light that:
(1) Is capable of producing multiple light signals;
(2) Produces the appearance of a revolving or oscillating light signal without reliance upon mechanical components;
(3) Generates little heat;
(4) Uses substantially less electrical current;
(5) Produces significantly reduced amounts of electromagnetic emissions;
(6) Is rugged and has a long life cycle;
(7) Produces a truer light output color without the use of filters;
(8) Is positionable at a variety of locations about an emergency vehicle; and
(9) Provides variable light intensity to the light source.

Other problems associated with the known warning signal lights relate to the restricted positioning of the signal light on a vehicle due to the size and shape of the light support. In the past, light supports due to the relatively large size of light bars or light supports, were required to be placed on the roof of a vehicle or at a location which did not interfere with, or obstruct, an operator's ability to visualize objects while seated in the interior of the vehicle. Light bars or light supports generally extended perpendicular to the longitudinal axis of a vehicle and were therefore more difficult to observe from the sides by an individual.

The ease of visualization of an emergency vehicle is a primary concern to emergency personnel regardless of the location of the observer. In the past, optimal observation of emergency lights has occurred when an individual was either directly in front of, or behind, an emergency vehicle. Observation from the sides, or at an acute angle relative to the sides, frequently resulted in reduced observation of emergency lights during an emergency situation. A need therefore exists to improve the observation of emergency lights for a vehicle regardless of the location of the observer. A need also exists to improve the flexibility of placement of emergency lights upon a vehicle for observation by individuals during emergency situations.

A need exists to reduce the size of light supports on an emergency vehicle and to improve the efficiency of the light sources particularly with respect to current draw and reduced aerodynamic drag. In addition, the flexibility for the positioning of the light sources about a vehicle for observation by individuals is required to be enhanced in order to optimize utility for a warning signal light. In order to satisfy these and other needs, more spatially efficient light sources such as LED's are required.

In the past, illumination of an area to the front or to the sides of an emergency vehicle during low light conditions has been problematic. Take-down lights have been utilized by law enforcement personnel for a number of purposes including, but not necessarily limited to, enhancing observation of an individual in a vehicle on a roadway subject to investigation and to hide the location of an officer, or to block or deter observation of an officer by individuals during law enforcement activities.

A need exists for an LED take-down light which has significant illumination characteristics, is spatially efficient, has a long useful life, and has reduced current draw requirements for use on a law enforcement or utility vehicle.

The alley lights as known also suffer from the deficiencies as identified for the take-down lights during dark illumination conditions. Alley lights are used to illuminate areas adjacent to the sides of a vehicle.

In the past, the intersection clearing lights have been predominately formed of halogen, incandescent, and/or gaseous discharge xenon illumination sources. A need exists for an intersection clearing light which solves these and other identified problems.

A problem has also existed with respect to the use of emergency lights on unmarked law enforcement vehicles. In the past, emergency lights for unmarked law enforcement vehicles have consisted of dome devices which are formed of revolving mechanisms. These lights are usually withdrawn from a storage position under a motor vehicle seat for placement upon dashboard of a law enforcement vehicle. In undercover situations it has been relatively easy to identify dashboard affixation mechanisms used to secure these types of dome illumination devices to a dashboard. The known dome devices are also clumsy, have large current draw requirements, and are difficult to store in a convenient location for retrieval in an emergency situation by an individual. A need therefore exists for an emergency vehicle or utility warning light which is spatially efficient, easily hidden from view, and is transportable by an individual for retrieval during an emergency situation.

A need also exists for a new emergency vehicle light bar or light support which is aerodynamic and which provides for at least one longitudinal illumination element and at least one optional elevated pod illumination device.

### GENERAL DESCRIPTION OF THE INVENTION

According to the invention, there is provided a light emitting diode (LED) warning signal light which may be depicted in several embodiments. In general, the warning signal light may be formed of a single row, single source, or an array of light emitting diode light sources configured on a light support and in electrical communication with a controller and a power supply, battery, or other electrical source. The warning signal light may provide various light signals, colored light signals, or combinations or patterns of light signals for use in association with a vehicle or by an individual. These light signals may include a strobe light, a revolving light, a flashing light at various rates or intervals of illumination, a modulated or variable intensity light, an oscillating light, an alternating light, a pulsating light signal, and/or any combination thereof. Additionally, the warning signal light may be capable of displaying symbols, characters, or arrows. Rotating and oscillating light signals may be produced by sequentially illuminating columns or single LED's on a stationary light support in combination with the provision of variable light intensity from the controller. However, the warning signal light may also be rotated or oscillated via mechanical means. The warning signal light may also be easily transportable and may be conveniently connected to a pole or stand such as a tripod for electrical coupling to a power supply, battery, or other electrical source as a remote stand-alone signaling device.

The warning signal light and/or replacement warning signal light may be electrically coupled to a controller used to modulate, or pulse, the light intensity for the light sources to provide for various patterns or combinations of patterns of illumination to create an illusion of rotation or other type of illusion for the warning signal light without the use of mechanical devices.

A reflective light assembly may also be provided. The reflective light assembly may rotate about a stationary light source or the light source may rotate about a stationary reflector. The reflective assembly may also be positioned at an acute angle of approximately 45° above a stationary LED panel or solitary light source, where the reflector may be rotated about a pivot point and axis to create the appearance of rotation for the light source.

The controller is in electrical communication with the power supply and the LED's to modulate the light intensity for the LED light sources for provision of a desired type of warning light effect. Each individual light support may be positioned adjacent to, and be in electrical communication with, another light support through the use of suitable electrical connections. A plurality of light supports or solitary light sources may be electrically coupled in either a parallel or series manner to the controller. The controller is also preferably in electrical communication with the power supply and the LED's, to regulate or modulate the light intensity for the LED light sources for variable illumination of the LED light sources as observed by an individual. The warning signal lights may encircle an emergency vehicle. In addition, the light support may be encased within a waterproof enclosure to prevent moisture or other contamination of the LED light sources.

The individual LED's and/or arrays of LED's may be used as take-down and/or alley lights by law enforcement vehicles to illuminate dark areas relative to the emergency vehicle. The take-down light source may be stationary or may be coupled to one or more rotational mechanisms. The intersection clearing light may be a particular application of the alley light as mounted to a motor for oscillation of the light source forwardly and rearwardly relative to an emergency vehicle. The intersection clearing mode preferably rotates or oscillates the alley lights forwardly and rearwardly on each side of a light bar as the emergency vehicle enters an intersection. The intersection clearing light mode preferably warns all traffic perpendicular to the direction of travel of the emergency vehicle as to the presence of an emergency vehicle within an intersection. When the intersection clearing light mode is not in operation the alley light or take-down light may be used to provide illumination at any desired angle relative to the passenger or drivers areas of an emergency vehicle.

A portable pocket LED warning signal light may be provided having a base and a power adaptor for use in unmarked law enforcement vehicles. The portable pocket LED warning signal light may also be connected to, or have, an integral controller for the provision of a variety of unique light signals as earlier described. The portable pocket LED may also include one or more reflective culminators to enhance the performance of the warning or utility signal light.

A light bar may also be provided having one or more longitudinal supports or bars and/or one or more elevated pod illumination elements. Each pod illumination element may be raised with respect to a light bar by one or more supports which extend upwardly from the base. The pod illumination elements may alternatively be oval or circular in shape. The light bar may also include one or more longitudinal light elements integral to the base which extend transversely to the roof of an emergency vehicle.

A principal advantage of the present invention is to provide a warning signal light capable of simulating revolving or oscillating light signals without the use of mechanical components.

Another principal advantage of the present invention is that the warning signal light is capable of producing several different types of light signals or combinations or patterns of light signals.

Still another principal advantage of the present invention is to be rugged and to have a relatively longer life cycle than traditional warning signal lights.

Still another principal advantage of the present invention is to produce a truer or pure light output color without the use of filters.

Still another principal advantage of the present invention is to allow the user to adjust the color of the light signal without having to make a physical adjustment to the light source from a multi-colored panel.

Still another principal advantage of the present invention is the provision of an LED light source which is formed of a relatively simple and inexpensive design, construction, and operation and which fulfills the intended purpose without fear of failure or risk of injury to persons and/or damage to property.

Still another principal advantage of the present invention is the provision of an LED light source for creation of bright bursts of intense white or colored light to enhance the visibility and safety of a vehicle in an emergency or other signaling situation.

Still another principal advantage of the present invention is the provision of an LED light source which produces brilliant lighting in any of the colors associated with an emergency vehicle light signal such as red, blue, amber, green, and/or white.

Still another principal advantage of the present invention is the provision of an LED light source which is highly resistant to corrosive effects and which is impervious to moisture build-up.

Still another principal advantage of the present invention is the provision of a warning signal light which includes LED technology and which is operated by a controller to provide any desired type or color of light signal including but not limited to rotational, pulsating, oscillating, strobe, flashing, encoded, alternating, variable, and/or modulated light signals without the necessity for mechanical devices.

Still another principal advantage of the present invention is the provision of a warning signal light which is capable of simultaneously producing several different types of light signals.

Still another principal advantage of the present invention is the provision of an LED light source which is flexible and which may be connected to a modulated illumination source to provide variable light intensity for the light source which in turn is used to create the appearance of rotation and/or oscillation without the use of mechanical rotation or oscillating devices.

Still another principal advantage of the present invention is the provision of an LED take-down light which has significant illumination characteristics which prohibits an individual located in a temporarily stopped vehicle from observing the location or actions or law enforcement personnel within or adjacent to a law enforcement vehicle.

Still another principal advantage of the present invention is the provision of an LED alley light which may easily adapted for use within existing light bar for an emergency vehicle.

Yet another advantage of the invention is the provision of an LED support member having an array of colored LED's and a controller capable of selectively illuminating the LED's of the same color to produce a single or mixed colored light signal.

Still another advantage of the invention is the provision of a light emitting diode support member having LED's disposed about the support or at least two sides of the support and a controller capable of producing light signals on the support or on each side of the support which are independent and/or different from each other.

Still another advantage of the present invention is the provision a microprocessor/controller which is in electrical communication with the LED light sources to selectively activate individual LED's to produce a flashing, strobe, alternating, rotating, oscillating, variable, encoded, modulated and/or pulsating warning light signals or combination warning light signals.

Still another advantage of the present invention is the provision of a warning signal light having LED technology which includes an array, a single row or a solitary LED light source mounted to a light support.

Still another advantage of the present invention is the provision of a strip warning signal light having LED technology where a plurality of strip LED light supports may be affixed in surrounding engagement to the exterior of an aircraft, vessel, sign, or emergency vehicle.

Still another advantage of the present invention is the provision of a warning signal light having a controller in electrical communication with each individual light source for the provision of a modulated light intensity to the light source to provide various desired patterns or combinations of patterns of illumination.

Still another advantage of the present invention is the provision of an LED light source where a single LED light source or an array of LED light sources may be rotated, and simultaneously a reflective device may be rotated, to provide a warning signal light.

Still another advantage of the present invention is the provision of a rotatable or stationary reflector or culminator which may include transparent and/or reflective sections.

Still another advantage of the present invention is the provision of a conical reflector which may include concave and/or convex reflective surfaces to assist in the reflection of light emitted from an LED light source.

Still another advantage of the present invention is the provision of an LED light support having a longitudinal dimension and a single row of LED's which provide a desired type of warning light signal.

Still another advantage of the present invention is the provision of an LED light support having a lens cover attached to the frame to minimize water penetration or contamination exposure into the interior of the frame.

Still another advantage of the present invention is the provision of an LED warning signal light having plug-in connectors for coupling to an electrical power source for an emergency vehicle such as a cigarette lighter or other electrical receptacle.

Still another advantage of the present invention is the provision of an LED warning signal light having at least one illumination face including a plurality of colored LED light sources.

Still another advantage of the present invention is the provision of an oscillating LED intersection clearing light for communication to traffic adjacent to an intersection as to the presence of an emergency vehicle and/or emergency situation.

Still another advantage of the present invention is the provision of a 360 Pod which may be magnetically or mechanically engaged to a vehicle at any desired location.

Still another advantage of the present invention is the provision of a 360 Pod which may be easily viewed from any direction relative to a vehicle.

Still another advantage of the present invention is the provision of a 360 Pod which may provide a rotational as well as other types of LED light signals for use in association with a utility vehicle as well as an emergency vehicle.

### BRIEF DESCRIPTION OF THE DRAWINGS

FIG. 1 is a partial perspective view of an emergency vehicle equipped with a light bar containing warning signal lights according to an embodiment of the invention;

FIG. 2 is a partial front elevation view of an emergency vehicle equipped with a light bar containing warning signal lights according to an embodiment of the invention;

FIG. 3 is a perspective view of a warning signal light attached to a gyrator according to an embodiment of the invention;

FIG. 4 is a perspective view of a warning signal light according to an embodiment of the invention depicting the sequential activation of columns of light-emitting diodes (LED's).

FIG. 5 is a perspective view of a warning signal light according to an embodiment of the invention depicting sequential activation of rows of LED's;

FIG. 6 is a perspective view of a warning light signal according to an embodiment of the invention;

FIG. 7 is a perspective view of a warning light signal according to an embodiment of the invention;

FIG. 8 is a perspective view of a warning light signal according to an embodiment of the invention;

FIG. 9 is a perspective view of a warning light signal according to an embodiment of the invention;

FIG. 10 is a perspective view of a warning light signal according to an embodiment of the invention;

FIGS. 11A, 11B, and 11C are schematic diagrams of one embodiment of the controller circuitry in accordance with an embodiment of the invention;

FIG. 12 is a perspective view of a warning signal light according to an embodiment of the invention;

FIG. 13 is a perspective detailed view of a warning signal light attached to the interior of a windshield of an emergency vehicle;

FIG. 14 is a side plan view of a warning signal light mounted to an interior surface of an emergency vehicle window having angularly offset individual LED light sources;

FIG. 15 is an environmental view of a warning signal light as engaged to a remote support device such as a tripod;

FIG. 16 is a detailed isometric view of a xenon strobe tube and standard mounting base;

FIG. 17 is a detailed isometric view of the replacement LED light source and standard mounting base;

FIG. 18 is a detailed isometric view of an incandescent lamp light source and standard mounting base;

FIG. 19 is a detailed isometric view of a replacement LED lamp and standard mounting base;

FIG. 20 is a front view of a standard halogen light source mounted in a rotating reflector;

FIG. 21 is a detailed rear view of a rotating reflector mechanism;

FIG. 22 is a detailed front view of the LED light source mounted to a rotating reflector;

FIG. 23 is a detailed front view of a replacement LED light source;

FIG. 24 is a detailed side view of a replacement LED light source;

FIG. 25 is a detailed isometric partially exploded view of a replacement LED light source and cover;

FIG. 26 is a detailed isometric view of a reflector or culminator;

FIG. 27 is a detailed isometric view of a culminator cup;

FIG. 28 is an alternative cross-sectional side view of a culminator cup;

FIG. 29 is an alternative cross-sectional side view of a culminator cup;

FIG. 30 is an alternative cross-sectional side view of a culminator cup;

FIG. 31 is an exploded isometric view of an alternative culminator assembly and LED light source;

FIG. 32 is an alternative partial cut away isometric view of an alternative culminator assembly and LED light source;

FIG. 33 is an environmental view of an emergency vehicle having strip LED light sources;

FIG. 34 is an alternative detailed partial cut away view of a strip LED light source;

FIG. 35 is an alternative detailed view of an LED light source having sectors;

FIG. 36 is an alternative detailed view of a circuit board or LED mounting surface having heat sink wells;

FIG. 37 is an alternative detailed isometric view of a reflector assembly;

FIG. 38 is an alternative cross-sectional side view of the frame of a reflector assembly of FIG. 37;

FIG. 39 is an alternative cross-sectional side view of a frame of a reflector assembly of FIG. 37;

FIG. 40 is an alternative detailed side view of a reflector assembly;

FIG. 41 is an alternative detailed isometric view of a reflector assembly;

FIG. 42 is an alternative detailed side view of a reflector assembly;

FIG. 43 is a graphical representation of a modulated or variable light intensity curve;

FIG. 44 is an alternative detailed partial cross-sectional side view of a reflector assembly;

FIG. 45 is a partial phantom line top view of the reflector assembly taken along the line of 45-45 of FIG. 44;

FIG. 46 is an alternative graphical representation of a modulated or variable light intensity curve;

FIG. 47 is an alternative isometric view of a reflector assembly;

FIG. 48 is a detailed back view of an individual LED light source;

FIG. 49 is a detailed front view of an individual LED light source;

FIG. 50 is a detailed end view of one embodiment of a reflector assembly;

FIG. 51 is a perspective view of a modular warning light signal according to an embodiment of the invention;

FIG. 52 is a block diagram of an electrical schematic of an embodiment of the invention;

FIG. 53 is a block diagram of an electrical schematic of an embodiment of the invention;

FIG. 54 is a block diagram of an electrical schematic of an embodiment of the invention;

FIG. 55 is a block diagram of an electrical schematic of an embodiment of the invention;

FIG. 56 is a detailed front view of a replacement LED light source;

FIG. 57 is a detailed side view of a replacement LED light source;

FIG. 58 is a detail partially exploded isometric view of a replacement LED light source and cover;

5 FIG. 59 is an environmental view of an LED personal warning signal light positioned on a dashboard of an emergency vehicle and electrically coupled to a power source such as cigarette lighter receptacle;

FIG. 60 is a detail isometric view of the LED personal warning signal light and electrical coupler;

FIG. 61 is an environmental view of an LED take-down light source and an LED alley light source mounted to the light bar of an emergency vehicle;

FIG. 62 is a top environmental view of an LED take-down light source and an LED alley light source mounted to the light bar of an emergency vehicle;

FIG. 63 is an isometric view of an LED light bar for an emergency vehicle;

FIG. 64 is a side view of an LED light bar for an emergency vehicle;

FIG. 65 is a cross-sectional top view of the take-down and alley light;

FIG. 66 is an exploded isometric view of the take-down light and alley light;

FIG. 67 is an alternative front view of a double light bar;

FIG. 68 is an alternative top view of the double light bar of FIG. 67;

FIG. 69 is an alternative side view of the double light bar;

FIG. 70 is an alternative front view of the double light bar and illumination pod;

FIG. 71 is an alternative front view of the light bar and illumination pod;

FIG. 72 is an exploded view of an end cap assembly for the light bar;

FIG. 73 is an exploded view of one embodiment of the 360° pod;

FIG. 74 is a detail isometric bottom view of the base of the embodiment of the 360° pod as depicted in FIG. 73;

FIG. 75 is a detail isometric view of the mounting base of the embodiment of the 360° pod as depicted in FIG. 73;

FIG. 76 is a detail isometric view of the LED support of the embodiment of the 360° pod as depicted in FIG. 73;

FIG. 77 is a detail isometric view of the insulator clip of the embodiment of the 360° pod as depicted in FIG. 73;

FIG. 78 is a detail isometric view of the retaining clip of the embodiment of the 360° pod as depicted in FIG. 73;

FIG. 79 is a detail isometric bottom view of the lens cover of the embodiment of the 360° pod as depicted in FIG. 73;

FIG. 80 is a detail isometric bottom view of the lens cover and Fresnel lens light diffuser of the embodiment of the 360° pod as depicted in FIG. 73;

FIG. 81 is a detail isometric view of a Fresnel lens segment of the embodiment of the 360° pod as depicted in FIG. 73;

FIG. 82 is a detail isometric view of the pole mount of the embodiment of the 360° pod as depicted in FIG. 73;

FIG. 83 is a bottom view of a gasket of the embodiment of the 360° pod as depicted in FIG. 73;

FIG. 84 is a cross-sectional side view of the gasket taken along the line of 84-84 of FIG. 83;

FIG. 85 is a side view of a wire harness of the embodiment of the 360° pod as depicted in FIG. 73;

FIG. 86 is a cross-sectional end view of the wire harness taken along the line 86-86 of FIG. 85;

FIG. 87 is a side view of the embodiment of the 360° pod of FIG. 73;

FIG. 88 is an alternative side view of the embodiment of the 360° pod of FIG. 73;

FIG. 89 is an alternative side view of the embodiment of the 360° pod of FIG. 73;

FIG. 90 is a detail top view of the LED support of the embodiment of the 360° pod of FIG. 73;

FIG. 91A is a partial electrical schematic of the embodiment of the 360° pod of FIG. 73;

FIG. 91B is a partial electrical schematic of the embodiment of the 360° pod of FIG. 73;

FIG. 91C is a partial electrical schematic of the embodiment of the 360° pod of FIG. 73; and

FIG. 91D is a partial electrical schematic of the embodiment of the 360° pod of FIG. 73.

### DETAILED DESCRIPTION OF THE PREFERRED EMBODIMENTS

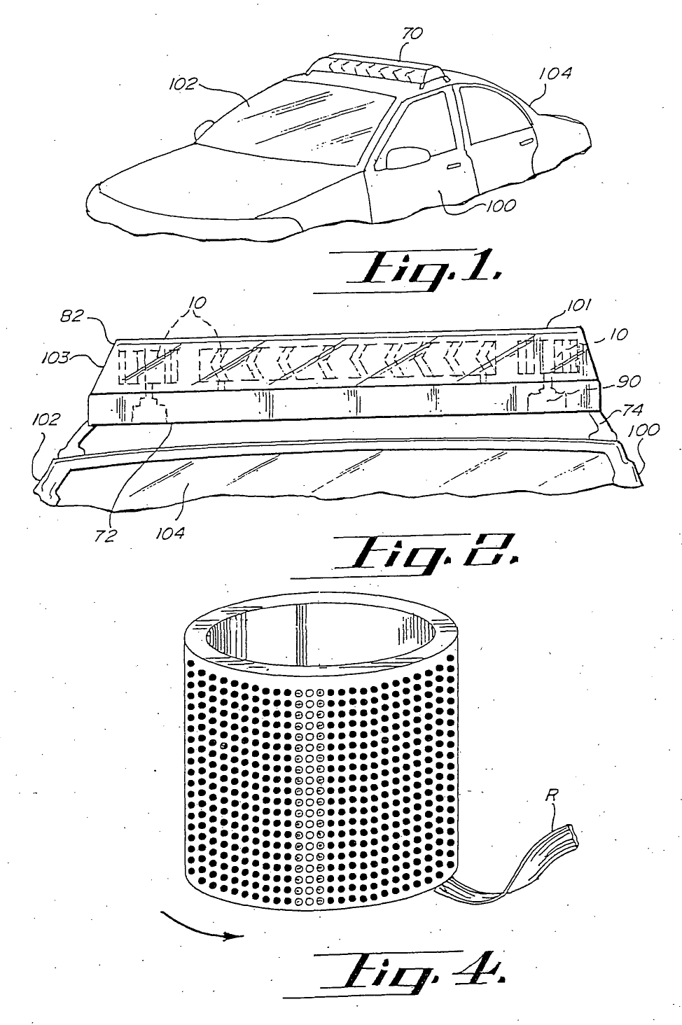

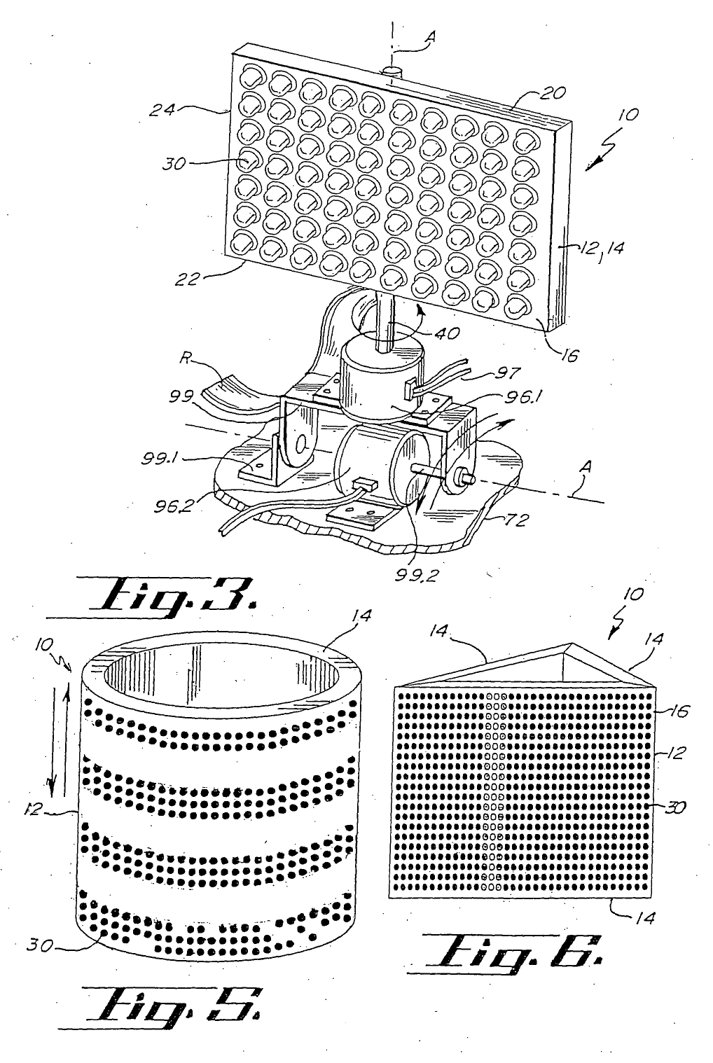

A warning signal light according to the principles of the invention is indicated generally herein as numeral 10. FIGS. 1 and 2 depict light bar 70 mounted to an emergency vehicle 104. Light bar 70, includes base 72, mounting means 74, cover 82, and warning signal lights 10. Also included in light bar 70, may be gyrators 90, which may be used to impart motion to warning signal lights 10.

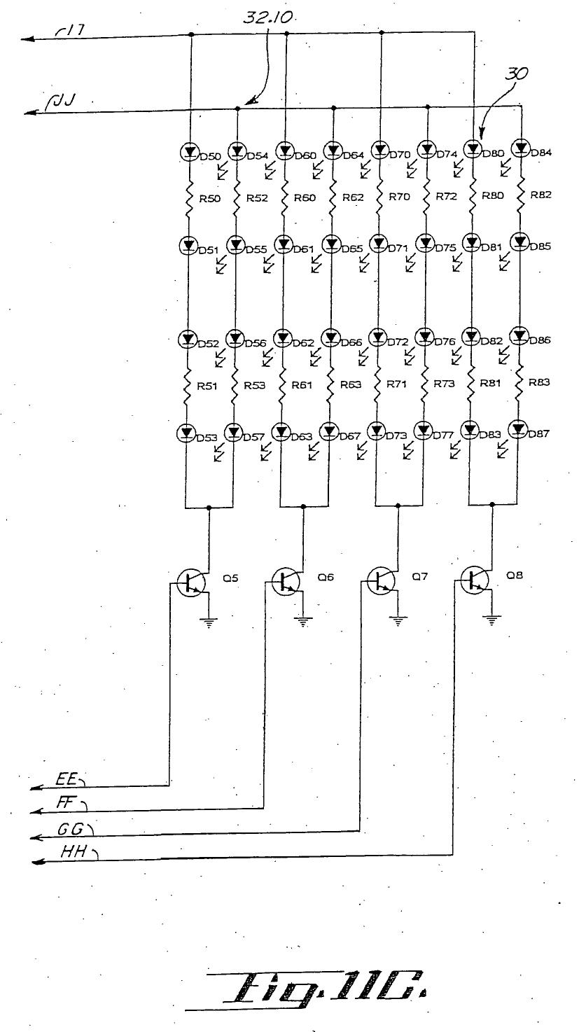

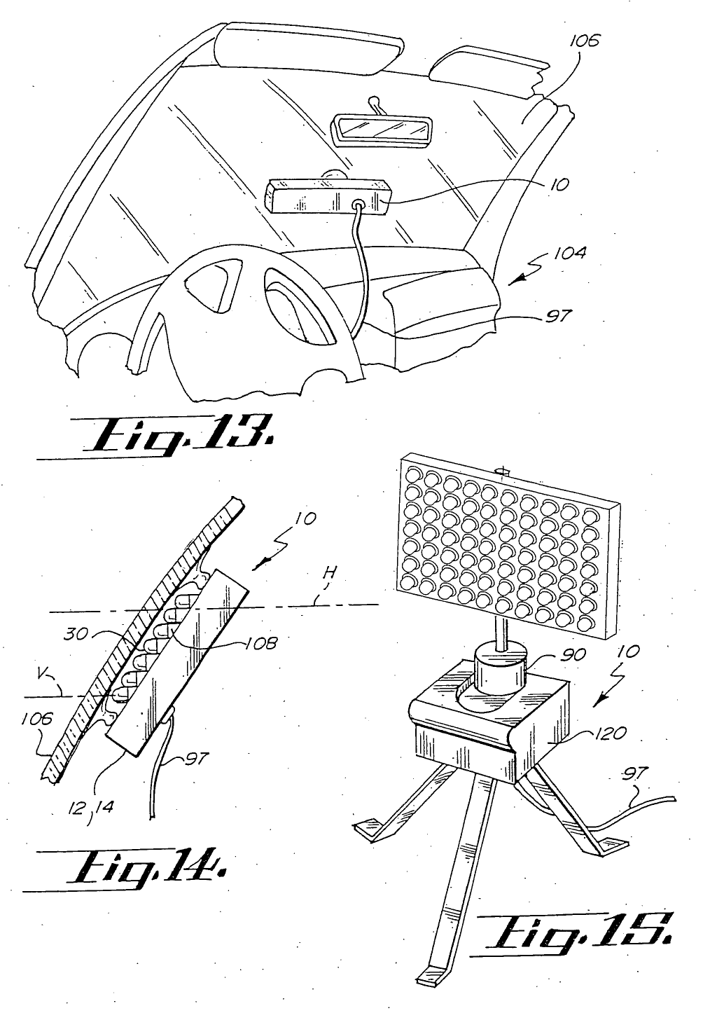

Referring to FIGS. 3 and 9, warning signal light 10, comprises light support 12, LED light sources 30, controller 50 (shown in FIG. 11), and connecting portion 40, for attaching the warning signal light 10, to light bar 70, or gyrator 90. The warning signal light 10, operates to create a warning signal for use by an emergency vehicle 104, by selectively activating light sources 30 or by selectively activating combinations and/or patterns of light sources 30 by using controller 50. Alternatively, warning signal light 10, may be formed of one or more solitary LED light sources 30.

Light sources 30, are preferably light emitting diodes (LED's) and are generally arranged in aligned columns 32, and/or rows 34, as shown in FIG. 7 and 9. Each of the light emitting diodes (LED's) may have shoulder portion 38, adjacent LED support 12, and dome 36. LED's 30, are situated to be in electric communication with controller 50, and a power supply, a battery, or power source. The use of light emitting diodes (LED's) to replace traditional halogen, incandescent, or gaseous discharge xenon lamps reduces heat generation, current draw, and electromagnetic emissions, while increasing lamp life and producing a more true output light color.

The controller 50 is used to selectively activate portions or entire columns 32, rows 34, or individual LED's 30, to illuminate any number of a plurality of visually distinct types of warning light signals at any moment; to illuminate more than one of a plurality of visually distinct types of warning light signals simultaneously at any moment; to illuminate one of a plurality of combinations or patterns of visually distinct warning light signals at any moment, or over any desired period or interval of time, or to illuminate more than one of a plurality of combinations or patterns of visually distinct warning light signals over any desired period or interval of time. The plurality of visually distinct warning light signals may include, but are not necessarily limited to, a strobe light signal, a pulsating light signal, an alternating light, a modulated light signal, a variable light signal, a flashing light signal, the illusion of a rotating or an oscillating light signal, a reverse character message, a sequential light signal, a random light signal, or images such as arrows.

The controller 50 may also incorporate into any selected warning light signal variable or modulated light intensity to facilitate the provision of a desired unique lighting effect. For example, the controller 50 may illuminate one or more LED light sources 30 to establish a single warning light signal at a given moment. Alternatively, the controller 50 may illuminate one or more light emitting diode light sources 30 to provide two or more warning light signals at any given moment. Further, the controller 50 may simultaneously, consecutively, or alternatively, illuminate one or more LED light sources 30 to establish any desired combination or pattern of illuminated visually distinct warning light signals at any given moment or over a desired period or interval of time. The combination and/or pattern of visually distinct warning light signals may be random, intermittent, or may be regularly cycled. The illumination of one or more patterns or combinations of warning light signals facilitates the continued observation of the light signal by an individual. Occasionally, the concentration or attention of an individual is diminished when exposed to a repetitive or to a monotonous light signal. The desired purpose for illumination of a warning light signal is thereby reduced. The provision of a pattern, combination, and/or random illumination of visually distinct warning light signals maximizes the concentration or attention to be received from an individual observing a warning light signal. The purpose of the warning light signal is thereby promoted.

FIGS. 11A, 11B, and 11C show an embodiment of controller 50 capable of selectively activating columns 32, rows 34, individual or combinations of individual LED's 30. Controller 50 generally comprises microprocessor 52 and circuitry 53 and is contained within, attached to, or an element of, LED support 12. It is envisioned that controller 50 may be programmed by an external controller 55 and powered through cable R.

In one embodiment, controller 50 generally comprises circuit board 54 or LED mounting surface having microprocessor 52 attached to a low voltage power supply, battery, or electrical source 56. Microprocessor 52 is configured through circuitry 53 to selectively activate columns 32, rows 34, or one or more individual LED's 30. Transistors Q9 and Q10 are in electronic communication with microprocessor 52, power supply, battery, or electrical source 56, and their respective columns 32.9 and 32.10 of LED's 30. Columns 32 of LED's 30 are connected to transistors Q1-Q8, which are in turn connected to microprocessor 52 through resistors R1-R8. Microprocessor 52 is capable of selectively activating transistors Q1-Q8 to allow current flowing through transistors Q9 and Q-10 to activate the selected column 32 of LED's 30. This circuit is capable of producing any one or more of the different types of light signals as earlier identified.

In one embodiment, a rotating or oscillating light signal may be established by the sequential illumination of entire columns 32 of LED's 30 by turning a desired number of columns on and then sequentially illuminating one additional column 32 while turning another column 32 off. Alternatively, the rotating or oscillating warning light signal may be created by selectively activating columns 32 of LED's 30. The following algorithm may be used to provide a counterclockwise revolving light signal (FIG. 9):
1) column A is activated at 0% duty cycle (column A 0%), column B 0%, column C 0%, column D 0%, column E 0%, column F 0%, column G 0%, column H 0%, column I 0%, and column J 0%;
2) column A 25%, column B 0%, column C 0%, column D 0%, column E 0%, column F 0%, column G 0%, column H 0%, column I 0%, and column J 0%;
3) column A 50%, column B 25%, column C 0%, column D 0%, column E 0%, column F 0%, column G 0%, column H 0%, column I 0%, and column J 0%;
4) column A 75%, column B 50%, column C 25%, column D 0%, column E 0%, column F 0%, column G 0%, column H 0%, column I 0%, and column J 0%;
5) column A 100%, column B 75%, column C 50%, column D 25%, column E 0%, column F 0%, column G 0%, column H 0%, column I 0%, and column J 0%;
6) column A 100%, column B 100%, column C 75%, column D 50%, column E 25% column, column F 0%, column G 0%, column H 0%, column I 0%, and column J 0%;
7) column A 75%, column B 100%, column C 100%, column D 75%, column E 50%, F 25%, column G 0%, column H 0%, column I 0%, and column J 0%;
8) column A 50%, column B 75%, column C 100%, column D 100%, column E 75%, column F 50%, column G 25%, column H 0%, column I 0%, and column J 0%;
9) column A 25%, column B 50%, column C 75%, column D 100%, column E 100%, column F 75%, column G 50%, column H 25%, column I 0%, and column J 0%;
10) column A 0%, column B 25%, column C 50%, column D 75%, column E 100%, column F 100%, column G 75%, column H 50%, column 125%, and column J 0%;
11) column A 0%, column B 0%, column C 25%, column D 50%, column E 75%, column F 100%, column G 100%, column H 75%, column I 50%, and column J 25%;
12) column A 0%, column B 0 %, column C 0%, column D 25%, column E 50%, column F 75%, column G 100%, column H 100%, column I 75%, and column J 50%;
13) column A 0%, column B 0%, column C 0%, column D 0%, column E 25%, column F 50%, column G 75%, column H 100%, column I 100%, and column J 75%;
14) column A 0%, column B 0%, column C 0%, column D 0%, column E 0%, column F 25%, column G 50%, column H 75%, column I 100%, and column J 100%;
15) column A 0%, column B 0%, column C 0%, column D 0%, column E 0%, column F 0%, column G 25%, column H 50%, column I 75%, an column J 100%;
16) column A 0%, column B 0%, column C 0%, column D 0%, column E 0%, column F 0%, column G 0%, column H 25%, column I 50%, and column J 75%;
17) column A 0%, column B 0%, column C 0%, column D 0%, column E 0%, column F 0%, column G 0%, column H 0%, column 1 25%, and column J 50%;
18) column A 0%, column B 0%, column C 0%, column D 0%, column E 0%, column F 0%, column G 0%, column H 0%, column I 0%, and column J 25%;
19) column A 0%, column B 0%, column C 0%, column D 0%, column E 0%, column F 0%, column G 0%, column H 0%, column I 0%, and column J 0%;
20) return to step 1).

A clockwise revolving light signal may be created by performing steps 1-19 in descending order then repeating the steps. An oscillating light signal may be created by performing: (a) steps 7 through 16 in ascending order; (b) steps 7 through 16 in descending order; and (c) repeating (a) and (b).

A second embodiment of controller 50 provides a means for activating LED's 30 individually to allow for greater flexibility in the type of warning light signal created. This embodiment of the invention is capable of displaying information in different colors or patterns. Depending on the size of the display, it may be necessary to scroll the symbols or characters across the display to accommodate for a larger visual appearance. It is envisioned that the mirror image of patterns, symbols, or characters could be displayed making the message easily readable by drivers viewing the signal in a rear view mirror. It is also envisioned that the warning light signal could display arrows indicating a direction a vehicle is to travel or other images as shown in FIG. 2. In addition, combinations of warning signal lights, direction arrows, and other information carrying signals or images, may be displayed simultaneously by the invention.

LED support 12 is envisioned to have several embodiments. One embodiment, shown in FIG. 9, consists of a panel 14 having front 16, back 18, top 20, bottom 22 and sides 24. LED's 30 are arranged on front 16, with domes 36 extending therefrom, in columns 32 and rows 34. LED's 30 are in electric communication with controller 50 which may be contained or sealed within LED support 12 to provide protection from the elements.

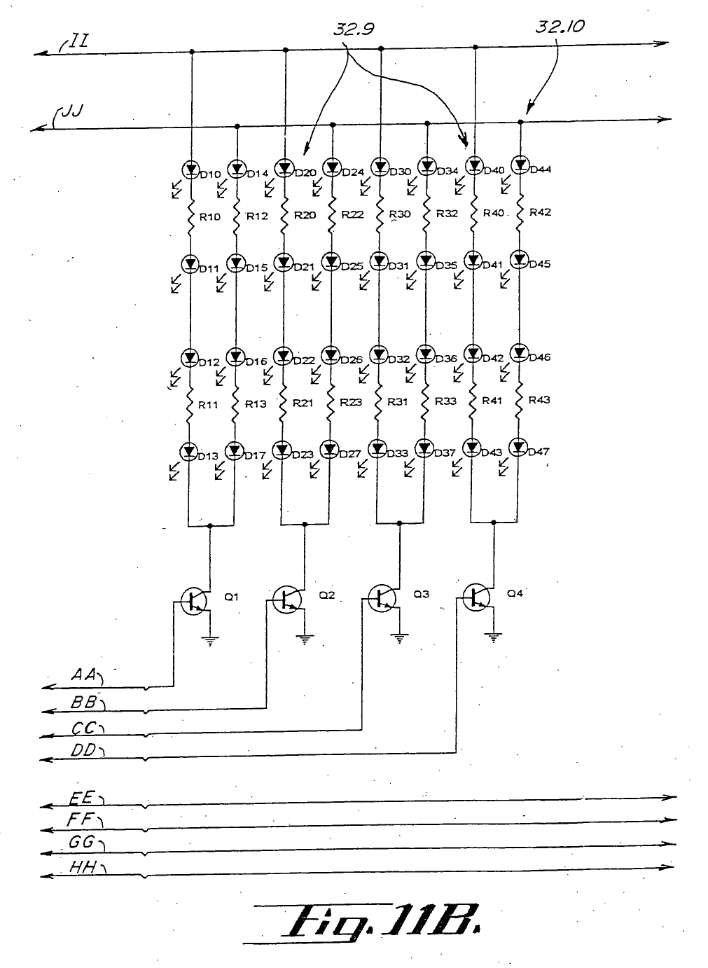

Another embodiment of warning signal light 10 is depicted in FIG. 10. Here, the backs 18 of two panels 14 are attached together to allow for a light signal to be produced on two sides. The two panels 14 form LED support 12. Alternatively, it is envisioned that a single panel 14 having LED's arranged about front 16 and back 18 could be used as well.

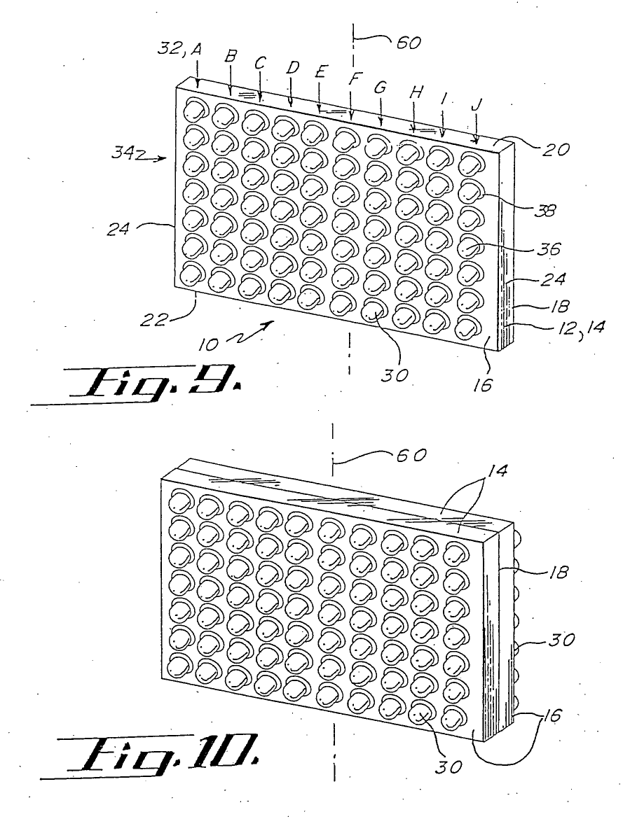

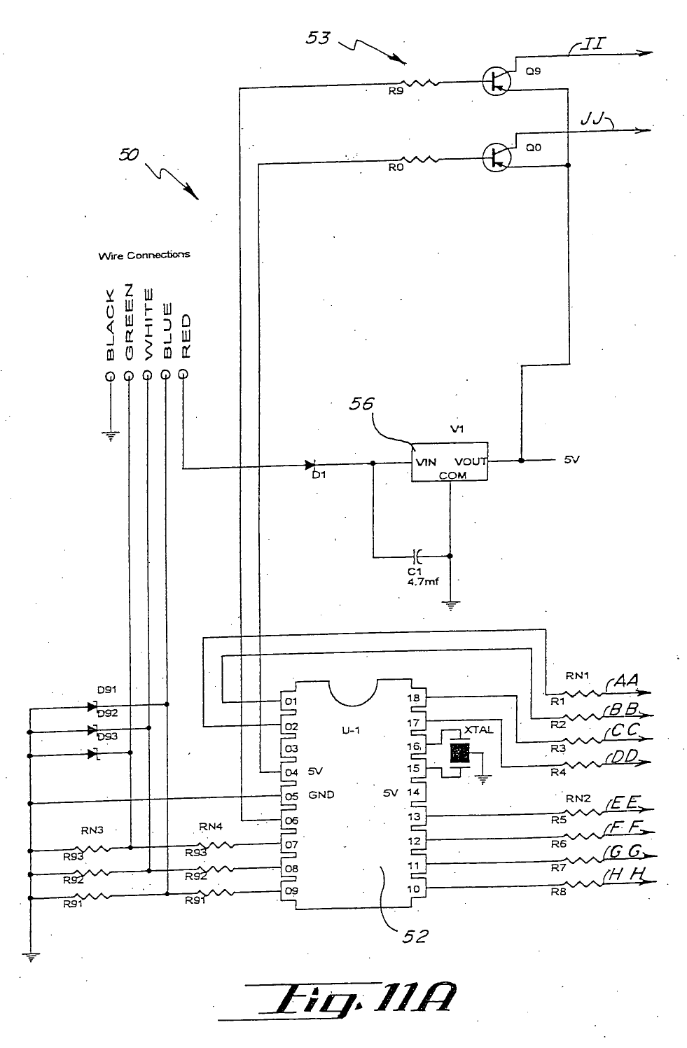

FIGS. 6 and 8 show further embodiments of warning signal light 10. In FIG. 8, panels 14 are used to form an LED support 12 having four sides and generally shaped as squared. FIG. 6 shows panels 14 connected to form an LED support 12 having three sides and generally triangular in shape. In both embodiments, LED's 30 are arranged about the fronts 16 of the panels 14. It is further envisioned that panels 14 may be integral to each other.

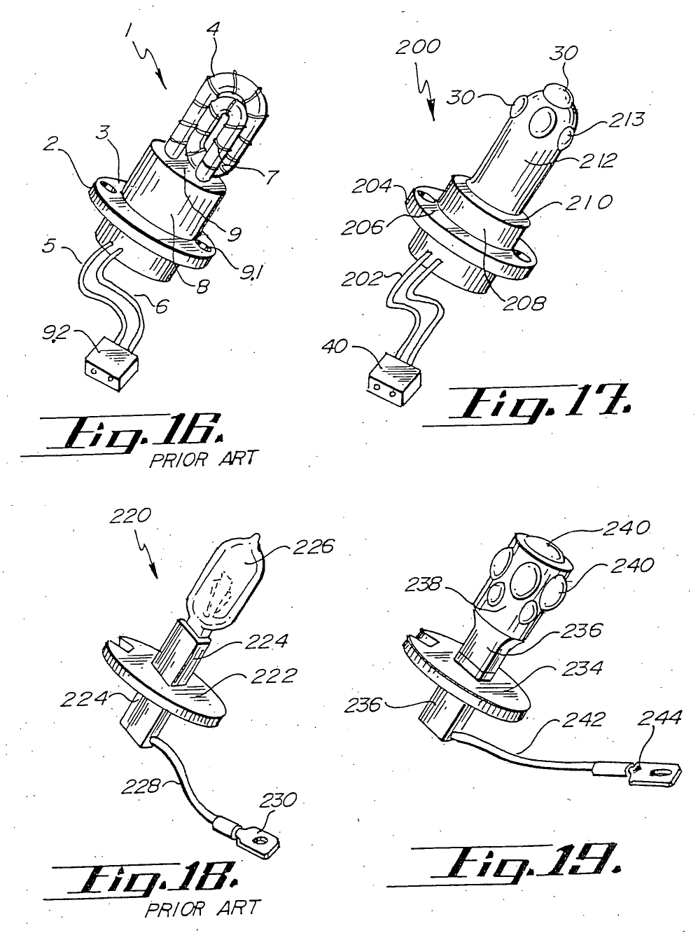

Yet another embodiment of warning signal light 10, consists of a flexible panel 14 and controller 50 to allow LED support 12 to be formed into various shapes. FIG. 5 shows LED support 12 formed into a cylinder. Further variations include the use of flexible panels 14 to form other shapes such as semicircles (FIG. 12) or to simply conform to a surface of an emergency vehicle (FIGS. 13 and 14). This embodiment is particularly useful for undercover vehicles which generally position the warning signal lights inside the vehicle. For example, panel 14 could be attached to the front, rear, or side window of an undercover police vehicle.

Numerous other shapes could be formed from panels 14 including those formed from combinations of flat, curved, and flexible panels.

In each of the embodiments discussed above, the array of LED's 30 may be formed of the same or differently colored LED's. Generally, each column 32 or row 34 may consist of a series of differently colored LED's. Controller 50 may be configured to select the color of the LED's to be illuminated forming the light signal. Accordingly, the user may select a blue, red, white, yellow, green, or amber color or any combination thereof to be used as the color of light signal. Alternatively, the warning signal 10 may be formed of individual LED's 30 which may be selectively illuminated for generation of a particular type of light signal.

It is also envisioned that the controller 50 may control warning signal lights 10 having multiple sides (FIGS. 5, 6, 8, and 10) such that each side is capable of producing warning light signals or combinations of warning light signals that are independent and/or different from those produced upon the other sides. For example, the squared shape warning signal light shown in FIG. 8 may produce or simulate a red revolving light on first side 15. 1, while second side 15.2 is simultaneously producing a blue oscillating light, while third side 15.3 is producing or simulating a stationary white light, and while fourth side 15.4 is producing a white strobe light.

Another embodiment of warning signal light 10 is depicted in FIGS. 1 and 2 as light bar 70 which extends from driver side 100 to passenger side 102 of emergency vehicle 104. Cover 82 protects light bar 70 from the elements. Each side of light bar 70 may have LED's 30 to produce or simulate warning light signals on each side of emergency vehicle 104. Furthermore, controller 50 may be used to create multiple warning light signals on each side of light bar 70. For example, controller 50 may create a simulated revolving blue light positioned at front passenger side 102 of light bar 70, oscillating white lights positioned at front driver side 100, and yellow arrows there between. Additional or alternative warning light signals may be produced out the back 18 and sides of light bar 70. It is further envisioned that light bar 70 may consist of a single light source, a single row of light sources or a large array of LED's 30 across each side (not shown). This embodiment provides the largest display and, therefore, is best suited to display desired combinations of warning lights and images. It should be noted that the identified types of warning light signals, combinations and/or patterns of warning light signals, may also be reproduced through the illumination of a single row of LED light sources 30 and that the type of patterns previously identified are not intended to be exclusive in that an infinite variety of combinations and/or patterns are available for generation by controller 50.

Mechanical rotation and oscillation of warning signal lights 10 about axis A is possible by way of attachment to gyrator 90 depicted in FIG. 3. Gyrator 90 mounted to light bar 70, generally comprises electric motors 96 having cables 97. Gyrator 90 is configured to receive connecting portion 40 of warning signal light 10. Cable 97 is preferably connected to a power supply and either an external controller 55 or controller 50.

Gyrator 90 may be capable of rotating or oscillating warning signal light 10 about a single or dual axis of rotation A. FIG. 3 shows gyrator 90 configured to rotate or oscillate warning signal light 10 about a vertical axis A by way of motor 96.1 and oscillate warning signal light 10 about a horizontal axis A by way of motor 96.2. Rotation or oscillation of warning signal light 10 about vertical axis A is accomplished through direct attachment of connecting portion 40 to motor 96.1. Oscillation of warning signal light 10 about horizontal axis A is accomplished by attaching swivel arm 99 to bracket 99.1 and post 99.2 which is mounted to motor 96.2.

Alternative methods for imparting rotation or oscillation motion to warning signal light 10 may be accomplished through the use of electric motors, toothed gears, and worm gears. In addition, maintaining electrical communication between a power supply and an external controller 55 with a revolving or oscillating warning signal light 10 may be accomplished using brushes or other means without sacrificing the operation of the warning signal light 10.

In another embodiment as depicted in FIGS. 13 and 14, emergency vehicle 104 may include a front or rear windshield 106. The front or rear windshield 106 is generally angularly offset with respect to the vehicle at an approximate angle of 45°. In this embodiment, the mounting of a panel 14 of light sources 30 in flush contact with the interior of a front or rear windshield 106 may occur through the use of angular offsets 108 for the light sources 30 such that light is transmitted from the light sources 30 at a horizontal visual line (V) which is substantially parallel to the plane of a vehicle and not at an approximate angle of 45° upward, which corresponds to the angle for the front or rear windshield 106.

In this embodiment, the ease of visualization of a generated light signal is significantly enhanced by the downward angular offsets 108 which position the light sources 30 along parallel visual lines of sight (V). LED supports 12 or panels 14 may then be positioned in any desired location within the interior of a vehicle in flush contact or proximate to the front or rear windshield 106. A suitable cable 97 is required to provide electrical power for illumination of the light sources 30. It should be noted that the angle of incidence for the angular offsets 108 may vary considerably dependent upon the make or model for the vehicle to include the warning signal lights 10.

The warning signal light 10 may be used upon an automobile, motorcycle, snowmobile, personal water craft, boat, truck, fire vehicle, helicopter, and/or any other type of vehicle receptive to the use of warning signal lights 10. The LED support 12 or panel 14 may be mounted to the interior top dashboard of a vehicle proximate to the front windshield 106 or to the interior top rear dashboard proximate to the rear windshield 106 of a vehicle.

Mounting of a light support 12 or panel 14 to either the front or rear dashboards may minimize the necessity for inclusion of angular offset 108 for the light sources 30. The LED supports 12 or panels 14 may be releasably affixed to the interior of the front or rear windshields 106 via the use of suction cups, hook-and-loop fabric material such as Velcro®, and/or any other releasable affixation mechanism. An individual may then adjust and reposition the location of the light support 12 or panels 14 anywhere within the interior of a vehicle as desired for maximization of visualization of the warning signal lights 10.

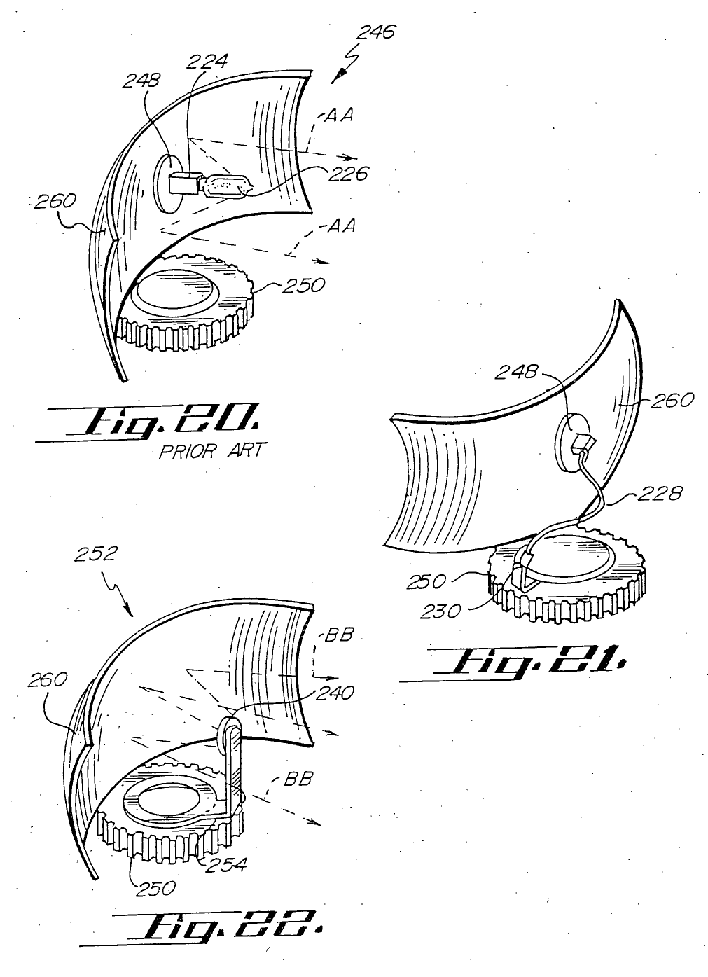

In another alternative embodiment as depicted in FIG. 15, warning signal light 10 may function as a remote, revolving, or stationary beacon. In this embodiment, LED support 12 or panel 14 is preferably releasably connected to a transportable support 120 via the use of a bracket. The transportable support 120 may be a tripod having telescoping legs or may be any other type of support. In this embodiment, LED light support 12 or panel 14 is electrically connected to an elongate electrical extension cable 97 which may include any desired adapter for electrical connection to a power source which may be a vehicle. The remote light support 12 or panel 14 may also include plug-in adapters for electrical connection to any desired electrical power source other than a vehicle as is available. Alternatively, the LED light support 12 or panel 14 may be electrically connected to a battery or rechargeable battery to provide power to the LED's 30.

The transportable support 120 may also include gyrator 90 as earlier described to provide rotational or oscillatory motion for warning signal light 10. A controller 50 having a microprocessor 52 may also be integral to, or in electrical communication with, LED's 30 for the provision of multi-colored lights, or one or more of the warning light signals or patterns or combinations of warning light signals as earlier described. In this embodiment, the warning signal light 10 may be physically separated from an emergency vehicle 104 any desired distance to facilitate or enhance the safety of a potentially dangerous situation necessitating the use of a warning light. Further, a series of remote warning signal lights 10 may be electrically coupled to each other for any desired distance to again facilitate the environmental safety of an emergency location.

FIG. 16 shows a perspective view of a xenon lamp 1. Xenon lamp 1 has a base pedestal 2 which is typically formed of rubber, plastic, or other insulating material. Base pedestal 2 has a top surface 3 which may support a glass tube 4 which may have a looped curve such that an anode end and a cathode end are each supported on a top surface. The anode and cathode ends may be sealed and respective electrical conductors 5 and 6 may pass through the sealed ends and through the top surface 3. A trigger wire 7 may be helically wound about the exterior surface of the glass tube 4 and the ends of the trigger wire 7 may be passed through the top surface 3 of the base pedestal 2 to form a third conductor on the underside of the base pedestal 2.

Base pedestal 2 may have an upper cylinder portion 8 extending from a lower shoulder all of which may extend above the top surface 3. The upper cylindrical portion 8 may include an upper shoulder 9. A glass dome (not shown) may be sized to fit over the xenon lamp 1 and glass tube 4 for resting on the upper shoulder 9. The glass dome may be formed of a transparent or silicate glass material capable of withstanding heat stress. The outer diameter of the glass dome is typically about one inch which is sized to fit through the conventional opening in a typical vehicle lamp fixture. The exterior glass dome surface generally has a much lower temperature during operation than the exterior surface of the glass tube 4 forming a part of the xenon lamp 1. The temperature drop between the glass tube 4 and the glass dome facilitates the use of coloring of the dome to provide a colored lamp by virtue of the xenon light intensity passing through the colored dome acting as a filter.

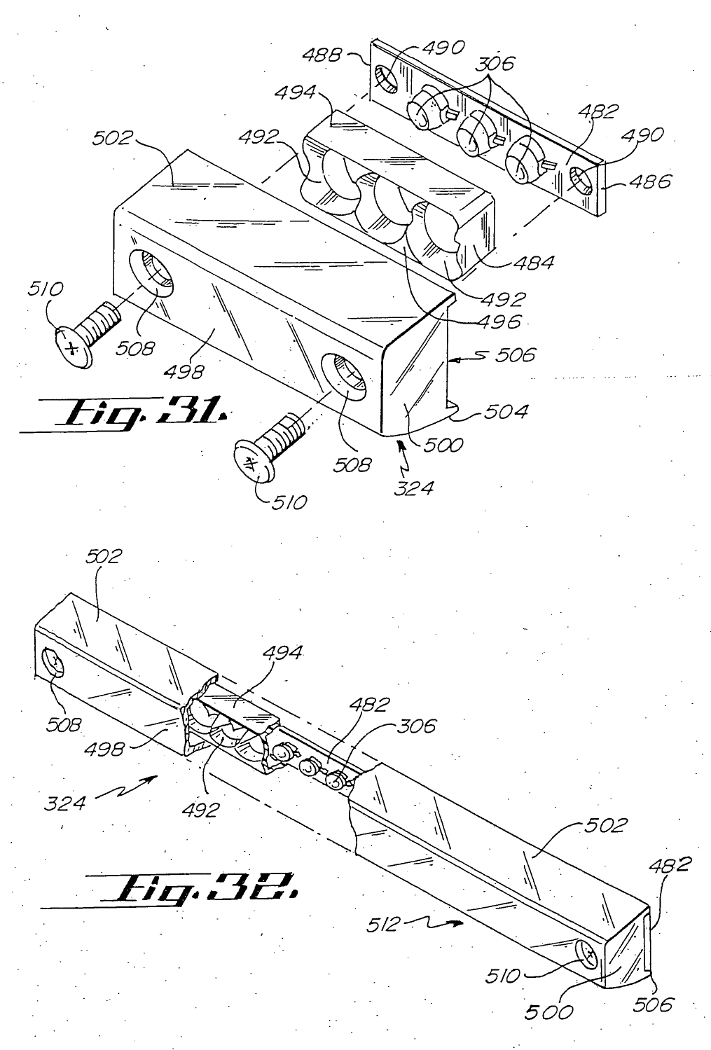

The xenon lamp 1 is preferably aligned for insertion into a conventional opening 248 of a light reflector 260 (FIGS. 20 and 21). The light receptacle opening 248 in the light reflector 260 is typically about one inch in diameter; and the glass dome and base pedestal 2 are sized to fit within the light receptacle opening 248. The xenon lamp 1 in its final construction may include a cover plate (not shown) affixed over the bottom opening of the base pedestal 2 for affixation to a light reflector 260 via the use of screws which pass through the screw apertures 9.1. The anode, cathode, and trigger wire 7 traverse the base pedestal 2 and may include a plug 9.2 which is adapted for engagement to a controller/power supply for a motor vehicle.

The light reflector 260 may be a conventional light reflector of the type found in vehicles having a clear plastic or glass lens cover. The glass or lens cover may be fitted over the front edge of the reflector 260 in a manner which is conventional for vehicle lamps. The light reflector 260 may be parabolicly or other shaped. The light reflector 260 may be mounted to a motor for rotation about a vertical axis. In this embodiment the light source/replacement lamp 200 may be integrally connected or affixed to the reflector 260 for simultaneous rotation about the vertical axis during use of the motor. Alternatively, the light source/replacement lamp 200 may be fixed proximate to the vertical axis where the light reflector 260 is rotated around the stationary replacement lamp 200 to provide for the visual appearance of a rotational light source.

In operation, the LED replacement lamp 200 may be constructed as a replacement part for a conventional incandescent or xenon gaseous discharge lamp. The standard mounting base 204 and LED support assembly 212 may be sized to readily fit into the same light opening as an incandescent lamp would require, although it is apparent the electrical driving circuit for the LED replacement lamp 200 may require modifications to accommodate the LED operating principles.

LED warning signal lamp 200 may be used in a variety of locations about a vehicle. The use of the LED warning signal lamps 200 are not necessarily limited to positioning adjacent to the head lamp or headlight, tail light, or turn signal illumination devices. The LED warning signal lamp 200 may be used as a rotational, pulsating, or oscillating reflector light within the interior, adjacent to a front, rear, and/or side window of a vehicle.

It is also envisioned that the controller 50 may control warning signal lights 200 independently of one another such that each warning signal lamp 200 is capable of producing warning light signals which are independent and/or different from those produced at another location about an emergency vehicle 104. For example, a front left location may produce a red colored light while simultaneously a front right location may produce an amber colored light and a right rear location may produce a green colored light and a left rear location may produce a blue colored light. The controller 50 may then alternate the color of the light illuminated from the warning signal lamp 200 in each area. Alternatively, the controller 50 may sequentially activate warning signal lamps 200 positioned about an emergency vehicle 104 to simultaneously produce a desired color or alternating sequence of colors. The controller 50 may simultaneously illuminate all LED warning signal lamps 200 to produce a flashing or strobe light which may be particularly useful in certain emergency situations. The controller 50 may also selectively illuminate individual LED warning signal lamps 200 in any desired color, pattern, and/or combination.

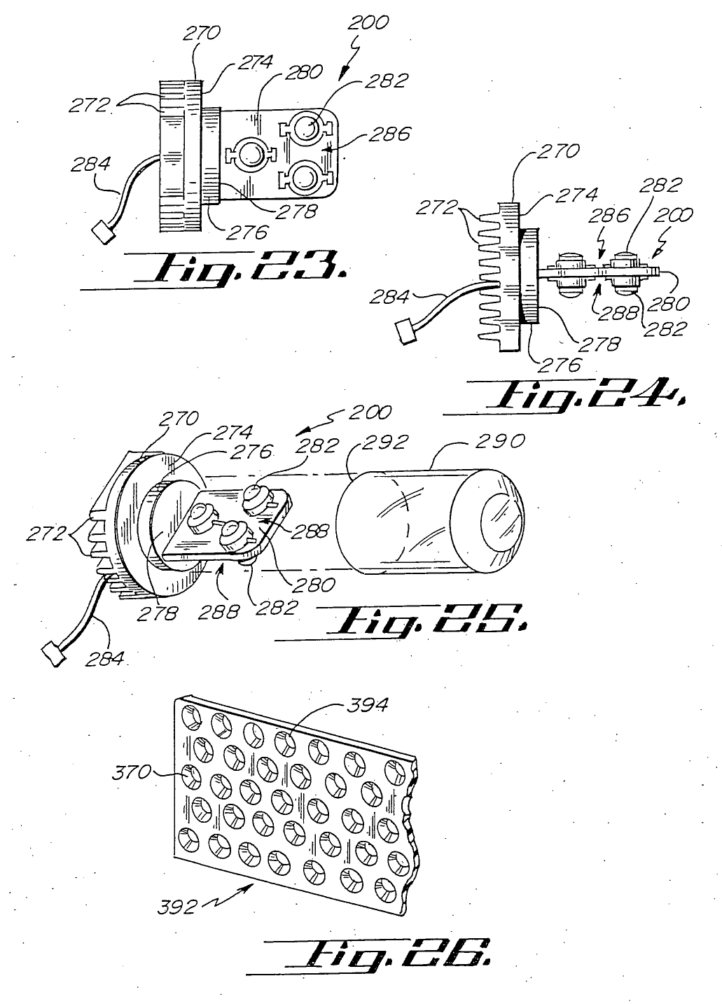

Referring to FIG. 17 in detail, an LED replacement lamp 200 is depicted. In this embodiment the LED replacement lamp 200 includes a standard mounting base 204 which includes a top surface 206. Extending upwardly from the top surface 206 is an upper cylindrical portion 208 which includes an upper shoulder 210. Extending upwardly from the upper shoulder 210 is an LED support assembly 212 which includes one or more LED lamp modules 213. The LED lamp modules 213 may be of the same or different colors. A wire 202 is in electrical communication with the plurality of LED lamp modules 213 to provide for electrical communication with the controller 50 to individually activate or illuminate LED lamp modules 213. A plug-in connector 40 may be coupled to the wire 202 for engagement to the controller 50 and/or power source of an emergency vehicle 104.

The LED replacement lamp 200 is adapted to be positioned in a one inch light receptacle opening 248 (approximate size) which has been previously placed through the backside of a reflector assembly 260. The LED replacement lamp 200 is used to replace a xenon gaseous discharge lamp or incandescent lamp as previously mounted to a base which is inserted into opening 248 in a reflector assembly 260. Illumination of one or more individual LED lamp modules 213, as mounted in the reflector assembly 260, enables the reflector assembly/lens to take on the appearance of a warning signal or emergency signaling lamp.

Referring to FIG. 18, an incandescent lamp or quartz halogen H-2 lamp is depicted and in general is indicated by the numeral 220. The incandescent lamp assembly 220 is formed of a standard mounting base 222. A vertical post 224 extends upwardly from the standard mounting base 222. The incandescent light bulb 226 is mounted in the vertical post 224. The vertical post 224 may extend below the standard mounting base 222 to provide for electrical coupling with a wire 228 which includes a standard pin connector 230. The standard pin connector 230 is adapted for electrical communication to a power supply and/or controller 50 for activation of the incandescent lamp assembly 220. The incandescent lamp assembly 220 may be stationary or mounted in a rotational light reflector 260. The light bulb 226 may be a halogen H-2, 55 watt, lamp.

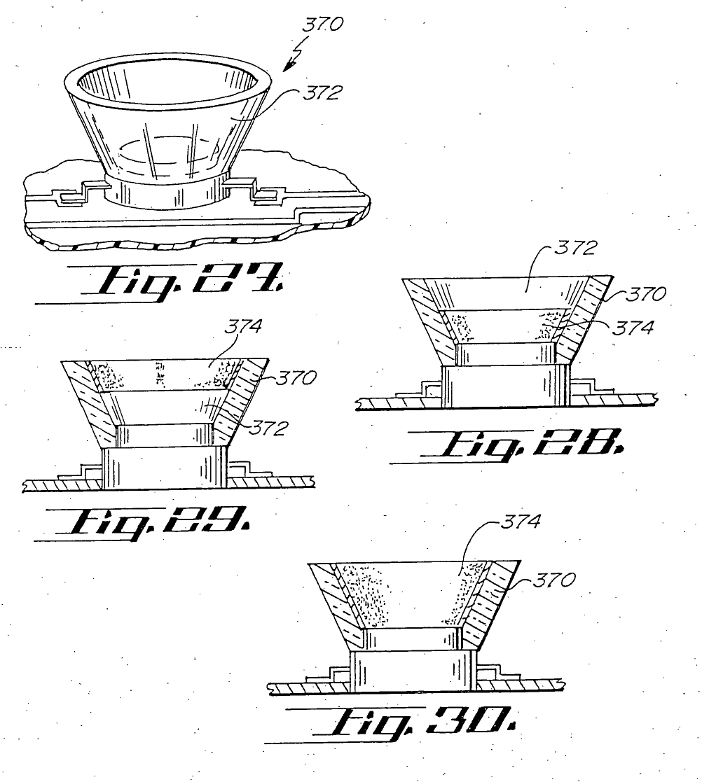

As depicted in FIG. 19, LED replacement lamp 200 is adapted to replace the incandescent lamp assembly 220 in a stationary or rotational light reflector 260. The LED replacement lamp 200 as depicted in FIG. 19 includes a standard mounting base 234 and a vertical post 236. The vertical post 236 may extend upwardly from the standard mounting base 234 and may alternatively extend below the standard mounting base 234. An LED mounting area 238 may be integral or affixed to the upper section of the vertical post 236. The LED mounting area 238 includes a plurality of individual LED module lamps 240 which may be illuminated individually, sequentially, or in combination with other light sources.

The individual LED module lamps 240 are in electrical communication with a wire 242 which includes an integral standard wire connector 244. The wire connector 244 is adapted to be plugged into a controller 50 or power supply. Communication is thereby provided for selective illumination of the individual LED module lamps 240. A group of individual LED module lamps 240 may be mounted in the LED mounting area 238. The LED replacement lamp 200 is adapted to replace the incandescent lamp assembly 220 or a xenon gaseous discharge lamp assembly base of FIGS. 16 or 18. The purpose of the LED replacement lamp assembly 200 is to replace existing xenon gaseous discharge and incandescent lamps with new LED technology while simultaneously utilizing existing standard bases in a standard lamp enclosure. For example, an individual may choose to replace a halogen “H-2” 55 watt lamp with an “LED-2” lamp in an existing rotating light fixture with no other structural modifications, yet achieving the advantages of less power consumption, greater reliability, easier installation, less RF emissions (which reduces interference with radio or electronic equipment), cooler operating temperatures, simplified circuitry, longer life, greater durability and duty capability, and simultaneously providing pure and easier-to-see color light output.

As depicted in FIG. 20, a rotational light reflector 246 is disclosed. The rotational light fixture 246 includes a reflector assembly 260 having a standard opening 248. The incandescent light assembly 220 is positioned in the standard opening 248 for extension of the vertical post 224 outwardly from the reflector assembly 260 for positioning of the light bulb 226 in a desired location. Light emitted from the standard halogen light bulb 226 reflects off the parabolic-shaped reflector assembly 260 for transmission of light in a direction as indicated by arrows AA for visualization by individuals. Reflector assembly 260 and light source 226 may be rotated via the use of gears 250 which are driven by electrical motors not shown. In this manner, the rotational light fixture 246 including the reflector assembly 260 may be rotated at any desired velocity as preferred by an individual.

As may be seen in FIG. 21, a rear or back view of the rotational light fixture 246 is provided. As may be seen in FIG. 21, the light source is positioned in the standard opening 248. The wire 228 is in electrical communication with the light source and is connected via the standard pin connector 230 to a power source.

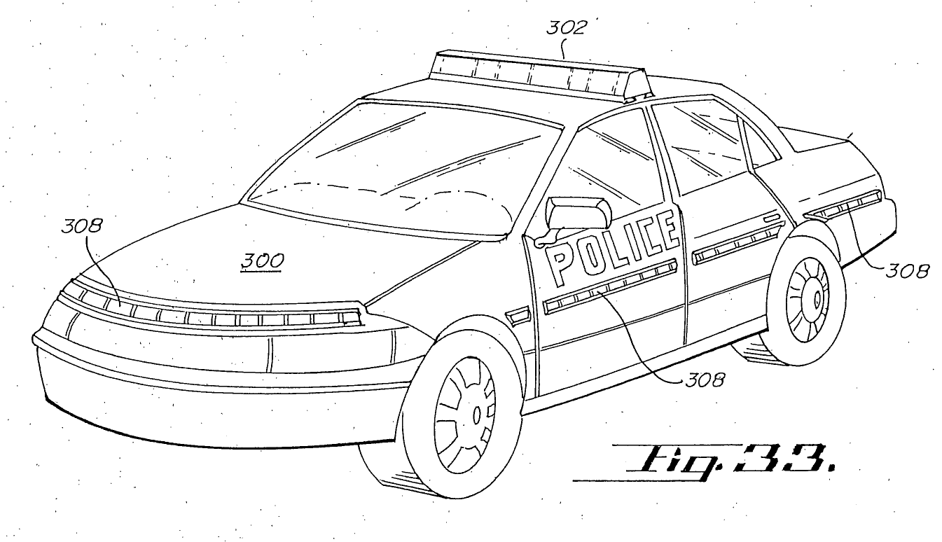

As depicted in FIG. 22, an alternative rotational light fixture 252 is depicted. Rotational light fixture 252 includes a reflector assembly 260 which may be parabolic in shape for the transmission of light along a common axis as depicted by arrows BB for visualization by an individual. In this embodiment, the individual LED module lamps 240 may be positioned to the front of the reflector assembly 260 through the use of a frame 254. The frame 254 may be integral or connected to a gear 250. The gear 250 may be driven by a motor for rotation of the light fixture 252. The individual LED module lamps 240 are in electrical communication with a power source not shown.

The rotational light fixture 252 may also be adapted for the provision of an oscillating or pulsating warning light signal.

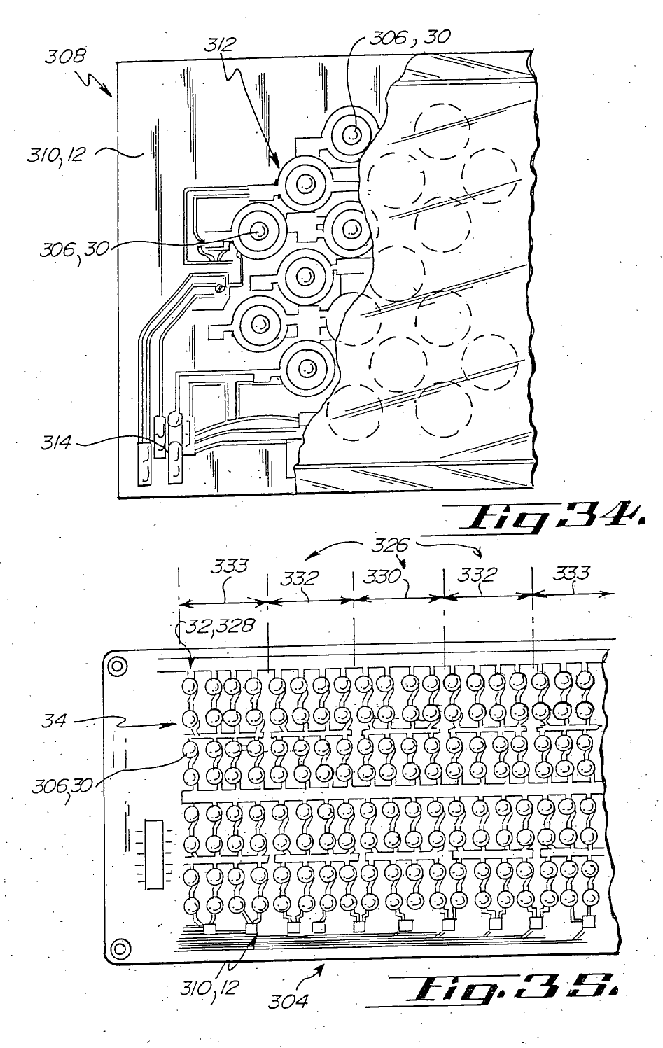

An alternative replacement LED lamp 200 is depicted in FIGS. 23-25. In this embodiment the LED replacement lamp 200 includes a standard mounting base 270. The standard mounting base 270 also includes a plurality of teeth 272. The teeth 272 are adapted for mating coupling with gears integral to a motor and/or reflector 260, or rotational light fixture 246 to facilitate rotation and/or oscillation of the replacement LED lamp 200. The standard mounting base 270 also includes a top surface 274 opposite to the teeth 272.

An upper cylinder portion 276 is adjacent to the top surface 274. The upper cylinder portion 276 includes an upper shoulder 278. Extending upwardly from the upper shoulder 278 is a circuit board, LED mounting surface, or support 280 which includes one or more LED illumination sources 282. The LED illumination sources 282 may be of the same or different colors. A wire 284 is in electrical communication with the LED illumination sources 282 to provide for communication and contact with the controller 50 for combination and/or individual illumination of the LED illumination sources 282. A standard plug-in connector may be integral to the wire 284 to facilitate coupling engagement to the controller 50 and/or power source for a vehicle 104.

The circuit board or LED mounting surface 280 is adapted to include a first side 286 and an opposite side 288. A plurality of LED illumination sources 282 are disposed on both the first side 286 and the opposite side 288 of the replacement lamp 200.

A glass dome or protector 290 is adapted for positioning over the circuit board or LED mounting surface 280 for sealing engagement to the top surface 274 of the standard mounting base 270. The glass dome 290 may be formed of transparent plastic material or a transparent or silicate glass material capable of withstanding heat stress. The glass dome 290 protects the circuit board or LED mounting surface 280 and the LED illumination sources 282 from contamination and from exposure to moisture during use of the replacement lamp 200. In this regard, the sealing lip 292 of the glass dome 290 is securely affixed to the top surface 274 to effectuate sealing engagement there between. The outer diameter of the glass dome 290 is about one inch which is sized to fit within the conventional opening 248 in a typical lamp fixture or reflector assembly 260.

The replacement lamp 200 depicted in FIGS. 23, 24, and 25 is also adapted to be positioned in a one inch light receptacle opening 248 which has been placed into a reflector assembly 260. Illumination of one or more individual LED illumination sources 282 as disposed on the circuit board or LED mounting surface 280 enables the replacement lamp 200 to take on the appearance of a warning signal or emergency signaling lamp.

The replacement lamp as depicted in FIGS. 23, 24, and 25 may alternatively permit the circuit board 280 to extend below the upper shoulder 278 to facilitate affixation and positioning relative to the standard mounting base 270.

The controller 50 may regulate the illumination of the LED light sources 282 individually, or in combination, to provide a desired warning lighting effect for the replacement lamp 200. Also, the controller 50 may illuminate the LED light sources 282 individually, or in combination, independently with respect to the first side 286 and the opposite side 288 to provide different warning light effects to be observed by an individual dependant upon the location of the person relative to the light source. The controller 50 may also simultaneously or independently regulate the light intensity for the LED illumination sources 282 to provide for a pulsating, modulated or variable light intensity for observation by an individual.

In an alternative embodiment, the LED warning signal lamps 10 or LED replacement lamps 200 may be electrically coupled to a controller 50 which in turn is used to provide a modulated light intensity for the light source. A modulated light intensity enables the provision of various light output or patterns of illumination for creation of a plurality of visually distinct warning light signals without the use of mechanical devices. In these embodiments, the controller 50 illuminates selected light sources 282 and the controller 50 may also regulate and/or modulate the duty cycle for the light sources 282, thereby varying the intensity of the observed light. In addition, the controller 50 may modulate the duty cycle for the LED warning signal lamps 10 or LED replacement lamps 200 in accordance with a sine wave pattern having a range of 0 to full intensity. At the instant of full intensity, the controller 50 may also signal or regulate an illumination burst for observation by an individual. The controller 50 operating to regulate and/or modulate the light intensity for the warning signal lamps 10 or LED replacement lamps 200 in conjunction with illumination and non-illumination of selected light source 282 may establish one or more of the types of light signals identified herein.

The controller 50 may also regulate the modulated light intensity for the provision of a unique variable intensity warning light signal. The unique variable intensity light source is not required to cycle through a zero intensity phase. It is anticipated that in this embodiment that the range of intensity will cycle from any desired level between zero to full intensity. A range of light intensity may be provided between thirty percent to full intensity and back to thirty percent as regulated by the controller 50. An irregular pattern of variable light intensity may be utilized to create a desired type of warning light effect. In addition, the controller 50 may also sequentially illuminate adjacent columns 32 to provide a unique variable rotational, alternating, oscillating, pulsating, flashing, and/or combination variable rotational, alternating, pulsating, oscillating, or flashing visual warning light effects. A pulsating warning light signal may therefore be provided through the use of modulated light intensity to create a varying visual illumination or intensity effect. The controller 50 may also modulate the light intensity for any combination of light sources 30 or 282 to provide a distinctive or unique type of warning light signal.

The use of a controller 50 to provide a modulated light intensity for a light source may be implemented in conjunction with replacement lamps 200, flexible circuit boards having LED light sources 30, paneled circuit boards or LED mounting surfaces having LED light sources 30, light bars 70 having LED light sources 30, a cylindrical, square, rectangular, or triangular-shaped circuit boards having LED light sources 30 and/or any other type or shape of LED light sources including but not limited to the embodiments described herein.

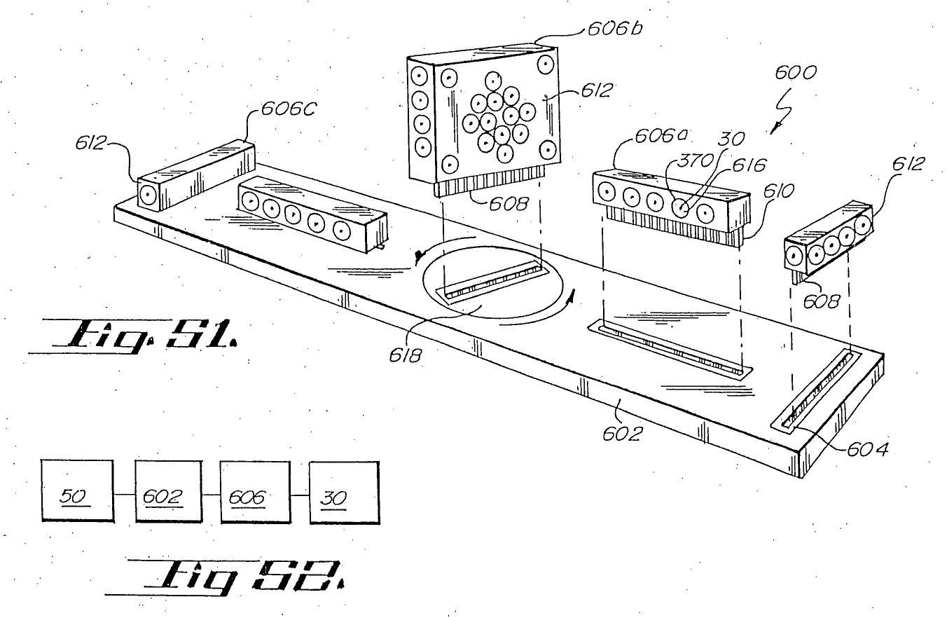

Further, the controller 50 may be utilized to simultaneously provide modulated or variable light intensity to different and/or independent sections, areas, and/or sectors 326 of a light source (FIG. 35). Also, the controller 50 may be utilized to simultaneously provide modulated or variable light intensity to different and/or independent sectors, areas, and/or sections 326 of the forward facing side or rearward facing side of a light support or light bar 70 for the provision of different warning light signals or different warning light effects on each side. In this embodiment it is not required that the forward facing and rearward facing sides of the light support or light bar 70 emit the identical visual patterns of illuminated light sources 30. The controller 50 may regulate and modulate the variable light intensity of any desired sector 326 of the forward facing side independently from the rearward facing side of the light support or light bar 70. An infinite variety of patterns and/or combinations of patterns of warning light signals may be provided for the forward facing side and the rearward facing side of the light support or light bar 70.

The modulated light intensity may be regulated by the controller 50 to create a unique warning light signal within a single sector 326 or in conjunction with multiple separated or adjacent sectors 326 of light bar 70 or light support for the provision of any desired composite emergency warning light signal. All individual LED light sources 30 within a light bar 70 or light support may be simultaneously exposed to incrementally increased modulated light intensity to provide for an incremental increase in illumination. An illumination burst may be provided at any time during the incremental increase of illumination. The modulation of the light intensity in conjunction with the incremental increase in illumination of all LED light sources 30 within light bar 70 or light support may provide the appearance of rotation of a warning light signal when observed by an individual. The illumination of the individual light sources 30 may then be incrementally decreased. The light intensity is not required to be regularly incrementally increased or decreased or terminated. It is anticipated that any regular, irregular, variable, pulsating, and/or modulated variable light intensity may be provided by the controller 50 to the LED light sources 30.

All individual LED light sources 30 within a light bar 70 or light support are not required to be simultaneously and incrementally illuminated to provide for the appearance of rotation. For example, a light bar 70 or light support may be separated into one or more distinct segments 326 which are formed of one or more columns 32 of LED light sources 30. A particular segment 326 may be selected as a central illumination band which may receive the greatest exposure to the modulated or variable light intensity and, therefore, provide the brightest observable light signal. An adjacent segment 332 may be disposed on each side of the central illumination band 330 which in turn may receive modulated or variable light intensity of reduced magnitude as compared to the central illumination band 330. A pair of removed segments 333 may be adjacent and exterior to the segments 332, and in turn, may receive exposure to a modulated light intensity of reduced magnitude as compared to segments 332. The number of desired segments may naturally vary. The controller 50 may thereby regulate the light intensity to provide a modulated or variable light signal for each individual segment 330, 332, or 333 (FIG. 35) to provide for a unique warning light effect for the light bar 70 or light support.

The provision of a modulated light intensity to the light bar 70 or light support may also be coupled with, or in combination to, the sequential illumination of columns 32 as earlier described. In this situation, the warning light signal may initially be dim or off as the individual columns 32 are sequentially illuminated and extinguished for illumination of an adjacent column or columns 32. The light intensity for the illuminated column or columns 32 may simultaneously be incrementally increased for a combination unique rotational and pulsating modulated or variable warning light signal.

Each individual LED light source 30 preferably provides an energy light output of between 20 and 200 or more lumens. Each support 12 may be controlled as part of an overall warning light signal or pattern where individual supports 12 may be illuminated to provide a desired type or combination light signal in addition to the provision of a modulated or variable light intensity for the light source 30.

Modulated light intensity may be regulated by the controller 50 to create the appearance of rotation within a single support 12 or in conjunction with multiple separated, independent or adjacent supports 12 for the provision of a composite emergency warning light signal.

The controller 50 may also provide for the random generation of light signals without the use of a preset pattern of variable light intensity. Controller 50 provides a means for activating LED's 30 individually to allow for greater flexibility in the type of warning light signal created. This embodiment of the invention is also capable of displaying information in a variety of different colors or sequential illumination of colors.

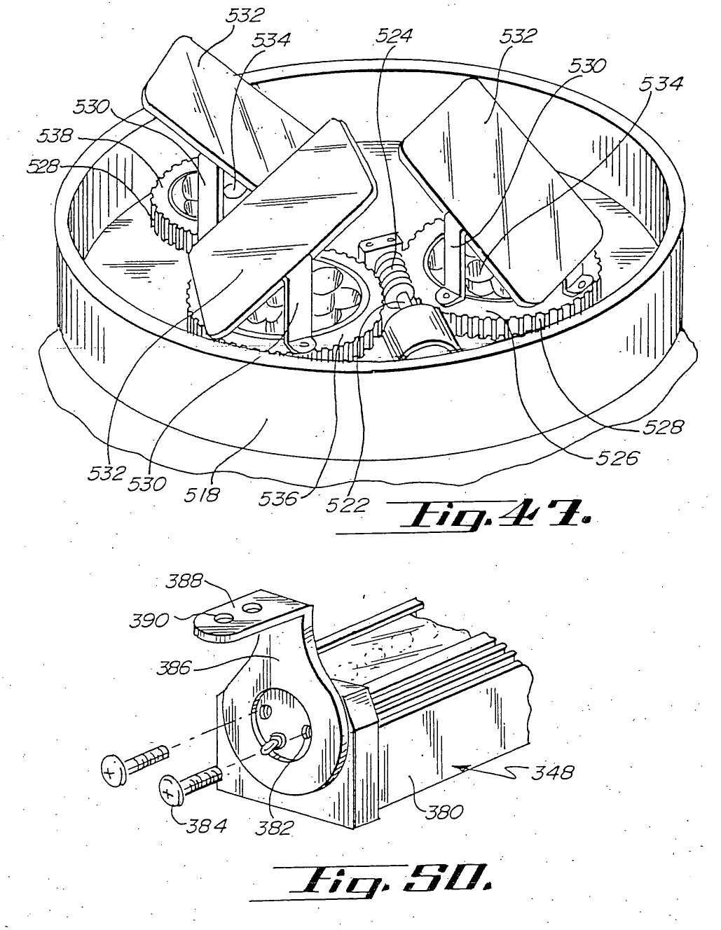

Referring to FIG. 33, the emergency vehicle 300 includes a light bar or light support 302 which may include one or more panels of LED light sources 306. A strip LED light source 308 may also be secured to the exterior of the emergency vehicle 300 at any location. It is anticipated that the strip LED light source 308 may encircle an emergency vehicle 300 to enhance the visualization of the emergency vehicle 300 positioned proximate to an emergency situation.

Referring to FIG. 34, the strip LED light source 308 is comprised of a circuit board 310 having an array 312 of individual LED light sources 306. The LED light sources 306 are in electrical communication with each other via electrical contacts 314. Each circuit board 310 is in electrical communication with a power supply and/or controller 50 via the use of wires 316. Each individual LED light source 306 as included within a strip LED light source 308 may be enclosed within a reflector 370 to facilitate and maximize light output along a desired visual line of sight. The LED light sources 306 have maximum illumination at an angle of incidence approximately 40°-45° downwardly from vertical. The strip LED light sources 308 also include a back-side. The back-side includes an adhesive, magnetic, or other affixation device which may be used to secure the strip LED light sources 308 to the exterior of an emergency vehicle 300 in any desired pattern or location. The strip LED light sources 308 may also be enclosed within a transparent cover 324 which prevents moisture or other contamination from adversely affecting the performance of the LED light sources 306 during use.

Wires of adjacent strip LED light sources 308 may be intertwined to extend across a vehicle for coupling to a power supply at a central location. The wires may be connected to the controller 50 which may be used to regulate the illumination of individual LED light sources 306 and/or individual panels of the strip LED light sources 308 to provide the types of light signals previously identified herein. The individual LED light sources 306 within the strip LED light source 308 may be of a single or variety of colors as earlier described. Adjacent strip LED light sources 308 may be electrically coupled to each other in parallel or series electrical connections for electrical communication to a centrally located controller and power source.

The individual LED light sources 306 as incorporated into the array 312 of the strip LED light sources 308 are sturdy and do not fail or separate from a vehicle 300 when exposed to rough operating conditions. The transparent cover 324 for the strip LED light sources 308 may be formed of sturdy and resilient plastic material which prevents water penetration and/or contamination to the circuit board 310 and/or individual light sources 306.

The strip LED light sources 308 may individually be formed into supports of any size. It is anticipated that the strip LED light sources 308 may have the approximate dimensions of three inches in length, three inches in width, and one-half inch in thickness for use in affixation to the exterior of an emergency vehicle 300.

Referring to FIG. 35, a panel 304 of individual LED light sources 306 is depicted. The panel 304 may form the illumination element for the strip of LED light sources 308 and/or light bar 70 or light support 12, 302 as affixed to an emergency vehicle 300. Each panel 304 contains a plurality of rows 34 and columns 32, 328 of individual LED light sources 306. The panels 304 are in electrical communication with the controller 50 and power supply (now shown). The panels 304 may be controlled individually to create a desired warning light signal for an emergency vehicle 300. Each panel 304 may be controlled as part of an overall warning light signal or pattern where individual panels 304 or combinations of individual panels 304 may be illuminated to provide for the appearance of rotation and/or oscillation through the selective illumination of light sources or through the use of a modulated light intensity light source.

The strip LED light sources 308 may be organized into distinct sections, segments, and/or sectors 326 for individual illumination by the controller 50. Each distinct segment, section, and/or sector 326 may therefore be illuminated with a visually different and distinct type of light signal with, or without, modulated or variable light intensity, for the creation of a desired type of unique warning lighting effect for a vehicle. An infinite variety of colors and/or patterns, combinations, or sequences of light signals may be established for the emergency vehicle 300 through the use of the controller 50.

Modulated light intensity may be regulated by the controller 50 to create the appearance of rotation or pulsation within a single panel 304, strip 308, or in conjunction with multiple separated or adjacent panels 304 or strips 308 for the provision of a composite warning light signal. The warning light signal for each or a group of panels 304 or strips 308 may also be regulated by the controller 50 for the provision of a modulated light intensity for an observable warning light signal. All individual LED light sources 306 within a panel 304 or strip 308 may also be exposed to an incrementally increased modulated duty cycle or light intensity to provide for the incremental increase in illumination for a warning light signal. The modulation or light intensity curve is anticipated to resemble a sine wave pattern when the warning light signal provides the appearance of rotation (FIG. 43). After a desired level of illumination has been obtained, the duty cycle for the individual light sources 306 may then be incrementally decreased. The duty cycle is not required to be terminated. Each individual LED light source 306 is not required to receive the same level of duty cycle from the controller 50. Therefore, different individual LED light sources 306 may receive different duty cycles within a single warning light signal. Individual LED light sources 306 within panel 304 are not required to be simultaneously and incrementally illuminated to provide for the appearance of rotation. It is anticipated that a pulsating and/or modulated variable light intensity may be provided by the controller 50 for regulation of the duty cycle from thirty percent to maximum and back to thirty percent which affords a desirable type of pulsating modulated variable light effect.

The provision of a modulated light intensity to the panels 304 may also be coupled with, or in combination to, the sequential illumination of columns 328 as earlier described. In this situation, the warning light signal may initially be dim or off as the individual columns 328 are sequentially illuminated and extinguished for illumination of an adjacent column or columns 328. The duty cycle or light intensity for the illuminated column or columns 328 may simultaneously be incrementally increased for a combination unique rotational and pulsating modulated light signal. In addition, the controller 50 may be programmed to provide the appearance of rotation pulsation and/or oscillation or for illumination of other types or combinations of types of lighting effects.

The provision of a modulated light intensity may be implemented in association with a light bar or light support 302, a cylindrical panel, a strip of lights 308, flat panels 304, or any other type of light source as described herein.

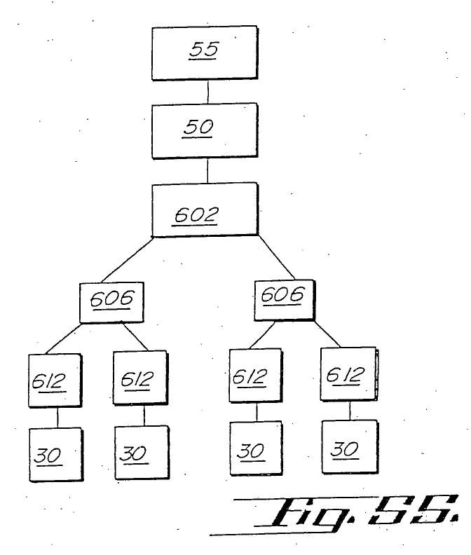

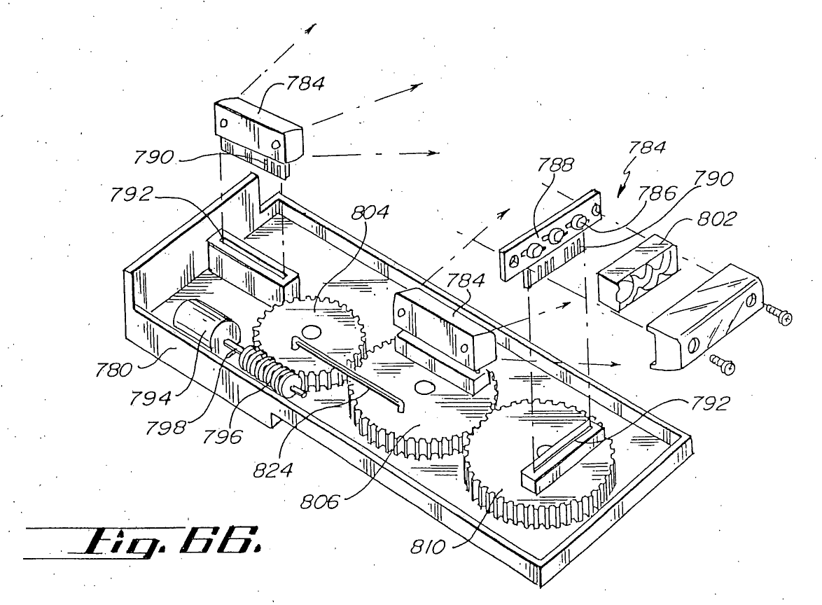

Referring to FIGS. 48 and 49, an individual LED light source 306 is depicted in detail. The LED light source 306 may include a ceramic and/or heat resistant base 334. Centrally within the ceramic and heat-resistant base 334 is positioned a light source 336. The light source 336 may be enclosed within a protective cover 338. Extending outwardly from the individual light source 306 are a pair of contact paddles 340 which provide for the electrical contacts for illumination of the light sources 336 during use. The back of the LED light source 306 includes a slug 342. The slug 342 is designed to be positioned within circular openings 344 of a circuit board or LED mounting surface 346 (FIG. 36). The circuit board or LED mounting surface 346 establishes a heat sink within an aluminum base or frame 348 as depicted in FIGS. 38 and 39. The LED light sources 306 as depicted in FIGS. 48 and 49 provide for a light intensity varying between 20 and 200 lumens or higher. The positioning of the slug 342 in the circular openings 344 of the circuit board or LED mounting surface 346 assists in the establishment of the heat sink. A heat sink is desirable because the individual LED light sources 306 may have a sufficient level of light output during use to develop heat. As a result, the slugs 342 are positioned within the circular opening 344 and may be fully engaged to an adhesive for affixation to an aluminum base 348 (FIG. 38 and 39). This combination assists in the dissipation of heat during use of the individual LED light sources 306 enhancing the performance of the light support 302.

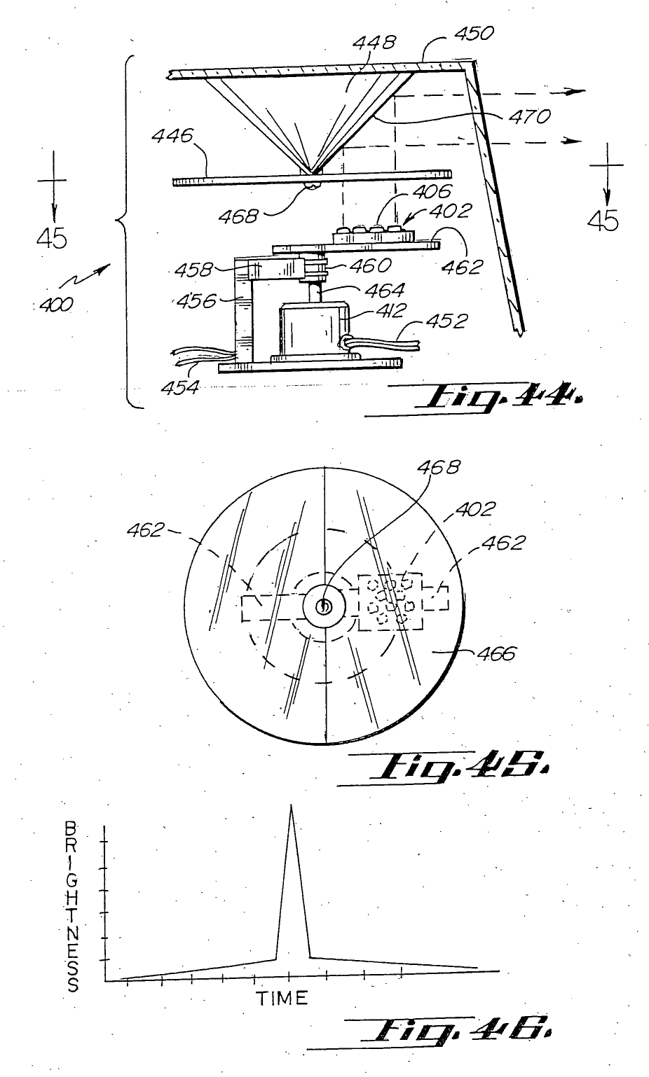

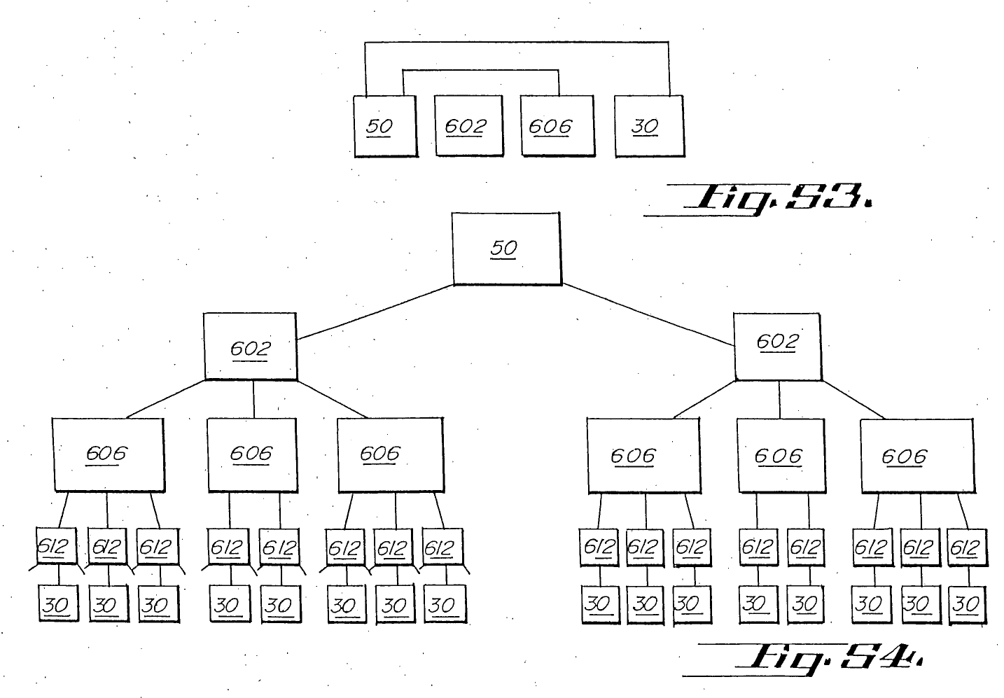

As may be seen in FIGS. 31, 32, 37 and 50, in an alternative embodiment, the light bar, light support 302, or panel 304 may be formed of a single row of LED light sources 306. Within this embodiment, the LED light sources 306 are positioned within circular openings 344 of circuit board or LED mounting surface 346 (FIG. 37). Circuit board 346 may be affixed to aluminum base 348 through the use of adhesive including glass beads where the circular openings 344 assist in the establishment of a heat sink for the individual LED light sources 306. The use of adhesive including glass beads to affix the LED light sources 306 and circuit board 346 to the aluminum base 348 assists in the creation of electrical contact for the light bar or light support 302.

As depicted in FIG. 37 the top surface of the circuit board or LED mounting surface 346 may include two reflectors or mirrors 350. The reflectors or mirrors 350 are preferably elongate and are positioned substantially parallel to each other and are adjacent or aligned to the rows of individual LED's 306. The reflectors or mirrors 350 diverge upwardly and outwardly from a position proximate to the LED light source 306 and aluminum base 348. As such, the mirrors 350 have a separation distance which is narrow proximate to the LED light sources 306, where the separation distance becomes larger as the distance vertically from the aluminum base 348 increases.

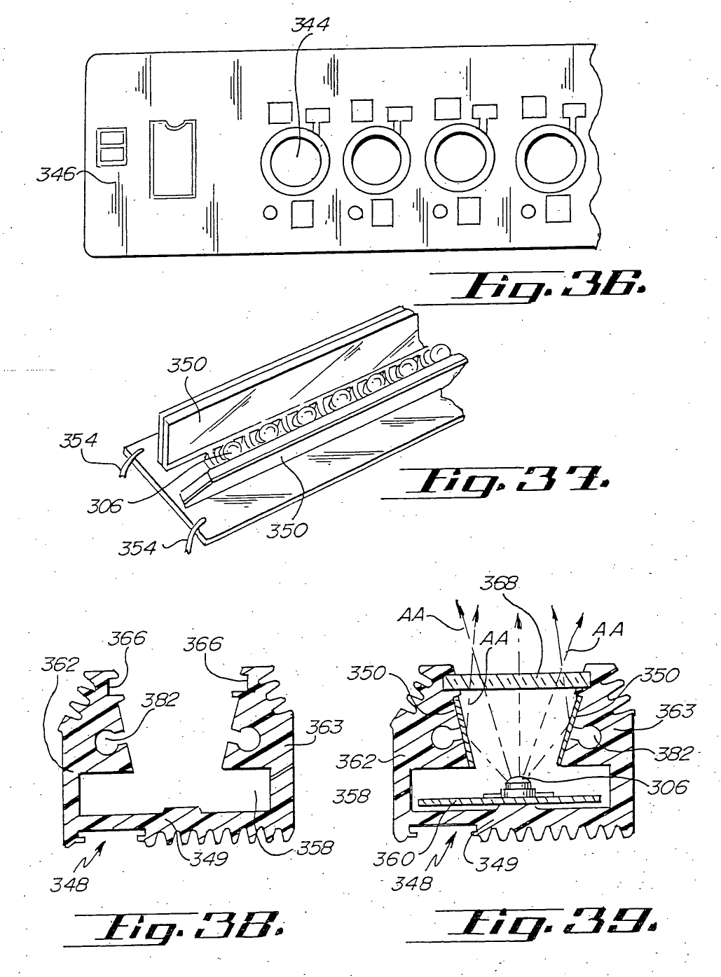

The brightest or most intense light of the individual LED light sources 306 is provided at an acute angle of approximately 40° to 42°. The reflector or mirror 350, as angled upwardly and outwardly relative to the row of LED light sources 306, reflects light exiting the LED light sources 306 along a desired line of sight which corresponds to perpendicular observation by an individual. The reflectors or mirrors 350 maximize the efficiency of the light sources 306 by reflecting light along the line of sight to be observed by an individual during an emergency situation. The reflectors or mirrors 350 may have a polished or non-polished surface depending on the brightness desired for the light support 302. The reflectors or mirrors 350 may also include one or more reflective sections 374 and/or transparent or clear sections 372. The transparent or clear sections 372 and the reflective sections 374 are described in detail with reference to FIGS. 26-30 below. The surface of the reflectors or mirrors 350 may also include any desired combination of sections, patterns, stripes, rows, and/or columns of clear or transparent sections 372 and/or reflective sections 374 for reflection of light illuminated from the individual LED light sources 306 during the provision of a warning light signal.

Wires 354 connect the circuit board 346 to the power supply and controller 50. A modulated light source may thereby be provided to the light support 302 which includes the reflector or mirrors 350. In this embodiment, the sequential illumination of individual LED's 306 may occur to provide a desired type of warning light signal. Also, the circuit board 346 as engaged to the base 348 may be separated into segments 326 of LED light sources 306 for use in combination with a modulated light intensity electrical source.

As depicted in FIGS. 38 and 39, the aluminum base 348 includes a floor 349. The floor 349 may include a holding cavity 358. In the holding cavity 358 is preferably positioned a circuit board or LED mounting surface 360 which includes a plurality of circular openings 344. In each circular opening 344, is positioned an individual LED light source 306. Above the holding cavity 358 is a first support 362 and a second support 363. The first support 362 and second support 363 each may have an angled interior edge 364. Each angled interior edge 364 is adapted to receive a reflector or mirror 350. Each mirror 350 is utilized to reflect light illuminated from an individual light source 306 along a visual line of sight as depicted by arrow AA of FIG. 39. The first and second supports 362, 363 may also include a positioning ledge or notch 365 which is adapted to receive a glass or transparent plastic cover lens 368 which serves as a protector for the base 348 and individual LED light sources 306.

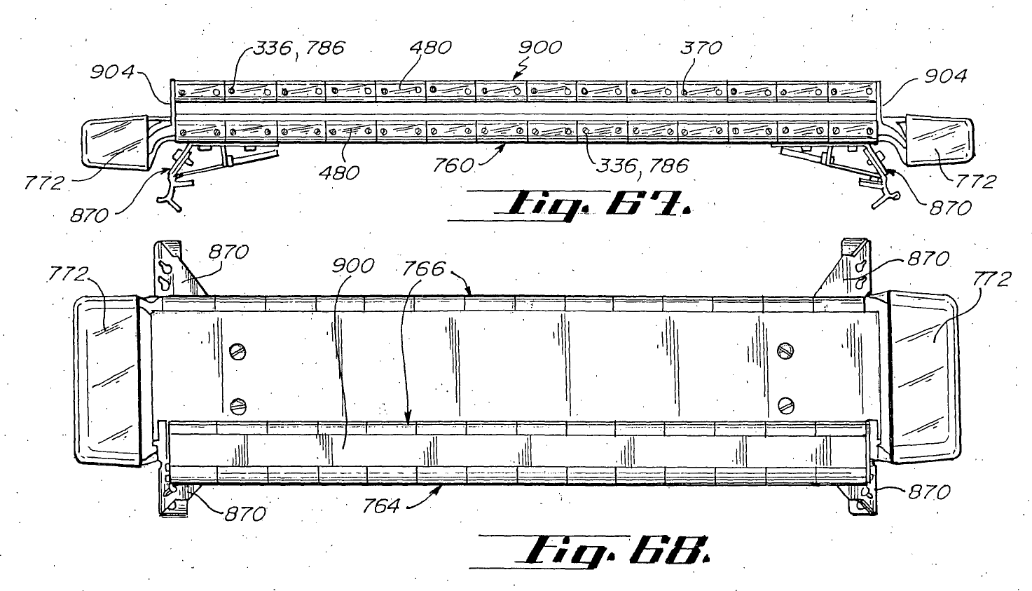

Referring to FIG. 50, the frame 348 may be elongate having a first end 380 and a second end (not shown). The first end 380 and the second end each include and affixation area 382 which may be threaded for receiving engagement to a fastener 384. A bracket 386 may be rotatably engaged to the first end 380 and second end by tightening of the fasteners 384 relative to the affixation areas 382. The bracket 386 includes and angled portion 388 which may include a second fastener 390 which may be formed of suction cups. Alternatively, the second fastener 390 may be screws, bolts, and/or rivets for attachment of the frame 348 at a desired location relative to the interior or exterior of a vehicle 300.

Referring to FIGS. 26-30, a reflector or culminator for the individual LED light sources 306 is disclosed. The reflector or culminator is indicated in general by the numeral 370. The reflector or culminator 370 may be conical in shape and may be configured to encircle an individual LED light source 306. The reflector or culminator 370 may also be partially transparent. The reflectors 370 may be formed of clear sections 372 and/or reflective sections 374. In FIG. 29, the clear section 372 is positioned proximate to the LED light source 306 and the reflective section 374 is positioned to the top of the reflector 370.

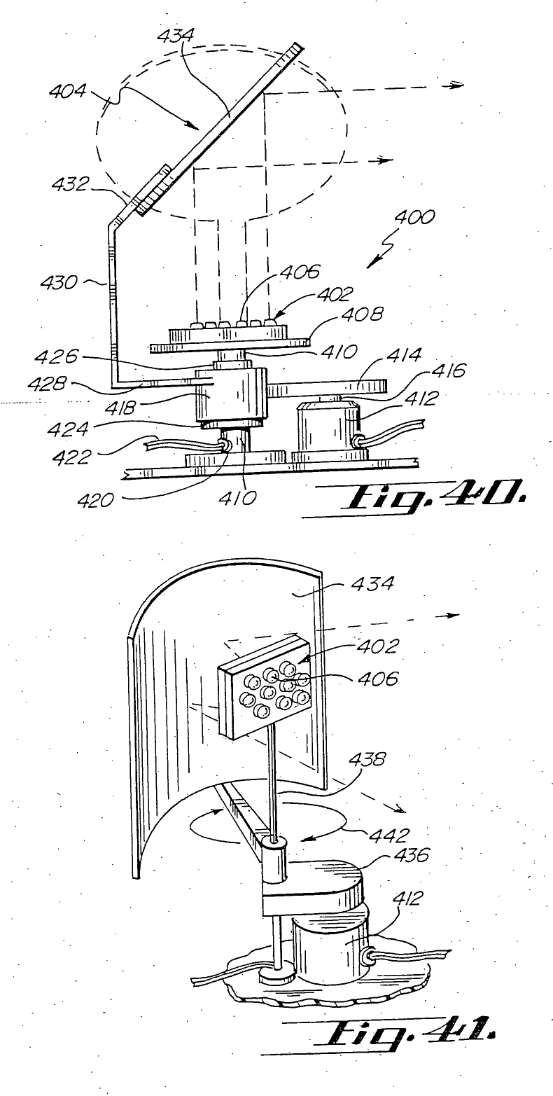

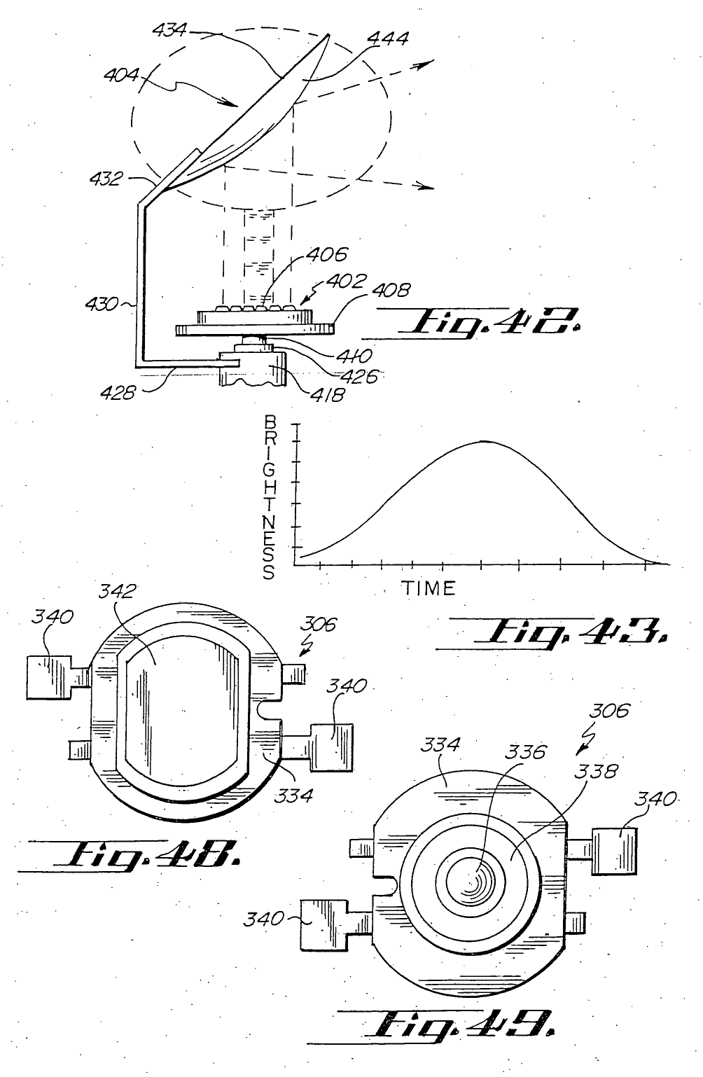

In FIG. 28, the reflective section 374 is positioned proximate to the LED light source 306 and the clear section 372 is positioned to the top of reflector or culminator 370. As may be seen in FIG. 30, the entire interior surface of the reflector or culminator 370 may be formed of a reflective section 374. A plurality of clear sections 374 may be utilized within each reflector or culminator 370.

The use of a combination of clear sections 372 and reflective sections 374 enable an individual to select a configuration for the provision of partial illumination along an angle which is not parallel to a desired line of sight. An individual may thereby observe an illuminated light signal from the side or top of a light bar or light support 302 as opposed to being aligned with a desired line of sight.

Each of the culminator or reflector cups 370 includes an angled interior surface which extends upwardly and diverges outwardly from a central opening 394. Each central opening 394 is constructed and arranged for positioning approximate to and over an LED light source 306. Each of the culminator or reflector cups 370 also preferably includes an angled exterior surface which extends upwardly and diverges outwardly from a bottom or base which is positioned proximate to an LED mounting surface or circuit board 346.

Referring to FIG. 26 a plurality of culminator cups or reflectors 270 may be formed into a culminator assembly or array 392. The culminator assembly or array 392 is adapted for positioning over an array of LED light sources 306. Examples of arrays of LED light sources 306 which may be utilized with a culminator assembly 392 are depicted in FIGS. 3-10, 12, 14, 15, 23-25, 31, 32, 34, 35, 37, 39, 40, 44, and 47.

Each culminator array 392 is formed of a reflective material which has plurality of reflective cups 370 disposed therethrough. Each opening 394 is adapted for positioning over an LED light source 306. The culminator array 392 has a sufficient thickness to establish an interior reflective surface having a sufficient dimension to reflect light as emitted from the LED light sources 306. Alternatively, the interior surface of each reflector cup 370 may be entirely or partially coated with reflective material. The entire culminator assembly 392 is not required to be formed of reflective material provided that the interior surface of the reflector cups 370 are coated at least partially with reflective material.

The culminator array 392 may be formed in any shape including but not necessarily limited to square, rectangular, triangular, linear, circular, oval, and special or other irregular shapes for use in reflecting light emitted from an LED light source 306. The interior surface of any desired number of culminator cups 370 may also be coated with reflective 374 and non-reflective 372 sections as earlier described.

The strip LED light source 308 and LED light sources 306 in frame 348 are designed to operate on a 12 volt power supply which is available in a standard emergency vehicle battery. The frame 348 and strip LED light source 308 are enclosed in a waterproof protector to minimize the risk of contamination or failure from any exposure to moisture or dust or dirt. The use of the strip LED light sources 308 and frame 348 minimize the necessity to modify the exterior of an emergency vehicle 300 through the placement of holes or other apertures. In these embodiments, the wires 354 and 316 may be adhesively secured to the exterior of a vehicle for entry into the power source and controller 50 at a common location.

The strip LED light source 308 may be used on other devices and are not necessarily limited to use on an emergency vehicle 300. It is anticipated that the strip LED light sources 308 may be used on a variety of apparatus including but not limited to snowmobiles, water craft, helmets, airplanes, or any other device which may accept use of an LED light source.

In FIGS. 40-43 a warning signal light 400 is depicted which in general includes a light source 402 and a rotatable reflector 404. The light source 402 may include one or more individual LED illumination devices 406. The light source 402 may include a base 408 which may be mounted on a post 410. The light source 402 may either be stationary or rotate as desired.

A motor 412 is electrically connected to a power supply for rotation of a wheel or gear 414. The wheel or gear 414 is connected to the motor 412 by a shaft 416. The wheel or gear 414 is in contact with, or is engaged to, a rotatable collar 418 which may be adapted to rotate freely about the post 410 during operation of the motor 412. The wheel or gear 414 may be formed of rubber or any other desired material. Alternatively, the wheel 414 may include teeth and function as a gear for engagement to corresponding grooves and teeth as integral to the exterior surface of the collar 418.

An aperture 420 may pass through post 410 to receive wires 422 for the provision of power to LED light source 402. A washer or support device 424 vertically supports rotatable collar 418 on post 410 from a position below collar 418. A positioner 426 functions to restrict the vertical movement of the collar 418 upwardly during engagement of the motor 412 and rotation of the wheel 414 and collar 418.

A horizontal support arm 428 extends outwardly from collar 418. A vertical support arm 430 extends upwardly form horizontal support arm 428. Angular support arm 432 extends inwardly and upwardly from vertical support arm 430 for positioning of a reflector or mirror 434 above light source 402. The reflector or mirror 434 is positioned at an approximate angle of forty-five degrees relative to the light source 402. Light as emitted vertically from the light source 402 may then reflect from the reflector 434 along a substantially perpendicular line of visual sight. The reflector 434 rotated ninety degrees is depicted in phantom line as an oval due to the angular offset of approximately forty-five degrees.

The use of motor 412 rotates wheel 414 which in turn rotates collar 418 and reflector 434 in a circular direction about light source 402 for the provision of an observed rotational warning light source. In addition, the light source 402 may be electrically coupled to a controller 50 to provide a modulated, alternating, variable, pulsating, or oscillating light source simultaneously to the rotation of the reflector 434 about light source 402.

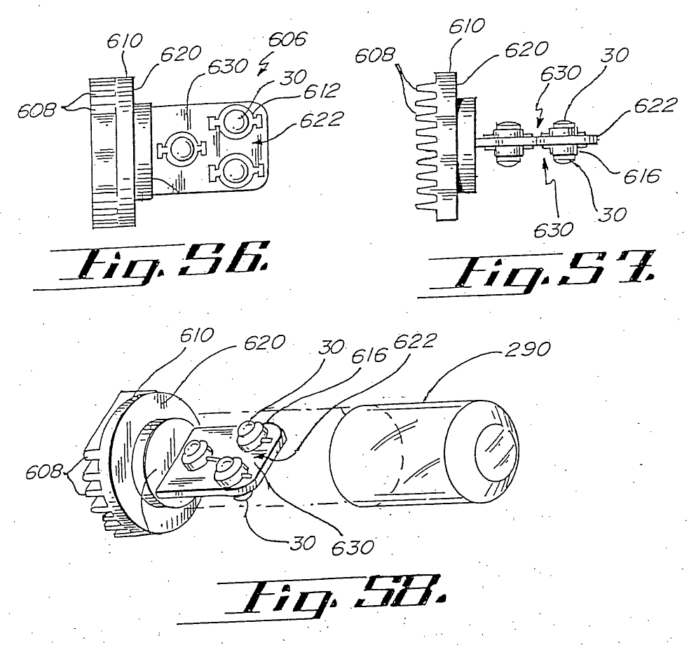

Referring to FIG. 41 the warning signal light 400 includes a light source 402 which is rotatable in conjunction with the reflector 434. In this embodiment the motor 412 is connected to a first gear which is enclosed within casing 436. A second gear is also enclosed within casing 436 and is coupled to the first gear for rotation of the reflector 434. A vertical rod 438 is affixed or integral to the second gear. The vertical rod 438 supports the LED light source 402 as positioned adjacent to reflector 434. An angled brace 440 is also engaged to rod 438. Angled brace 440 supports reflector 434 during rotation of reflector 434 which represents a circular motion as depicted by arrow 442. In this embodiment reflector 434 is arcuate in shape and may be parabolic. Light emitted from light source 402 may then be reflected by the arcuate reflector 434 along a desired line of sight. The engagement of the motor 412 rotates the light source 402 and reflector 434 to provide a rotational light source as observed by an individual. The light source 402 may be coupled to a controller 50 to provide for a modulated, alternating variable, and/or pulsating light signal in conjunction with the rotation of the reflector 434.

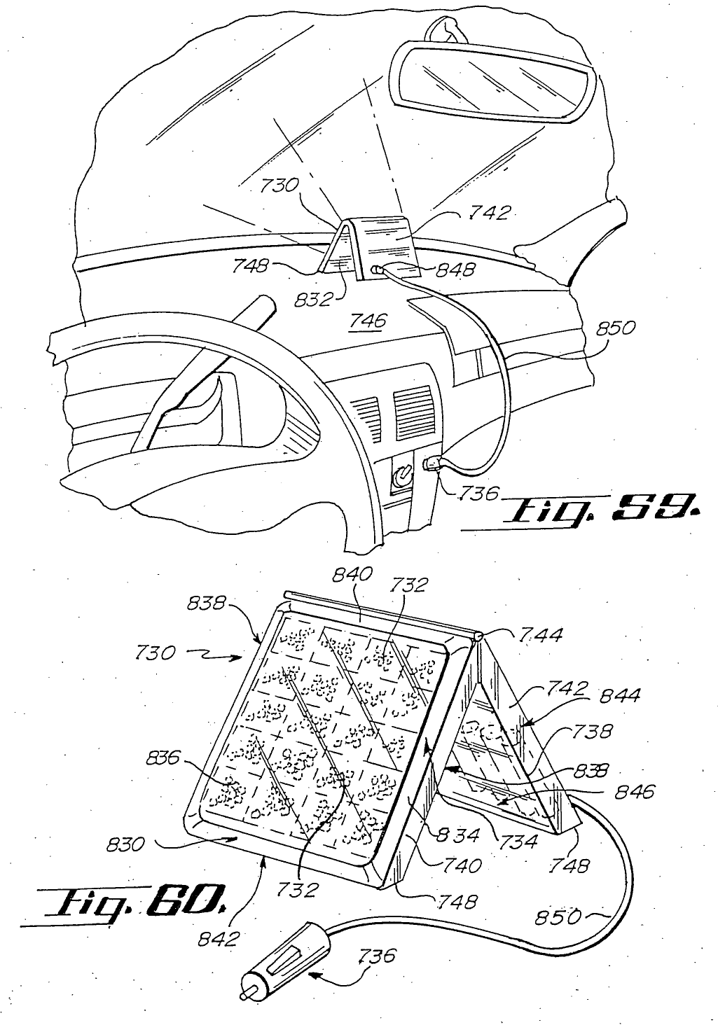

Referring to FIG. 42, the reflector 434 is not required to be flat and may include a convex or concave face 444. The provision of a convex or concave face 444, is utilized to assist in the creation of a unique variable light effect as observed by an individual. Light as emitted from the light source 402 may then be reflected at any desired angle other than perpendicular for observation by an individual. The pulsating intensity of the light as observed by an individual may then be unique, especially when used in conjunction with the rotated reflector 434 and variable or modulated light intensity from the controller 50. In addition, the use of a convex or concave reflector 444 may expand or enhance the observation of the warning signal light 400 by individuals beyond a perpendicular line of sight. The warning signal light 400 may then be observed above or below a light source 402. The reflector 434 as rotated ninety degrees is depicted in phantom line and is generally oblong or oval in shape.

FIG. 43 represents graphically the variable or pulsating illumination of the observed light as reflected from the reflector 434 of FIG. 42. Time is represented along the x-axis and increasing brightness is depicted along the y-axis. The graph of FIG. 43 shows the gradual increase in brightness of the observed light as the reflector 434 is rotated to a maximum illumination corresponding to direct in line observation of the warning light signal, and then the gradual decrease in observed light intensity as the reflector 434 is rotated away from direct in line sight. The observed warning light signal is not required to be extinguished and may be reduced to a minimum observable intensity of approximately thirty percent or lower.

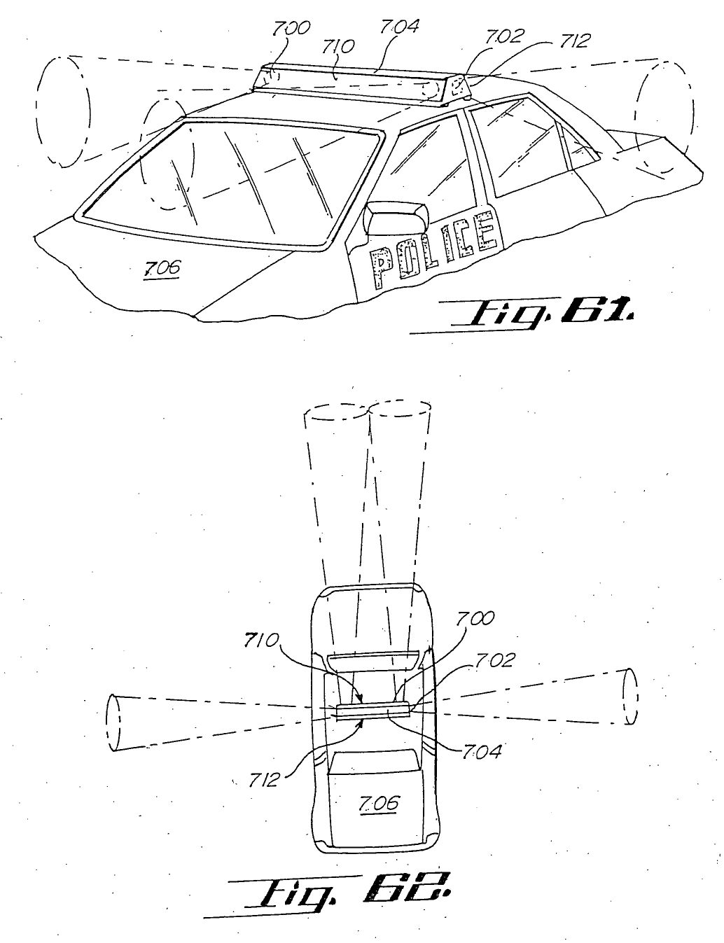

Referring to FIG. 44, the warning signal light 400 in general includes a light source 402 which may be rotated through the use of a motor 412 for transmission of light through a filter 446 for reflection from a conical reflector 448 as mounted to the interior of a light bar or light support 450.

Power for motor 412 is supplied through wires 452 from a power source not shown. Power for the light sources 402 is provided through wires 454 in support 456. Brushes 458 may be in electrical communication with the power from the wires 454 to transmit electrical current to a second set of brushes 460 utilized to communicate power to the light sources 402. The base 462 of the light source 402 may preferably be formed of an electrically conductive material to facilitate the provision of power to the light sources 402.

A shaft 464 preferably extends between the motor 412 and the base 462 where operation of the motor 412 causes rotation of the shaft 464 and the base 462 having the light sources 402. Light is transmitted vertically upward from the light sources 402 through the filter 446. (FIGS. 44 and 45.) The filter 446 may include one or more sections of tinted material 466. The filter 446 may be stationary or may be rotatable. The tinted material 466 may be any color or opaque to establish a desired illumination effect for an emergency warning signal light. Any number of tinted sections 466 or transparent areas may be placed on the filter 446. The filter 446 may be formed of glass or plastic or other sturdy material. The tinted sections 466 may be integral to or placed upon the filter 446 dependent upon construction considerations. The filter 446 may be attached to the conical reflector 448 by a fastener 468.

The conical reflector 448 may include a straight reflective edge 470. Alternatively, the reflective edge 470 may be concave or convex to establish a unique lighting effect. The conical reflector 448 may be affixed to, and descend from, the top of a light bar or light support 450 as may be attached to an emergency vehicle 300.

Light transmitted upwardly from the light sources 402 passes through either a substantially transparent section or through the tinted or opaque material 466 which may block light transmission or alter the color of the light. Light is then reflected from the conical reflector 448 at a desired angle for transmission through the light bar or light support 450 for observation by an individual.

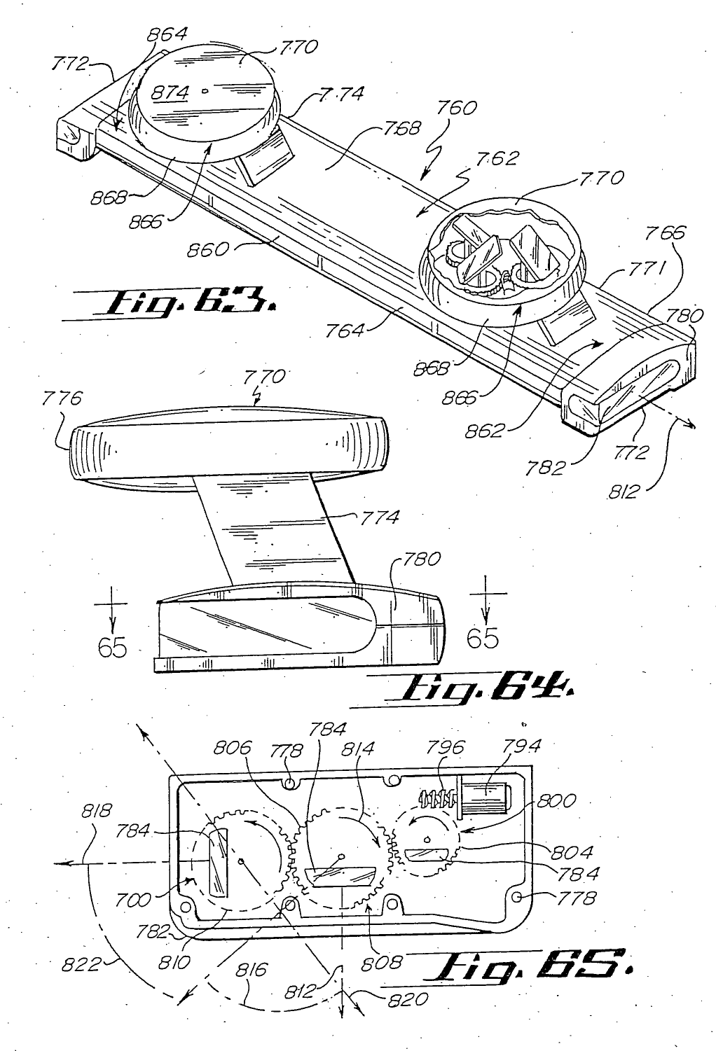

FIG. 46 represents graphically the intensity of the observed light as reflected from the conical reflector 448 of FIG. 44. Time is represented along the x-axis and observed brightness is represented along the y-axis. The observed light signal transmitted from the warning signal light of FIG. 44 is much steeper which corresponds to a shorter period of observation more similar to a flashing light signal. The light sources may also be coupled to a controller 50 for the provision of a variable, modulated and/or pulsating light effect.

Referring to FIGS. 31 and 32 a modular light support 480 in general includes an LED mounting surface 482 having one or more LED light sources 306, a culminator assembly 484 and a cover 324.

The LED mounting surface 482 is elongate and includes a plurality of LED light sources 306. In general, one to five LED light sources 306 are disposed in a linear orientation along the LED mounting surface 482 which may be a circuit board as earlier described. The LED mounting surface 482 also includes a first end 486 and a second end 488. An opening 490 is positioned through the LED mounting surface 482 proximate to each of the first end 486 and second end 488.

The culminator assembly 484 preferably includes a plurality of reflector cup areas 492. The culminator assembly 484 also preferably includes a plurality of support walls 494, a top surface 496, and a plurality of openings 490. Each of the openings 490 is sized to receivingly position and hold the individual LED light source 306 during assembly of the modular light support 480. The reflector cup areas 492 are equally spaced along the culminator 484 to correspond to the spacing between the individual light sources 306 as disposed on the LED mounting surface 482.

The cover 324 is preferably transparent permitting transmission of light emitted from the LED light sources 306 therethrough. The cover 324 includes a forward face 498, a pair of end faces 500, a top face 502 and a bottom face 504. Each of the pair of end faces 500 includes a receiving notch 506 which is adapted to receivingly engage the LED light mounting surface 482 during assembly of the modular light support 480. An affixation opening 508 traverses the forward face 498 proximate to each of the pair of end faces 500. A fastener 510 passes through the affixation opening 508 for engagement to the opening 490 to secure the LED mounting surface 482 into the receiving notch 506. The culminator assembly 484 is then positioned within the interior of the cover 324 where the top surface 496 is proximate to the forward face 498. The illumination of the LED light sources 306 then transmits light through the forward face 498 for observation of an emergency warning light signal.

Specifically referring to FIG. 32 one or more modular light supports 480 may be positioned adjacent to each other for the creation of a light bar or light stick 512. The modular light supports 480 and/or light bar or light stick 512 may be coupled to a controller 50 which may independently and/or in combination provide a plurality of independent and visually distinct warning light signals as earlier described. In addition, the controller 50 may provide modulated and/or variable light intensity to the individual LED light sources 306 to establish unique warning light signal effects. The controller 50 may individually illuminate LED light sources 306 to provide for one or a combination of colored light signals as earlier described.

Any number of modular light supports 480 may be positioned adjacent to each other to comprise a light bar or light stick 512. A plurality of modular light supports 480 may be positioned at any location about the exterior or within the interior of a vehicle.

Referring to FIG. 47 an alterative embodiment of a reflector assembly is disclosed. In general, the reflector assembly of FIG. 47 includes an enclosure 518. Positioned within the interior of enclosure 518 is a motor 520 having a shaft 522 and a gear 524. A first support 526 has a periphery having a plurality of teeth 528 adapted to releasably engage the gear 524. The first support 526 includes a mirror bridge 530 which is used to position a mirror 532 at an approximate angle of 45° relative to a LED light source 306. Within the interior of the first support 526 is located a culminator assembly 534 which may include one or more reflective cups. Individual LED light sources 306 are positioned within each of the culminator cups of the culminator assembly 534 to maximize illumination of emitted light for reflection from the mirror 532.

On the opposite side of gear 524 is located second support 536. Second support 536 also includes a periphery having a plurality of teeth 528, a mirror bridge 530, a mirror 532, and a culminator assembly 534 disposed adjacent to a plurality of individual LED light sources 306.

A third support 538 is adjacent to the second support 536. The third support 538 also includes a periphery having a plurality of teeth 528, a mirror bridge 530, and a mirror 532 disposed at a 45° angle above a culminator assembly 534. A plurality of individual LED light sources 306 are disposed within the reflector cups of the culminator assembly 534. The teeth 528 of the third support 538 and second support 536 are coupled so that rotational motion provided to the second support 536 by the gear 524 is transferred into rotational motion of the third support 538.

In operation, the individual LED light sources 306 are connected to a power source and/or a controller 50 as earlier described. An infinite number of independent visually distinctive warning light signals may be emitted through the use of the rotational reflector as depicted in FIG. 47. An infinite number of warning light signal combinations may also be provided by the controller 50 for use with the rotational reflector of FIG. 47.

Each of the mirrors 532 may be positioned for reflection and transmission of light to a desired field of vision relative to the rotational reflector. A flashing and/or rotational light source may be provided for observation by an individual.

The first support 526, second support 536, and third support 538 may be synchronized to provide for a unique warning signal light for observation by an individual. The engagement of the motor 520 for rotation of the gear 524 simultaneously rotates the first support 526, second support 536 and third support 538 for the provision of a warning light signal.

LED technology enables the selection of a desired wavelength for transmission of light energy from the individual LED light sources 306. Any wavelength of visible or non-visible light is available for transmission from the LED light sources 306. As such, generally no filters are required for use with individual LED light sources 306. The individual LED light sources 306 may be selected to provide for any desired color normally associated with the use in emergency vehicles such as amber, red, yellow, blue, green and/or white.

The controller 50 may simultaneously display any number of combinations of warning light signals. For example, the controller 50 may provide for a solitary light signal for transmission from a light source. Alternatively, the controller 50 may effect the transmission of two signals simultaneously from the identical light source where a first warning light signal is emitted from one portion of the light source and a second warning light signal is emitted from a second portion of the light source. Alternatively, the controller 50 may alternate two warning light signals where the first area of the light source first transmits a first warning light signal and secondly transmits a second warning light signal. The second area of the light source initially transmits the second warning light signal and then transmits the first warning light signal. Further, the controller may transmit two independent and visually distinct warning light signals simultaneously within different areas of light source. The controller 50 may also reverse the warning light signals for simultaneous transmission between different areas of the light source. Further, the controller 50 may regulate the transmission of more than two visually distinct types of warning light signals from a light source at any given moment. The controller 50 may alternate warning light signals within different areas or enable transmission of warning light signals in reverse alternating order for the creation of an infinite variety of patterns of visually distinct warning light signals for use within an emergency situation. The controller 50 may also permit the transmission of a repetitive pattern of warning light signals or a random pattern of visually distinct warning light signals.

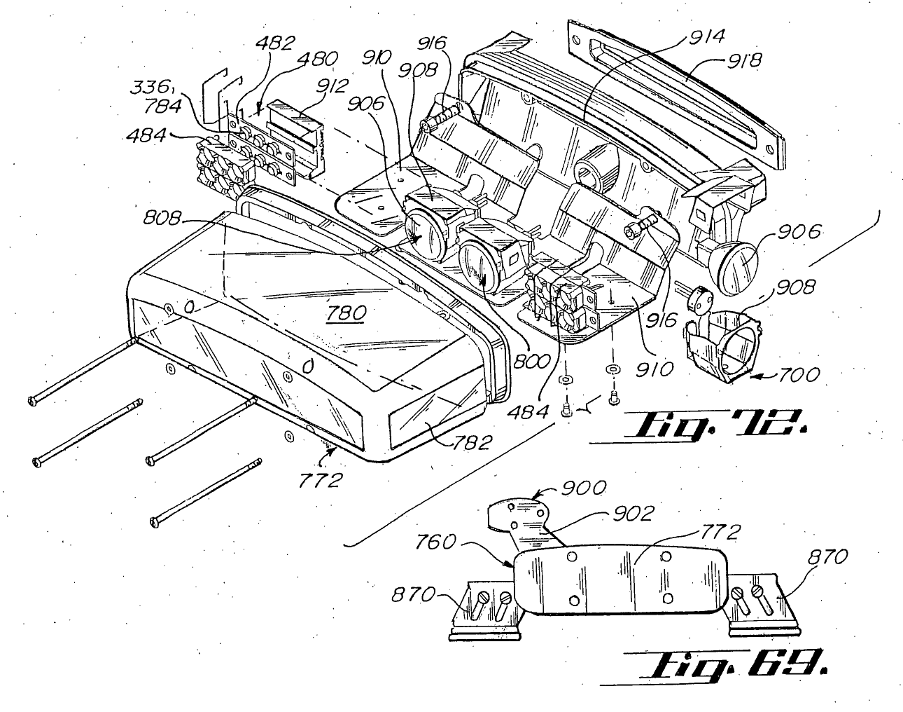

Turning to the embodiment shown in FIG. 51. FIG. 51 shows a possible configuration of a warning signal light 600 having modular components. In the embodiment shown a light support 602 has a plurality of module receiving ports 604. The module receiving ports 604 are constructed and arranged to provide electrical communication respectively to a module support member 610 of a module 606 received therein. Each of the module support members 610 may be made up of connection teeth or contacts 608 which electrically contact and engage the receiving ports 604 when inserted therein. Each module 606 has at least one visible light signal display surface 612 which has one or more light sources 30 removably mounted thereon. The light sources 30 are light emitting diodes, such as have been previously discussed. About each light source 30 may be a culminator 370. Furthermore, each culminator 370 may include a reflective surface 614 at least partially disposed thereon. Reflector 616 more efficiently directs the light emitted from light source 30 in a desired direction. In an additional embodiment of the invention the reflector 616 may be adjustable so as to redirect and/or focus light emitted from the light source 30 during use. Also, the visible surface 612 or the individual culminator cups 370 and reflectors 616 may also have one or more lenses equipped thereon to provide the warning signal light with the ability to magnify and/or diffuse emitted light.

In the embodiment shown, the module support members 610 and the module receiving ports 604 respectively are uniform in size. The uniformity of the ports 604 and the members 610 allows modules 606 to be readily replaced and also provides the invention with the capacity to have variously sized and shaped modules 606 to be interchanged and arranged in various configurations. For example a relatively elongated module, such as is indicated by reference numeral 606a, could be positioned in any of the various ports 604 shown and could likewise be replaced with any other module such as the more vertically oriented module 606b, or the remaining module type 606c. Such modularity and standardization of connections provides the present invention with a tremendous variety of module configurations which may be readily reconfigured as desired.

In addition to providing a variety of module types, the present invention also provides for a variety of mechanisms to be associated with the ports 604. In the embodiment shown for example, a rotation mechanism 618 has a port 604 mounted thereon. Any number of rotation mechanisms 618 could be included on the surface of the support 602 such as is shown. Alternatively a similar mechanism or mechanisms could be included on one or more surfaces of a module 606 to provide a dedicated rotation module. The rotation mechanism 618 could also be configured as a gyrator or other motion producing device.

It must also be noted however that the three types module varieties 606a, 606b and 606c presently shown and described are merely three examples of potential module sizes and shapes. It should be understood that modules 606 may be configured in any size or shape as desired. As indicated above, in order to ensure the greatest ease of use and elegance in design, it may be desirable to provide the various modules 606 with uniform support members 610 and also provide the support 602 with similarly uniform ports 604. However, in order to ensure that only certain module types are utilized in certain ports, it is recognized that the present invention could also utilize a support 602 having a variety of port 604 configurations with modules 606 having module supports 610 sized to correspond with specific ports and/or ports 604.

In keeping with the modular construction of the present invention, it should also be understood that the support 602, like most of the components thus described could be embodied in a variety of shapes and sizes. Preferably, the support 602 is a circuit board with a number of ports 604 included thereon. In one aspect of the invention, the support 602 could be embodied as several supports with each support having a unique arrangement of modules and light sources. The electronic schematics shown in FIGS. 52-55 show some possible configurations and their associated electronic connections between the various components of the invention.

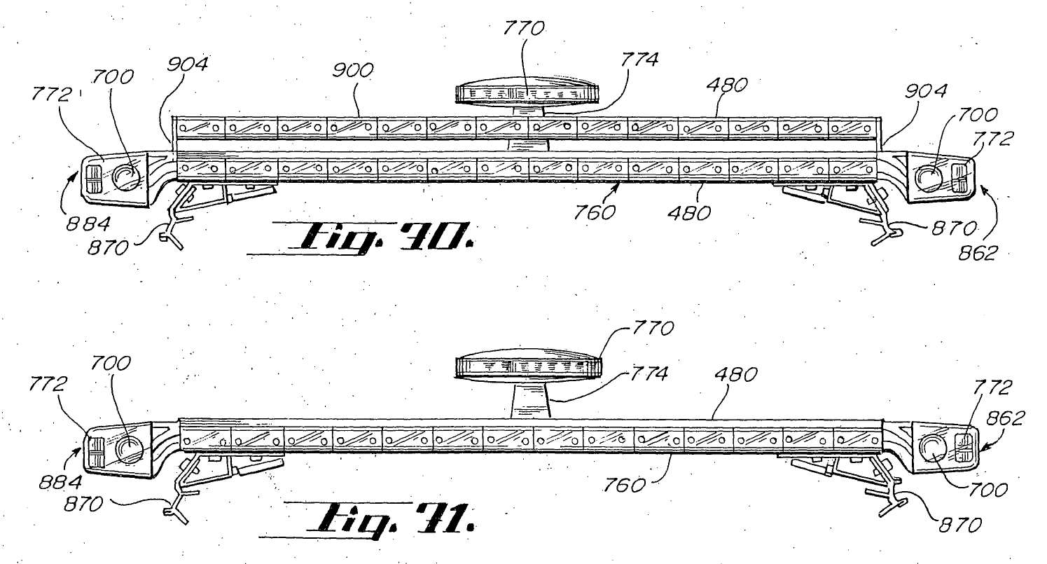

Starting in FIG. 52, an embodiment of the invention is shown where the controller 50 is in electronic communication with one or more supports 602, which are in turn in electronic communication with one or more modules 606, which are in turn in electronic communication with one or more light sources 30. FIG. 53 shows a similar series of electric pathways, but in the present embodiment the controller 50 may also be in direct electric communication with each of the various components, support(s) 602, module(s) 606 and light source(s) 30, independent of one another.

In the embodiment shown in FIG. 54, the individual visible surfaces 612 of the various modules 606 may be controlled by the controller 50. Though not indicated in the schematic, the various components: supports 602, modules 606, visible surfaces 612 and light sources 30 may be independently controlled by the controller 50 or may be selectively activated via the electronic pathway shown.

In the embodiment shown in FIG. 55, a support 602 includes a controller 50. Each controller 50 is in electronic communication with an external controller 55 in the manner previously discussed. The embodiment shown in FIG. 55 may include numerous independently controlled supports 602 which are in communication with the external controller 55. Individual controllers 55 may also be included with each modules 606 to provide for a warning signal light having numerous predetermined light signals or patterns which may be displayed by sending a single signal from the external controller 55 to the various controllers 50.

In reference to the various embodiments shown in FIGS. 52-55, additional components may be added to any of the various embodiments shown and that numerous configurations other than those shown or described could be created. The present invention is directed to all possible arrangements of the various components described herein regardless of the number, type or arrangement of the components described herein.

The controller 50 and/or external controller 55 described in relation to FIGS. 52-55 may provide modulated and/or variable illumination to individual light sources 30 or modules 606. The controller 50 or external controller 55 may selectively illuminate any combination of individual light sources 30 or modules 606 to provide an infinite variety of patterns and/or combinations of patterns for a warning light signal independently of, or in combination with, the provision of modulated or variable light intensity.

Turning to FIGS. 56-58, several views of an example of a module 606 is shown. Typically, a module will include a base portion 620 and light mounting portion 622. The base portion 620 will include the support member 610 which will typically include a plurality of electric contacts 608. The support member 610 and the electric contacts 608 are removably engageable to a port 604. The contacts 608 provide the module 606 with an electric path to the support 602 and controller 50 such as is shown in FIGS. 51-55.

The light mounting portion 622 preferably is a vertically oriented circuit board 630 which includes one or more light sources 30 and associated culminator cups 370 with reflective surfaces 614 removably mounted thereon. The light sources are preferably LED's. As shown in FIG. 51 the light mounting portion 622 may be enclosed in a transparent cover or dome such as protector 290.

As depicted in FIGS. 61, 62, 65, and 66, an LED take-down light 700 and an LED alley light 702, 800, 808 are shown as being integral to a light bar 704, 760 mounted to an emergency vehicle 706.

The LED take-down light 700 may be formed of one or more LED's 336. The LED's 336 forming the LED take-down light 700 may each be surrounded by a culminator 370 as depicted and described with reference to FIGS. 26-32 having one or more reflective sections 374 for transmission of light along a desired line of illumination. Alternatively, a reflector 350, 434 may be positioned adjacent to LED light sources 336 as described in reference to FIGS. 37-47. The reflector 350, 434 used in conjunction with take-down light 700 may be stationary or may be rotatable through the use of a rotational device. The LED's 336 forming the LED take-down light 700 may also be angularly offset with respect to horizontal to provide illumination along a preferred line of illumination as depicted with reference to FIGS. 13 and 14.

The LED take-down light 700 may be integral to, or mounted upon, the light bar 704, 760. The LED take-down light 700 may be formed of panels or modules of LED illumination sources as depicted and described in FIGS. 31-32 and 51-58. The LED take-down light 700 may also include circuit boards as earlier depicted and described further using culminator reflectors 370, within a frame or support assembly.

The use of an LED take-down light 700 incorporating LED technology improves illumination of areas in front of an emergency vehicle by flooding the area occupied by a stopped vehicle with light while simultaneously secreting the actions and location of law enforcement personnel during law enforcement activities. The illumination of the LED take-down light 700 also assists in enhancing the visibility of an emergency vehicle during dark illumination conditions which in turn improves the safety for law enforcement personnel.

The LED take-down light 700 is preferably coupled to a power supply, battery, or other low voltage power source. The take-down light 700 may also be electrically coupled to a controller 50 for illumination of all or part of the LED light sources 336 to provide for a desired level of illumination for an area adjacent to an emergency vehicle. The controller 50 may alternatively provide one or more of the many types of light signals as earlier described.

Further, the intensity of the LED light sources 336 may be selectively regulated by a controller 50 dependent upon the darkness of the conditions to be illuminated during law enforcement activities. The controller 50 may be coupled to a light or photosensitive detector to assist in the selection of a desired level of light output dependent upon the environmental conditions encountered by the law enforcement personnel during use of the LED take-down light 700.

The LED take-down light 700 may be formed of one or more adjacent panels or modules 480 of LED illumination sources 336 along a front face 710, 764 for a light bar 704, 760. Alternatively, a plurality of panels or modules 480 of LED light sources 336 may be formed along the front face 710, 764 of the light bar 704, 760 as well as a plurality of panels or modules 480 of LED light sources 336 along the rear face 712, 766 of the light bar 704, 760. The panels or modules 480 selected for the LED illumination sources 336 may be linear, square, rectangular and/or may have two or more sides, or may be a single illumination source. Each individual panel or module 480 of LED illumination sources 336 may be independently illuminated by a controller 50 to provide one of a plurality of individual and distinct warning light effects. For example, a first, third, and fifth panel or modules 480 of LED sources 336 may be illuminated where the second and fourth panels or modules 480 are not illuminated. Alternatively, the first, third, and fifth panels or modules 480 of LED light sources 336 may be continuously illuminated and the second and fourth panels or modules 480 may be illuminated to provide a flashing or strobe light signal. Illumination of any combination of panels or modules 480 may be provided to create a preferred unique warning light signal for the LED take-down light 700. A constant illumination signal may be provided or a flashing, strobe, and/or modulated light intensity may occur to provide one of a plurality of distinct light signals for use within an emergency situation.

The LED light sources 336 within the LED take-down light 700 may be angularly offset as depicted within FIG. 14 to provide a maximum illumination at a preferred distance adjacent to the front of a law enforcement vehicle.

The LED take-down light 700 may be releasably secured to the top of an emergency vehicle or light bar 704, 760 through the use of standard affixation mechanisms including, but not limited to, the use of suction cups, hook and loop fasteners, brackets, screws, bolts, and/or other fasteners. The LED take-down light 700 may be permanently secured to a light bar 704, 760 or may be releasably attached thereto for separation and use as a remote beacon as described in reference to FIG. 15.

The take-down light 700 may alternatively be formed of strips of LED light sources 308 as previously disclosed in reference to FIG. 34. During use of strip LED light sources 308 a culminator/reflector 370 may be used for positioning adjacent to each individual LED light source 336 to reflect light along a desired line of illumination. The strip LED light sources 308 may preferably include adhesive backing material. The adhesive backing material may be used to permanently or releasably secure the strips of LED light sources 308 in a desired location within the LED take-down light 700. Alternatively, the take-down light 700 may be integral to light bars previously illustrated and described.

As depicted in FIGS. 61, 62, 65, and 66, the LED alley lights 800, 808 provide illumination perpendicularly outward, illuminating areas adjacent to the drivers side and passengers side of the vehicle 706. The LED Alley lights 800, 808 are almost identical in construction and functionality to the LED take-down light 700. The LED alley lights 800, 808 may be mounted to a mechanical pivot, gears, and/or rotational device which may include an electric motor. The rotation of the mechanical pivot, or gears may alternatively be terminated to permit fixed angular illumination of areas adjacent to a law enforcement vehicle 706 which are not perpendicular to either the drivers or passenger sides in a manner similar to the functionality and operation of a spot light. In this regard, the LED alley lights 800, 808 may be manipulated forwardly, rearwardly, upwardly, and/or downwardly to provide illumination of a desired area relative to an emergency vehicle 706.

The LED alley lights 800, 808 may be integral to, or removable from, the light bar 704, 760. As such, the LED alley lights 800, 808 may be releasably secured to the ends of the light bar 760 through the use of fasteners 778 such as bolts and nuts, screws, adhesives, straps, and/or hook and loop fabric material. An individual may simultaneously illuminate the LED take-down light 700 and the LED alley lights 800, 808 or may alternatively illuminate the LED alley lights 800, 808 independently from the LED take-down light 700 within an emergency situation.

Referring to FIGS. 61, 62, 65, and 66, the take-down light 700 may be positioned inside of a housing, base, or enclosure 780 which has a transparent surface 782 permitting light as emitted from LED light sources 784 to pass therethrough. Within the interior of the base/housing 780 are located one or more light emitting diode light sources 784. Each LED light source 784 may include one or more individual light emitting diodes 786 as integral to circuit board 788. The functions and operation of LED light sources, LED's, and circuit boards are identical to the light sources described in reference to FIGS. 31 and 32. Each LED light source 784 may also include electrical couplers or connectors 790 which may be adapted for penetrating engagement into a receiving slot 792. The LED light sources 784 may be modular as earlier described with reference to FIGS. 51-58 to facilitate ease of replacement herein. An individual may thereby easily replace and/or substitute an LED light source 784 with another LED light source having the same or different colors or intensity characteristics. The circuit board 788 and/or LED light sources 784 may be panels or strips as described with reference to FIGS. 34 and 35.

The LED lights 786 are preferably spaced about circuit board 788 in any pattern and/or combination including the use of a linear configuration. Adjacent to each LED light source 784 is positioned a reflector which may be a culminator 730, 534, as earlier described in reference to FIGS. 26-32 and 47. Alternatively, a reflector or mirror 802, 434, 350, as described in reference to FIGS. 21, 22, 37-39, 40-42, and 47, may positioned adjacent to LED light sources 784 to reflect light emitted by LED's 786 in a desired direction for maximization of illumination characteristics for the alley lights 800, 808 and/or take-down light 700. The utility of the alley lights 800, 808 and/or take-down light 700 is thereby enhanced. The reflectors 370, 534, 434, 802, or 350 may be integral and/or attached to circuit board 788, a frame, or to a support adjacent to circuit board 788 to reflect light emitted from LED's 786 in a desired direction.

Within the housing/enclosure 780 is located a motor 794 having a worm gear 796 engaged to a shaft 798. Engagement of motor 794 rotates shaft 798 in turn rotating worm gear 796. The motor 794 is electrically coupled to the electrical system and/or controller 50 for the emergency vehicle.

A first alley light 800 may be positioned within housing 780 proximate to motor 794. The first alley light 800 may be stationary and/or rotatable relative to the light bar 760. The first alley light 800 may or may not be engaged to a gear 804. If rotation of the first alley light 800 is desired, then gear 804 may include a receiving slot 792 to provide electrical connection and power to the LED light source 784 for provision of light. Gear 804 may also be coupled to worm gear 796 for the provision of rotation and/or oscillation motion. If motion of first alley light 800 is not desired, then stationary positioning of LED light sources 784 relative to housing 780 may be provided with suitable electrical connection to a vehicle power source.

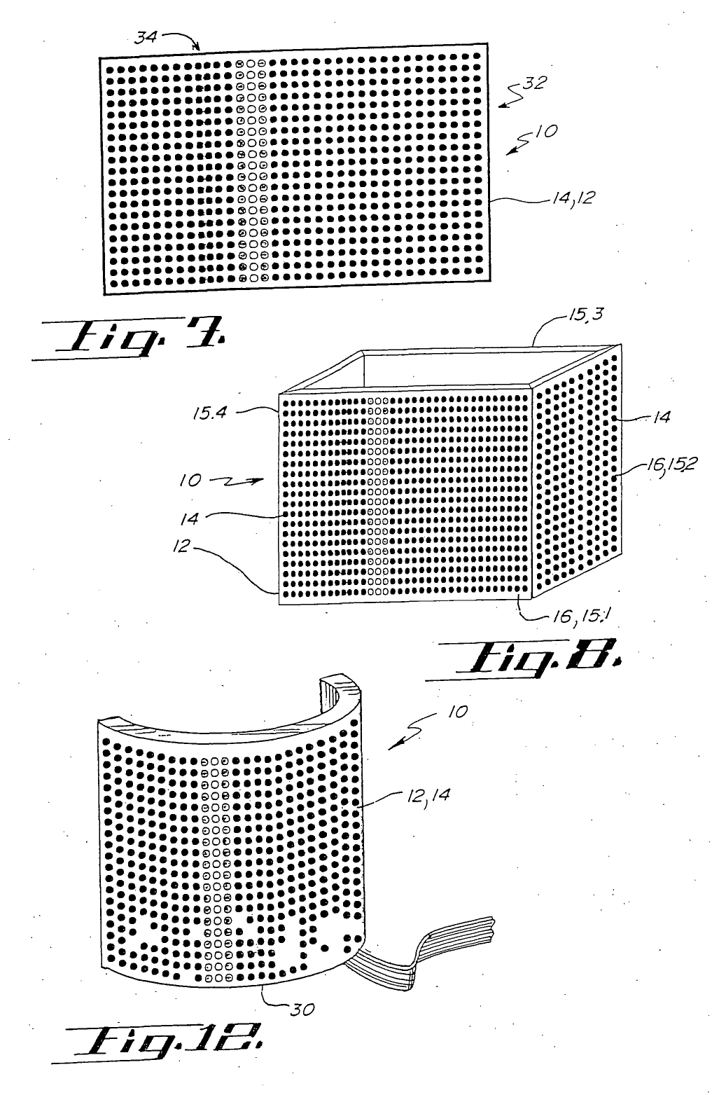

Take-down light 700, first alley light 800, and second alley light 808 may be alternatively formed in any shape as earlier described in reference to FIGS. 4-10, 12, 23-25, 31, 32, 34, 35, 37-39, 51, and 56-58. Take-down light 700, first alley light 800, and second alley light 808 may be stationary within housing 780.

A second gear 806 may be provided for central positioning within housing 780. The second gear 806 may be coupled to gear 804 which may in turn be coupled to worm gear 796 as connected to shaft 798. Rotation of shaft 798 by motor 794 thereby imparts rotation of gear 804 and second gear 806. Alternatively, the shaft 798 may be elongate including worm gear 796 for direct coupling to second gear 806. Rotation of 360° or oscillating rotation of second gear 806 may therefore be provided.

Second gear 806 may also include a receiving slot 792 adapted to receivingly engage electrical connectors 790 as integral to circuit board 788 of LED light sources 784. Light sources 784 also include a plurality of individual LEDs 786 which may each be positioned within a culminator 534, 370, 802. A controller 50 may be electrically connected to each LED light sources 784 as coupled to gear 804, second gear 806, third gear 810, and/or housing 780 for selectively illumination of individual LED's 786, or for illumination of any combination of LED's 786. The features as earlier described for controller 50 are equally applicable for use with the take-down light 700, first alley light 800, and second alley light 808, relative to distinct types and combinations of types of warning light signals.

Second gear 806 may be further coupled to third gear 810 which may include a receiving slot 792 adapted for electrical coupling to connector 790 of take-down light 700. Second alley light 808 is designed to be rotated and to sweep forwardly to the front of an emergency vehicle at such times when the intersection clearing light mode has been activated. During activation of the intersection clearing light mode, the take-down light 700 as electrically coupled or integral to third gear 810 will rotate sweeping to the outside front corner of an emergency vehicle.

The controller 50 is in electrical communication with the take-down light 700, the first alley light 800, and the second alley light 808. Any number of take-down lights 700 or alley lights 800, 808 may be used in association with a light bar 704, 760. The controller 50 may additionally regulate the rotation of the motor 794 for imparting rotation to the take-down light 700, and/or the alley lights 800 and 808.

The controller 50 activating the motor 794 may selectively initiate an intersection clearing illumination mode or sequence. Motor 794 causes the shaft 798 to rotate imparting motion to the worm gear 796. The rotation of the worm gear 796 may then be transferred to the first alley light 800 through coupling to the first gear 804. Alternatively, the worm gear 796 may be directly coupled to the second gear 806. In another embodiment, motion may be imparted to the second gear 806 through the use of a tie bar 824 as connected between the second gear 806 and the first gear 804. Rotation of the worm gear 796 rotates first gear 804 whereupon motion may be transferred to the second gear 806 for movement of the second alley light 808. Rotation may be further transferred to the take-down light 700 via the coupling of the third gear 810 to the second gear 806. The tie bar 824 may extend between gear 804 and second gear 806 to synchronize motion, rotation, and illumination of the first alley light 800 relative to the second alley light 808 and take-down light 700.

Each of the first alley light 800, second alley light 808, and take-down light 700, are in electrical communication with a power source for a vehicle and are further in communication with the controller 50. The controller 50 may independently impart motion to the take-down light 700, first alley light 800, and second alley light 808. The alley lights 800, 808, and take-down light 700 may be selectively illuminated without initiation of rotational motion as regulated by the controller 50. Alternatively, the controller 50 may signal engagement of the motor 794 to impart rotation to any one of the first alley light 800, second alley light 808, and/or take-down light 700 for use as an intersection clearing light. The controller 50 is therefore capable of simultaneously regulating motion of the rotational devices such as gears 804, 806, and 810 and illumination of selected individual or groups of LED's 786 to provide independent or combination light effects.

The intersection clearing light mode may generally be initiated by the controller 50 which signals motor 794 to rotate second gear 806 either through rotation of first gear 804 or through direct contact with worm gear 796. The first or at rest position for the second alley light 808 directs the transmission of light in the direction depicted by arrow 812 which is generally perpendicular to the longitudinal axis of a vehicle. As the intersection clearing light mode is engaged, the counter clockwise rotation of gear 804 causes the clockwise forward rotation of the second gear 806 according to arrow 814 until an angle of forward rotation 816 is achieved. The direction of forward rotation 816 transmits light emitted from LED light sources 784 forwardly towards a corner of a vehicle at an approximate angle ∝ of 45°. The controller 50 may then continue to rotate the gears 804, or 806, in a counter clockwise direction for 360° rotation, or alternatively the controller 50 may signal the motor 794 to reverse direction to rotate the second alley light 808 rearwardly back to the first at rest position indicated by number 813. During the clockwise rotation the second gear 806, third gear 810 and take-down light 700 may be rotated in a counter clockwise direction. The initial at rest position for the take-down light 700 is forwardly with respect to the alley lights 800, 808. The engagement of the intersection clearing light mode rotates the take-down light 700 outwardly towards the sides of an emergency vehicle from a first position indicated at 818 to a second position indicated at 820 as depicted by arrow 822.

Alternatively, the first alley light 800 may be rotated simultaneously with the second alley light 808 by engagement between the first gear 804 and second gear 806. Synchronous rotation between the first alley light 800 and the second alley light 808 may be provided through the use of the tie bar 824 or through direct coupling engagement of gears 804 and 806.

In an alternative embodiment as depicted in FIG. 66, the first gear 804 is not required to be connected to the second gear 806 with the exception of the tie bar 824. The tie bar 824 extends between the first gear 804 and the second gear 806 and is pivotally and rotatably engaged to each of the first and second gears 804, 806 respectively. The initial positioning of the tie bar 824 on the first gear 804 may be initially indicated as the at 0° location. The initial position of the tie bar 824 on the second gear 806 may also be initially indicated as the at 0° location where the tie bar 824 extends in a linear direction between the first and second gears 804, 806 proximate to the circumference of each of the first and second gears 804, 806 respectively.

The second alley light 808 is initially positioned for transmission of light outwardly from the housing 780 opposite to the location of the tie bar 824. The second alley light 808 is positioned for light transmission at a location approximately 180° from the tie bar 824 on the second gear 806.

As the motor 794 is engaged, the first gear 804 may be rotated in either a clockwise or counter clockwise direction relative to the housing 780. A clockwise rotation of the first gear 804 will be described herein for transfer of motion to the second gear 806 and third gear 810. Alternatively, the motor 794 may be configured to rotate the first gear 804 in a clockwise direction for a desired period of time or distance, and then reverse directions for counterclockwise rotation of the second gear 806 for a desired period of time or distance. In an oscillating sequence the first gear 804 may be initially rotated 90° in a clockwise direction or in a counter clockwise direction and then the direction of rotation may be reversed for rotation of a distance corresponding to an angle of 90° or 180°, whereupon rotation may again be reversed for continued rotation of a distance corresponding to an angle of either 90° or 180° in the initial direction.

In a 360° rotation cycle of the first gear 804 in a clockwise direction, motion is transferred to the second gear 806 and third gear 810 in a push-pull configuration through the tie bar 824. Clockwise rotation of the first gear 804 from a position of 0° to a position of approximately 90° causes the second gear 806 to be pulled by the tie bar 824 moving the position of the second alley light 808 from an initial position of 180° to a position of approximately 270°. Continued rotation of the first gear 804 from a position at 90° to a 180° location preferably causes the second gear 806 to be pushed by the tie bar 824 causing the second alley light 808 to be rotated in a reverse direction from a 270° position back to a 180° position. Continued rotation of the first gear 804 in a clockwise direction from a position 180° to a 270° location in turn causes the tie bar 824 to pull the second gear 806 causing the second alley light 808 to continue to be rotated in a reverse direction from a position of 180° to a 90° location. Continued rotation of the first gear 804 in a clockwise direction from a 270° position to a 360° or to the initial position in turn causes the tie bar 824 to push the second gear 806 causing the second alley light 808 to reverse directions to be rotated from a 90° position back to an initial or starting position of 180°.

Rotational motion is also, in turn, transferred to the third gear 810 due to the coupling engagement with the second gear 806. The rotational motion of the third gear 810 relative to the second gear 806 is in the opposite direction. The initial positioning of the take-down light 700 on the third gear 810 is offset relative to the second alley light 808. The initial positioning of the second alley light 808 may be indicated as 180° and the initial position of the take-down light 700 may be initially indicated as 270°. The third gear 810 and the take-down light 700 are, therefore, initially rotated from 270° in a counter clockwise direction to approximately 180°. The rotation of the third gear 810 and the take-down light 700 is then reversed from 180° back to 270° and then to 360° where rotation may be reversed back to 270°. The take-down light 700 therefore wags and oscillates between 360° or 0° to 180° through an initial positioning of 270°. Simultaneously, the second alley light 808 is wagged or oscillated between 90° and 270° through an initial position of approximately 180°.

The offset positioning of the second alley light 808 relative to the take-down light 700 prevents obstructed contact between the two light sources permitting free rotational motion there between. The offset positioning of the second alley light 808 relative to the take-down light 700 enables the utilization of oversized or enlarged LED light sources 784 as engaged to the second or third gears 806, 810 respectively. The illumination as transmitted by the LED light sources 784 may thereby be significantly increased.

Alternatively, the rotation of the second gear 806 and third gear 810 may occur through an arc of approximately 360°. The controller 50 is not required to continuously illuminate either the take-down light 700, first alley light 800, and/or second alley light 808. Alternatively, the first gear 806, and third gear 810 may be rotated to a desired position such as indicated by the numbers 820, 816, and oscillated for return to an initial position 818, 813. The controller 50 may regulate the rotation of the gear 804, second gear 806, and third gear 810, for illumination of LED's 786 during use as an intersection clearing light. The intersection clearing light, take-down light, and/or alley lights, are positioned inside the housing 780 proximate to the distal ends of LED light bar 760 as depicted in FIG. 63.

The intersection clearing lights, take-down lights 700, and/or alley lights 800, 808, may additionally be activated by a switch for regulation of rotation to a desired angle where upon rotation may be terminated. In this situation, the take-down lights 700, and/or alley lights 800, 808, may be utilized in a manner similar to a spotlight integral to a vehicle and as controlled by an operator. The controller 50 or switch may be utilized to provide any angle of illumination within an arc of approximately 180° relative to a vehicle between an angle of approximately 45° forwardly and inwardly to an approximate angle of 135° rearwardly and outwardly relative to the front and sides of a vehicle. The controller 50 or switch may also be utilized to provide any desired angle of illumination for the alley lights 800, 808, within an arc of approximately 140° relative to a vehicle between an angle of approximately 70° forwardly and outwardly to an approximate angle of 70° rearwardly and outwardly from the sides of an emergency vehicle. A wide area of illumination to the front and sides of an emergency vehicle is thereby provided by the alley lights 800, 808, and take-down light 700 either independently and/or in combination.

In an alternative embodiment, a plurality of take-down lights 700 may be positioned adjacent to each other and disposed along the longitudinal length of a light bar 760 above the front face 764 and/or rear face 766. Alternatively, the take-down lights 700 may be formed of a plurality of LED light sources 784 positioned adjacent to each other along the entire length of the front face 764 and/or rear face 766 of a light bar 760. (FIG. 63.) The LED light sources 336, 786 in this embodiment are connected to the controller 50. The controller 50 may selectively illuminate one or more LED lights 336, 786 to provide any desired intensity of light to be used in a take-down situation by law enforcement personnel.

As depicted in FIGS. 31, 32, and 63, a single row of LED light sources 336, 786 is disposed on front face 764 and rear face 766 of LED light bar 760. Alternatively, a plurality of rows and/or columns of LED light sources 336, 786 as generally illustrated and described in relation to FIGS. 7, 9, 12, 34, and 35, may be utilized on front face 764 and/or rear face 766. A linear culminator assembly 484 (FIGS. 31, 32), or a culminator assembly 392 in the form of an array (FIG. 26), may be positioned adjacent to LED light sources 336, 786. Alternatively, reflectors 350 such as mirrors as illustrated in FIGS. 37-39, may be engaged to front face 764 and/or rear face 766 adjacent to LED light sources 336, 786.

A transparent surface 782 is preferably in sealing engagement with the housing 780 to prevent moisture or other contamination from adversely affecting the performance of the take-down light 700 and/or the alley lights 800, 808. The transparent surface 782 is preferably of sufficient strength and durability to not fracture, break, and/or fail when exposed to adverse environmental and/or weather conditions including but not limited to the exposure to rock or gravel strikes.

Referring to FIGS. 59 and 60, a personal LED warning signal light 731 is shown. The personal LED warning signal light 731 is formed of a plurality of individual LED light sources 732 which may provide illumination in any desired color. The individual LED light sources 732 may be selectively illuminated by a controller 50 for the provision of any desired combination or pattern of visually distinctive warning light signals as earlier described.

The personal LED warning signal light 731 may be formed of columns or rows of individual LED light sources 732 which may in turn be sequentially illuminated to provide the appearance of a scrolling or rotating light source.

The individual light sources 732 may be formed in an array, panel, or single line, and may include an adhesive backing as earlier described. Further, the individual LED sources 732 may be angularly offset as depicted within FIG. 14 to maximize light output along a desired line of illumination. The personal LED warning signal light 731 includes a circuit board or LED mounting surface 482 which may be electrically coupled to a controller 50. The types of lighting effects available for illumination by the personal warning signal light 731 include but are not necessarily limited to the types of light signals and/or combinations of light signals as earlier described.

The personal LED warning signal light 731 may also include a culminator or reflector 730 as earlier described disposed about the LED light sources 732. The culminator or reflector 730 preferably assists in the maximization of light output. The culminator 730 may also be angularly offset to conform to any angular offset of LED light sources 732.

The personal LED warning signal light 731 may be the approximate size of a hand held calculator for convenient transportation within the pocket of law enforcement personnel. The personal LED warning signal light 731 may also be enclosed within a hard or soft sided case 734. Alternatively, the case 734 may have an exterior appearance designed to secrete the function of the personal LED warning signal light 731. For example, the case 734 may be configured to have a first area having a removable or retractable cover to reveal the LED light sources 732. Alternatively, the case 734 may be formed to resemble an article used to transport tobacco products similar to a cigarette case. Alternatively, the case 734 may include a removable or retractable face which is designed in appearance to resemble a hand held calculator, personal electronics device, and/or electronic address book.

The personal LED warning light 731 includes a plug in adaptor 736 which is used to establish an interface for coupling engagement to the cigarette lighter receiver of a motor vehicle. A low voltage power supply is thereby available for the personal LED warning signal light 731 when used in conjunction with a motor vehicle. The plug in adaptor 736 may also resemble a power cord for a cellular telephone thereby hiding the function of the personal LED warning signal light 731. Alternatively, the personal LED warning signal light 731 may be powered by one or more batteries 738.

During use, the personal LED warning signal light 731 may be withdrawn and opened to expose a first panel 740 and a second panel 742. The first panel 740 and the second panel 742 are joined together by a hinge 744. Following opening, the plug in adaptor 736 may be engaged to either the first panel 740 or to the second panel 742 and to a cigarette lighter receptacle for the provision of low voltage power to the personal LED warning signal light 731. The personal LED warning signal light 731 may then be placed upon the dashboard 746 of a motor vehicle or held for use as a warning signal light by undercover law enforcement personnel.

The first panel 740 and the second panel 742 may each include a tacky and/or adhesive base 748 which functions to assist in the retention of the personal LED warning signal light 731 upon the dashboard 746.

The personal warning signal 731 may include a frame 830 having a back surface 832. The frame 830 includes a lip 834 which is adapted for positioning and retention of a transparent protector 836. The transparent protector 836 is water resistant and prevents water and/or other contamination from adversely affecting the performance of the LED light sources 732. The frame 830 also includes a pair of parallel sides 839, hinge side 840, and support side 838. The support side 838 may be angled to facilitate positioning upon the dashboard of a vehicle.

An opaque cover or second panel 742 includes a receiving ledge 844 which is adapted for nesting and covering engagement relative to the parallel sides 839 during closure of the second panel or opaque cover 742 over the transparent protector 836. The second panel 742 therefore conceals the LED light sources 732 during periods of non-use. The personal warning signal light 730 may also have a first nested closed position and a second open signaling position as indicated in FIGS. 59 and 60. A switch may also be provided which is adapted to detect the closure of the second panel 742 relative to the first panel 740 for termination of power and illumination of the LED light sources 732. The personal warning signal light 731 may also include a power saving feature to prolong the utility and life of internal batteries 738.

An electrical receiving port having a cover may be placed in either the support side 838 or the tacky or adhesive base 748. The electrical receiving port is adapted to receivingly engage a plug 849 of a power cord 850. The power cord 850 may include an adapter 736 for insertion into the cigarette lighter receiving port. Alternatively, the plug 849 may be inserted into a electrical receiving port integral to either the opaque exterior surface 846 and/or frame 830.

The personal warning signal light 731 includes an internal controller 50 as earlier described. Alternatively, the personal warning signal light 731 may include an external programmable controller. A selector switch may also be provided for activation of pre-stored and/or programmed light signals for illumination during use of the personal warning signal light 731.

The personal warning signal light 731 may be configured in any shape including, but not necessarily limited to, square, rectangular, round, and/or oval. A reduced thickness dimension may be provided following closure of the second panel 742 relative to the frame 830 for placement in the first nesting closed position. The second panel 742 also functions to provide for sealing engagement to the frame 830. The LED light sources 732 are rugged and shock absorbent facilitating transportation and prolonged usefulness by an individual.

Referring to FIGS. 63 and 64 an LED light bar 760 is disclosed. The LED light bar 760 may be formed of a base 762 which extends longitudinally, traversing the roof of an emergency vehicle. The base 762 includes a front face 764 and a rear face 766. Each of the front and rear faces 764, 766 include LED illumination devices 336, 786 which may be configured similarly to the modular light support 480 identified and described relative to FIGS. 31-32. The LED illumination devices 336, 786 along the front face 764 and rear face 766 are positioned within the interior of the base 762 and are enclosed therein by a transparent protective cover 860 to minimize contamination and/or exposure to water. The transparent protective cover 860 may be placed into sealing engagement with either the front face 764 and/or rear face 766 through the use of a gasket and/or sealant or any other preferred mechanical and/or chemical sealing mechanism. The protective cover 860 as engaged to the front face 764 and rear face 766 is formed of a transparent material such as plastic, and/or glass to provide for transmission of light from individual LED light sources 336, 786 for observation by an individual.

As earlier depicted with reference to FIGS. 31 and 32 the LED light sources 336, 786 may be formed into modular units which may be regularly spaced along the front face 764 and rear face 766. The LED light sources 336, 786 integral to the front face 764 and/or rear face 766 are each positioned within a culminator 370 as earlier described. The reflector devices as depicted and described with reference to FIGS. 37-39 may be incorporated into modular light supports 480 for utilization along a front face 764 and/or rear face 766 of LED light bar 760. The number of light emitting diode light sources 336, 786 forming each individual modular unit 480 may vary. Each modular unit 480 may include between 2 and 20 LED light sources 336, 786. Each of the LED light sources 336, 786 is electrically connected to a circuit board 346 having heat sink wells 344 as earlier described in reference to FIG. 36. The construction of the modular light supports 480 and LED light sources 336, 786 facilitates ease of color modification and versatile alternative configurations for light transmission from the light bar 760. The modular light supports 480 also may preferably include electrical couplers or connectors 790 as earlier described.

Each modular light support 480, and/or individual LED light source 336, 786 is in electrical communication with the controller 50. The controller 50 regulates the illumination of LED light sources 336, 786 to provide any desired color, pattern, combination of patterns, and/or types of light signals as earlier identified. The controller 50 may also preferably regulate the illumination of modules 480 and/or individual LED light sources 336, 786 independently between the front face 764 and the rear face 766. The controller 50 may further regulate the individual illumination of LED light sources 336, 786 within sections and/or sectors along the front face 764 independently with respect to each other, and independently with respect to the rear face 766. The controller 50 may also regulate the illumination of LED light sources 336, 786 in any desired individual combination, pattern, or sector, for the provision of an infinite variety of different types of light signals. For example, one portion of the front face 764 may transmit a stroboscopic light signal. Simultaneously and/or alternatively, another portion or sector of the front face 764 may transmit a different colored flashing light signal at varying time intervals. Alternatively, a third portion of the front face 764 may transmit a third color of a pulsating modulated or variable lighting effect. The examples illustrated herein are, by no means, restrictive of the infinite variety of combinations or types of light signals which may be regulated by the controller 50 during use of the LED light bar 760.

The controller 50 may also simultaneously be in electrical communication with the take-down lights 700, alley lights 800, 808, and pod illumination devices 770. The controller 50 may therefore regulate the modular light sources 480, take-down lights 700, alley lights 800, 808, and pod illumination devices 770 either simultaneously, independently, and/or in combination. Further, the controller 50 may also be in electrical communication with rotational and/or reflector devices such as earlier described with reference to the intersection clearing light or the reflector as described in detail with respect to FIG. 47 as positioned within the pod illumination devices 770.

Light bar 760 includes base 762 which is elevated with respect to the roof of an emergency vehicle to enhance visualization during use. The base 762 may be supported above the roof of an emergency vehicle by a plurality of feet 870. The feet 870 are secured to the roof or rain channels of a vehicle through mechanical affixation mechanisms. In a preferred embodiment, four feet 870 extend from the base 762 downwardly to the roof of an emergency vehicle. Extending between each pair of feet 870 is at least one support bar 872 which serves as a frame for elevation of the LED light bar 760 above the roof of a vehicle. The feet 870 may be adjustable to facilitate use on various makes and/or models of emergency vehicles.

The LED take-down light 700 and/or alley lights 800, 808 may be integral to the base 762 proximate to each of the first and second ends 862, 864 of light bar 760. An end cap 772 may be secured to the first and second ends 862, 864 of the base 762. Each end cap 772 encloses the take-down light 700 and alley lights 800, 808. The end caps 772 may be elevated above or alternatively may rest upon the roof of an emergency vehicle and may assist to support the longitudinally extending base 762. The end caps 772 provide for visualization of the LED light bar 760 from the sides of an emergency vehicle. Each end cap 772 may have the same width dimension as the base 762 or have larger or smaller dimension as dictated by manufacturing and performance considerations.

Supports 774 extend angularly upwardly and forwardly from the base 762 for elevation and of the pod illumination devices 770 above the base 762. The supports 774 preferably are substantially vertical and are angled inwardly and forwardly toward the front face 764 of the LED light bar 760. The supports 774 may be formed of any material provided that the essential functions, features, and attributes described herein are not sacrificed. The supports 774 are aerodynamically designed to improve the efficiency for the LED light bar 760.

Each pod illumination device 770 is elevated by at least one and preferably two supports 774. The elevation of the pod illumination devices 770 above the light bar 760 enhances illumination source differentiation of light signals as observed by individuals.

The pod illumination devices 770 may either be circular, oval, square, rectangular, or any other shape. The pod illumination devices 770 include LED light sources 336, 786 as earlier described. The visualization of the LED light bar 760 is enhanced by the pod illumination device 770 permitting observation at all angles relative to an emergency vehicle.

The pod illumination devices 770 include a frame 866 comprised of metal, plastic, rubber, and/or any other sturdy material. The frame 866 also includes a transparent protective cover 868 which functions to prevent moisture or other contamination from adversely affecting the performance of the LED light source 336, 786. The transparent protective cover 868 also is formed of a material such as plastic or glass.

Each LED light bar 760 has at least one and preferably two or more pod illumination devices 770 for the provision of warning light signals for observation by individuals. Each of the pod illumination devices 770 are disposed proximate to either the first end 862 and/or second end 864 of light bar 760. Alternatively, a pod illumination device 770 may be centrally disposed between the first end 862 and second end 864 of light bar 760.

A controller 50 may also be in electrical communication with the pod illumination devices 770 to provide for an infinite variety unique lighting signals as earlier described. The controller 50 may independently illuminate the pod illumination devices 770 relative to each other or provide different light signals within each pod illumination device 770.

Each pod illumination device 770 may include individual columns and rows of multicolored LED light sources 336, 786 which in turn may be enclosed within a culminator and/or reflector 370 as earlier described. Alternatively, each pod illumination device 770 may also include a reflector assembly as illustrated and earlier described within FIG. 47 which includes a culminator 370, 534 and rotational mechanism or motor 794 as positioned within the frame 866. The motor 794 provides rotational or oscillating motion to the reflector 532. Alternatively, reflector devices as earlier described with reference to FIGS. 37-42, and 44-45 may be incorporated into pod illumination devices 770.

The pod illumination devices 770 also may include a frame 866 having a cover or top 874 which is removable to provide access to either a reflector assembly, culminator, modular light supports 480 and/or LED light sources 336, 786 for repair or replacement therein. The cover or top 874 may be affixed to the pod illumination devices 770 by any conventional means including but not limited to the use of bolts, screws and/or wing nuts.

The pod illumination devices 770 may include flexible circuit boards as illustrated and described in FIGS. 4, 5, and 12. The pod illumination devices 770 and frame 866 provide an aerodynamic encasement for the LED light sources 336,786. The LED light bar 760 provides an aesthetically pleasing visual shape representative of a high technology appearance to enhance the visualization of a law enforcement vehicle.

Modular light supports 480, 606 as earlier described in reference to FIGS. 23-25, 31-32, and 51-58 herein may be incorporated into pod illumination device 770. The LED light sources 336, 786 may therefore be replaceable or alternatively, the entire pod illumination device 770 may be replaceable to effectuate ease of configuration and/or replacement.

If modular LED light sources 480, 606 are utilized within pod illumination devices 770 then rotational mechanisms as described in FIGS. 21, 22, 40-42, 44, 47, 51, 63, and/or 65, may be utilized individually, exclusively, and/or in combination with controller 50 to provide a desired warning signal light. Alternatively, the module light sources 480, 606 are not required to be utilized in association with a rotational reflector device, where the controller 50 may be exclusively utilized to selectively illuminate individual and/or combinations of LED's 336, 786 to provide a desired type of warning light signal.

If non-modular light sources 336, 786 are utilized within pod illumination device 770, then rotational mechanisms as described in FIGS. 21, 22, 40-42, 44, 47, 51, 63, and 65, may be utilized individually, exclusively, and/or in combination with a controller 50 to provide a desired warning light signal. Alternatively, the non-modular LED light sources 336, 786 are not required to be utilized in association with a rotational device where the controller may be exclusively utilized to selectively illuminate individual and/or combinations of LED's 336, 786, to provide a desired type of warning light signal.

The LED light bar 760 may be independent elements which may be combined in any desired configuration.

As may be seen in FIGS. 67-72, alternative embodiments of light bar 760 are shown. In the alternative embodiments, a second light bar 900 having a second base or support 902 may be positioned above base 762 or bar 760 facing forwardly and/or rearwardly. The second base or support 902 preferably includes the LED features and functions as earlier described for base 762 and/or LED light bar 760. The second support or base 902 preferably includes controller 50 which may be integral or coupled to one or more controllers 50 of light bar 760 to provide a desired type, pattern, combination, and/or independent visual warning light signal effect as earlier described. As may be seen in FIG. 70 and FIG. 71, a single illumination pod 770 may be disposed centrally between the first end 862 and the second end 864 of light bar 760 and second light bar 900. The features and functions as earlier described for illumination pod 770 are applicable for the alternative embodiment as depicted in FIGS. 67-72.

Second base 902 is preferably elevated above light bar 760 by one or more platforms or brackets 904. The double light bar including light bar 760 and second base 902 is depicted without an illumination pod 770 in FIGS. 67, 68, and 69.

Referring to FIG. 71, a light bar 760 is disclosed having a single illumination pod 770 centrally disposed between first end 862 and second end 864.

In more detail, a front view of double light bar 900 is depicted in FIG. 67. The front face 764 of each of light bar 760 and second light bar 900 preferably includes a plurality of modules 480 of LED light sources 336, 786 as positioned within culminators 370, 484. Second light bar 900 is elevated above light bar 760 by platforms and/or brackets 904. Double light bar as depicted in FIG. 68 preferably includes a front face 764 and a rear face 766 for provision of illumination forwardly and rearwardly with respect to a vehicle as regulated by controller 50 as earlier described. Identical and/or different light signals may be simultaneously transmitted from either the front face 764 and/or rear face 766 or between sectors of either light bar 760 and/or second light bar 900 as earlier described with reference to light bar 760. Second light bar 900 may include a second controller 50. Alternatively, controller 50 may be integral to light bar 760 which, in turn, may control the illumination of light sources within both light bar 760 and second light bar 900.

Referring to FIG. 69, a side view of a double light bar is shown with second light bar 900 elevated with respect to light bar 760. In this embodiment, second base or support 902 does not include a rear face for the provision of illumination rearwardly with respect to a vehicle. The controller 50 may independently regulate illumination of LED light sources or sectors of LED light sources between front face 762 of each light bar 760 and the second light bar 900 for the provision of a desired type or combination type warning signal light as earlier described. The second base 902 may be aerodynamically designed for positioning of second light bar 900 angularly forward with respect to light bar 760.

Referring to FIG. 70, double light bar including light bar 760, second light bar 900, and single illumination pod 770 is shown. In this embodiment, single illumination pod 770 is centrally positioned between first end 862 and second end 864. Referring to FIG. 71, light bar 760 is depicted having single illumination pod 770 centrally positioned between first end 862 and second end 864.

An alternative end cap assembly 772 is depicted in FIG. 72. In this embodiment, take-down light 700 and alley lights 800, 808 are positioned within an enlarged circular or parabolic reflector 906. Reflector 906 is positioned within reflector bracket 908. Reflector bracket 908 is secured to base 910. LED modules 480 having circuit board 482 and culminator assembly 370, 484 are releasably secured to base 910 proximate to alley lights 800, 808. LED modules 480 may be coupled to module base 912 which, in turn, may be releasably secured to base 910. Base 910 may be attached to mounting frame 914 by fasteners 916. Mounting frame 914 in turn may be attached to a bracket 918 which in turn may be attached or integral to either first end 862 or second end 864 of light bar 760.

Light emitting diodes may be manufactured to emit light at any wavelength from infrared to visible. Therefore, an infinite variety of colors of different wavelengths of LED's are available. LED's also are extremely flexible in the provision of an instantaneous light signal which minimizes and/or eliminates carry over illumination after termination of power. For example, the application of power to a traditional light source frequently causes electrons to pass through a filament which in turn causes the temperature of the filament to increase emitting the visible light. The termination of power to a traditional light source having a filament does not immediately terminate the provision of light. A carry over illumination effect continues as the traditional light source filament cools. The traditional light source filament therefore is not flexible for receipt of a vary rapid pulsed power for transmission of a pulsed light signal.

An LED light source however is well adapted to receive a rapid pulsed power supply for the provision of a pulsed light signal. In fact, LED's have the capability to pulse thousands of times per second where the rapid pulses are unobservable to an unaided human eye. In these instances, the pulsed LED light source will appear to an individual to be a constant light signal where the pulses are not recognizable.

The duty cycle provided to an LED light source is regulated by a controller 50 which includes a rapid switch to enable the rapid pulsation of the LED light sources which in turn causes the provision of a pulsating light. Simultaneously, the controller may also regulate an observable light signal for illumination in minutes, seconds, and/or fractions of seconds to provide a desired type of unique light effect.

The power source for the LED light bar 760 may be a low voltage, low current power supply and may include a rechargeable battery capable of receiving recharge through coupling to a solar energy cell. Other sources of electrical power may be suitable substitutes herein.

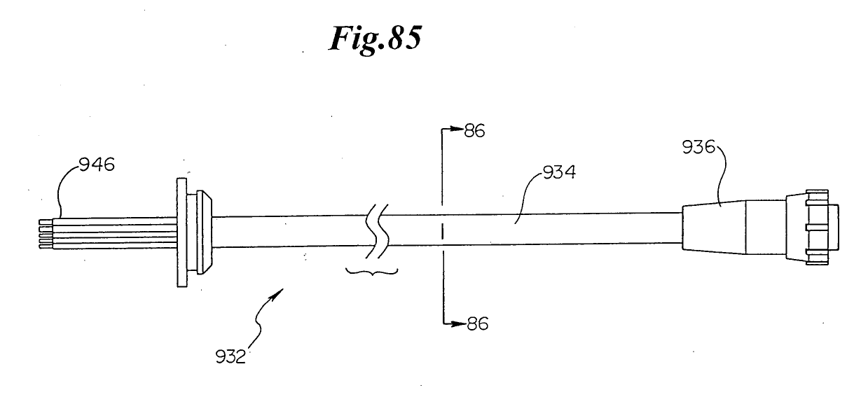

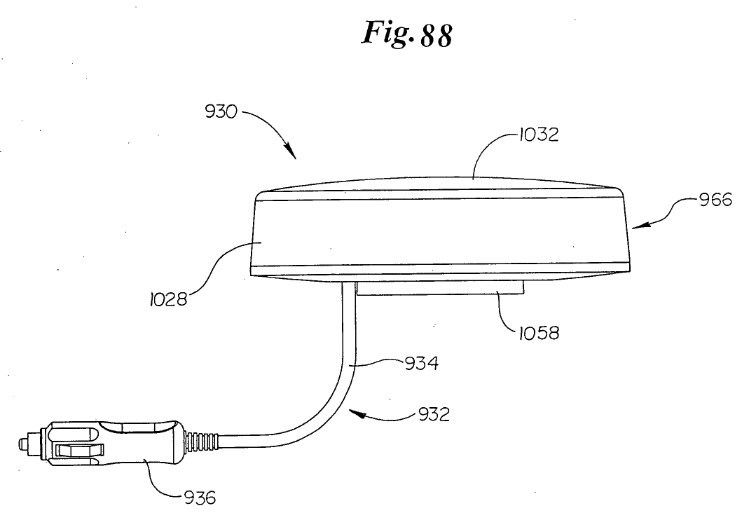

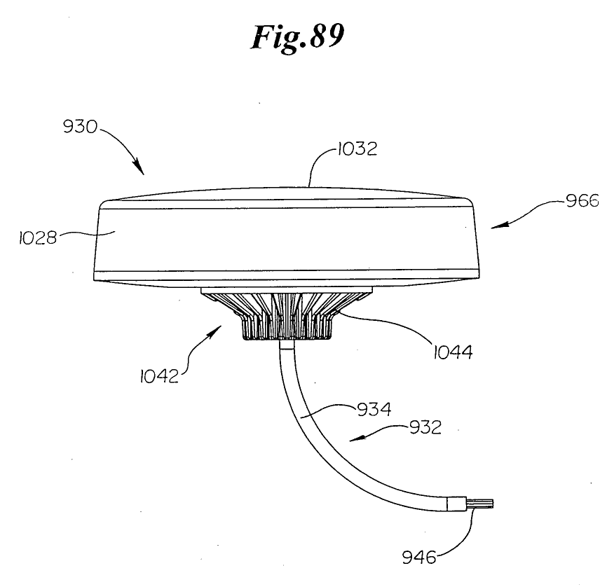

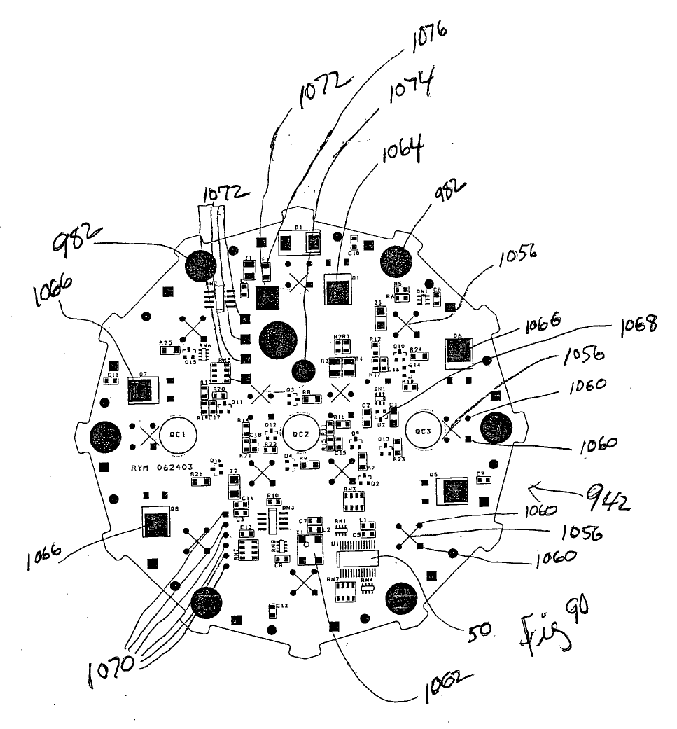

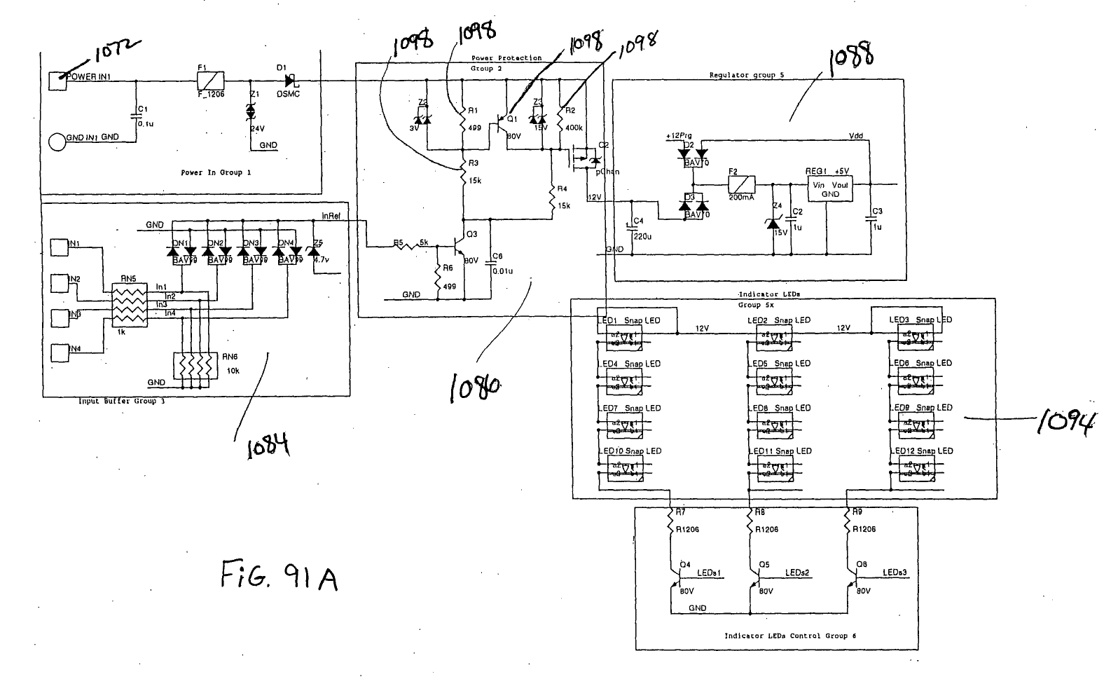

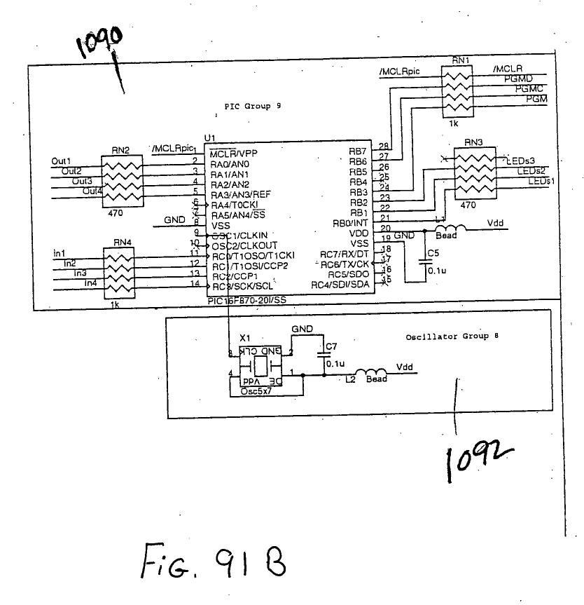

Referring to FIGS. 85, 86, 88, and 89, a wire harness 932 is used to provide electrical communication and/or power to the 360° pod 930. The wire harness 932 may include a pigtail section 934 which may have an approximate length dimension of 9 inches to 12 inches terminating at a disconnectable plug 936. Generally, the disconnectable plug 936 passes through aperture 938 of mounting base 940 for engagement to LED support 942. The LED support 942 is preferably a circuit board containing a plurality of LED's 944.

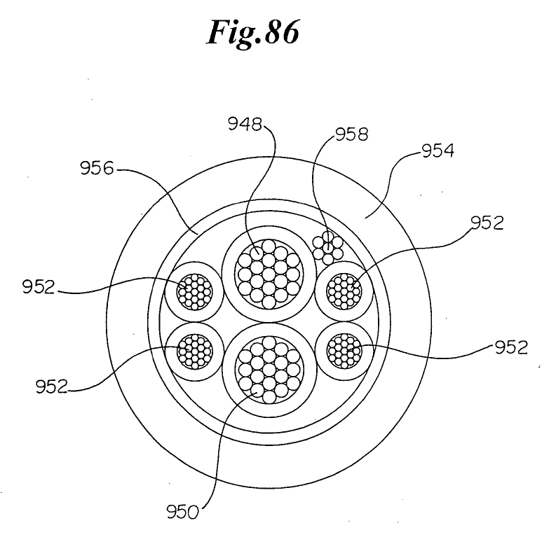

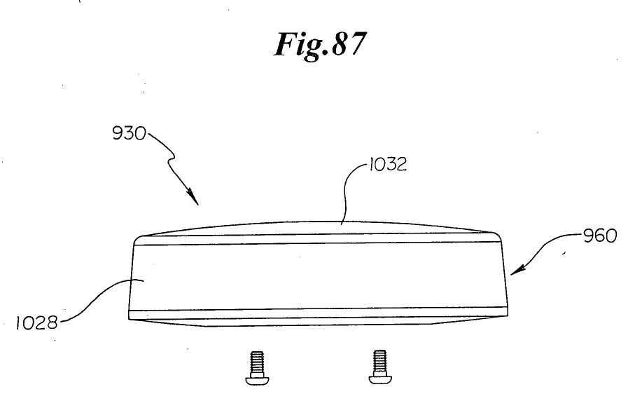

In general, opposite to disconnectable plug 936 is located a coupler 946 which is preferably adapted to be hardwired into a vehicle electrical system. Disconnectable plug 936 may be removably engaged to a vehicle electrical system by a conventional electrical connector such as a cigarette lighter penetrating adaptor. The coupler 946 is generally a universal type of connector including 1 to 8, and preferably 6 conductors (FIG. 86).

In general, conductor 948 is for the provision of power, conductor 950 is for ground, and conductors 952 are utilized to signal the initiation of different pattern arrangements of LED light signals as may be regulated by controller 50 integral to LED support 942. The pattern arrangements of LED light signals may be identical to the light signals as earlier described including the use of modulated, and/or variable illumination light signals. The conductors 948, 950, and 952, are preferably electrically connected to a 12 volt power supply as provided by a vehicle electrical system and/or battery.

The wire harness 932, preferably includes an outer jacket protector 954 which may be coated with polyvinylchloride or PVC.

The power conductor 948 and ground conductor 950 are preferably formed of 16 gauge wire and the conductors 952 are preferably formed of 22 gauge wires.

The wire harness 932 also preferably includes an inner insulation shield 956 which may be formed completely or partially of foil or Mylar having an aluminized coating. In addition, the wire harness 932 may include an unjacketed drain 958. The inner insulation shield 956 and the drain 958 preferably function to reduce RF radio frequency interference within a vehicle radio and/or communication system as the 360° pod 930 is activated or deactivated. The activation and/or deactivation of the power provided to the power conduit 948 and ground 950 may cause radio interference. This radio interference is preferably captured by the shield 956 and drain 958 to improve RF radio performance for the vehicle by reducing RF noise.

The wire harness 932 may be positioned within and engaged to a strain relief fitting 960. The strain relief fitting 960, if utilized, is preferably positioned within the aperture 938 of the mounting base 940. The strain relief fitting 960 preferably assists to create a water tight seal to prevent water entering into the interior of the mounting base 940 for exposure to the LED support 942.

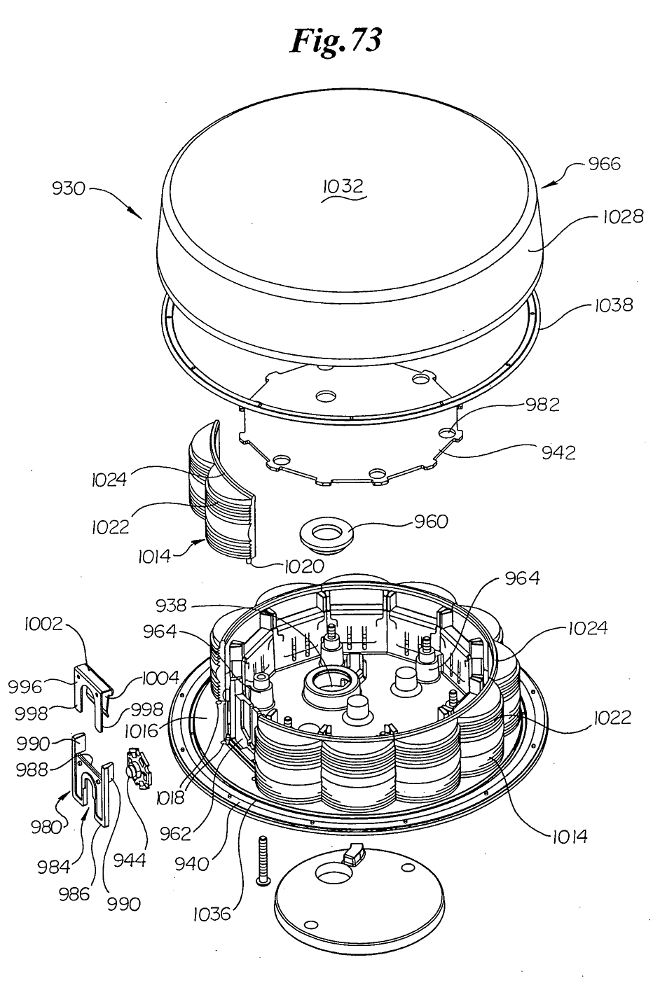

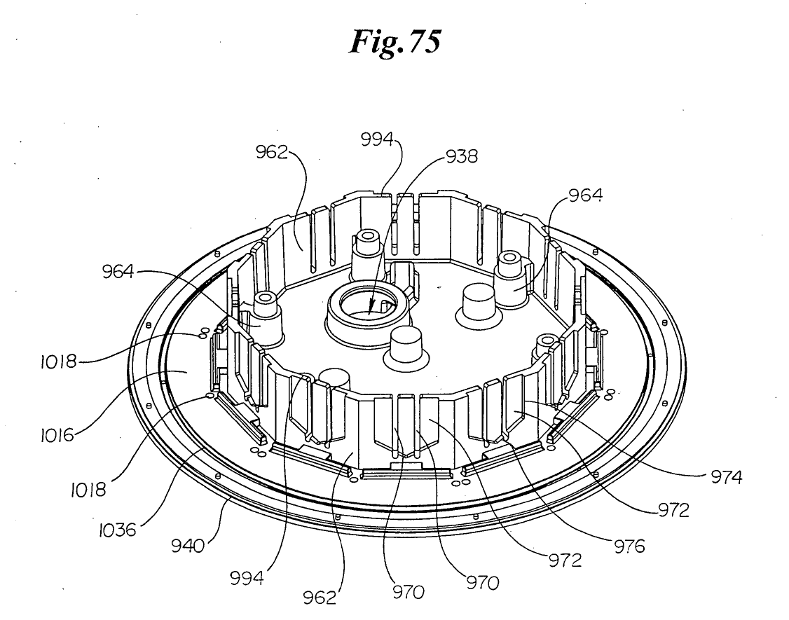

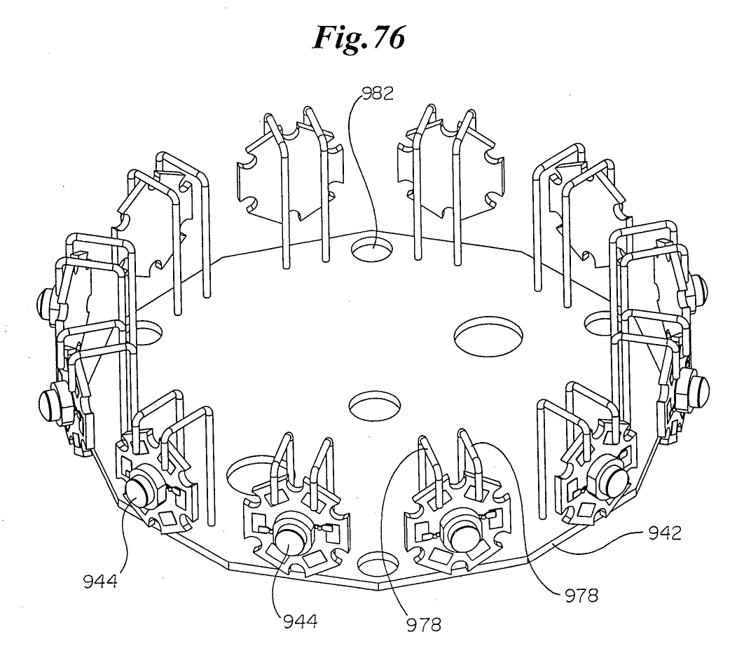

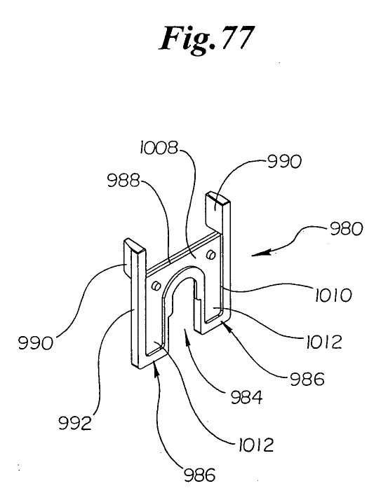

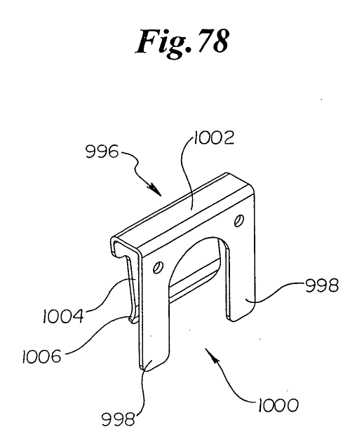

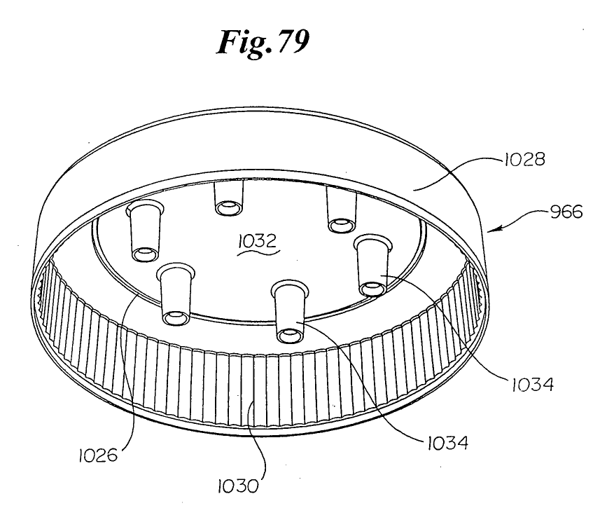

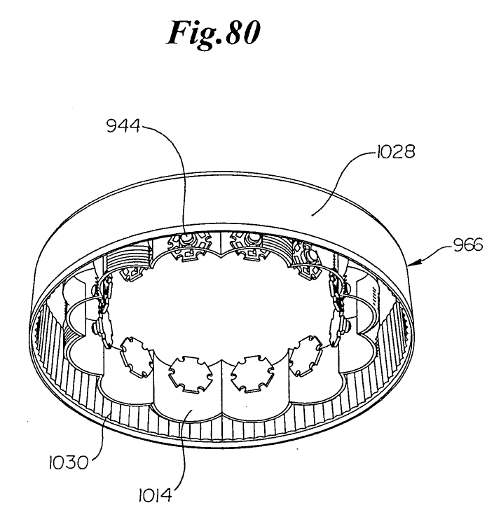

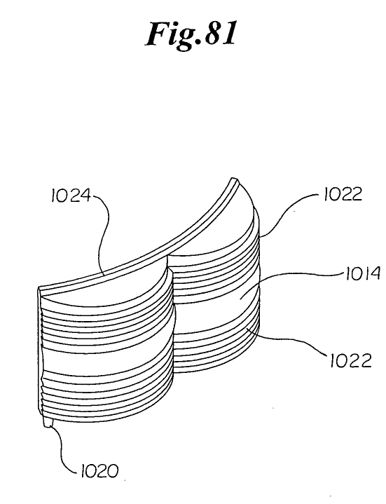

As may be seen in FIGS. 73, 74, and 75, the mounting base 940 is shown. The mounting base 940 is preferably formed of die cast aluminum and includes between 8 and 16, and preferably 12, LED mounting facets 962. Each LED mounting facet 962 is adapted to receivingly position one LED light source 944. Each LED mounting facet 962 preferably facilitates illumination outwardly from the mounting base 940 at an approximate viewing angle or view arc of 30°, so that 12 LED mounting facets 962 provide for 360° illumination for the 360° pod 930.

The mounting base 940 preferably includes a number of screw bosses 964 which are adapted to receivingly retain a lens cover 966. The screw bosses 964 may also be utilized to securely position the LED support 942 within the interior of the mounting base 940.

The underside of the mounting base 940 preferably includes a number of heat transfer members 968 which assist in the dissipation of any heat as generated during operation of the LED light sources 944 and as transferred through the screw bosses 964 and/or mounting base 940.

Each LED mounting facet 962 preferably includes a pair of vertical slots 970 and a first recessed area 972. The first recessed area 972 preferably includes a pair of vertical edges 974 and a V-shaped bottom edge 976.

A pair of wires 978 are generally electrically connected to each LED 944. Each of the wires 978 is preferably positioned within one of the slots 970. An LED 944 is preferably centrally positioned within one of the first recessed areas 972 of the LED mounting facets 962. The wires 978 as engaged to the LED's 944 pass from the exterior of the LED mounting facet 962 into the interior of the mounting base 940 for electrical connection to the LED support 942. The wires 978 are preferably secured to the LED support 942 by a suitable electrical connection which may include soldering.

During assembly, the LED light sources 944 extend outwardly from the LED support 942 in a substantially horizontal plane. The LED support 942 is then positioned vertically above mounting base 940 where wires 978 are vertically aligned with a respective slot 970. The LED support 942 is then lowered to the interior of the mounting base 940 where the wires 978 pass vertically downward through a respective slot 970. Affixation apertures 982 of the LED support are preferably aligned with the screw bosses 964 for receipt of a suitable fastener which may be a screw of bolt. The LED's 944 are then bent upwardly for positioning of the back of the LED's 944 adjacent to the exterior face of a respective first recessed area 972.

An insulator clip 980 as depicted in FIG. 73 is preferably positioned over each LED 944 to hold the LED 944 against the exterior face of each first recessed area 972. Each insulator clip 980 is preferably formed of plastic, nylon, or other non-electrically conductive material.

Each insulator clip 980 includes an upside down substantially U-shaped LED receiving channel 984 defining a pair of legs 986. The insulator clip 980 preferably includes a top edge 988. A pair of positioning tabs or flags 990 are above the top edge 988 and proximate to each exterior side 992 of the insulator clip 990. The U-shaped LED receiving channel 984 is positioned over the LED's 944. The pair of positioning tabs or flags 990 are generally positioned over the top edge 994 of an individual LED mounting facet 962.

The insulator clip 980 has a forward face 1008 which is opposite to the direction of the extension of the positioning tabs or flags 990. The insulator clip 980 also includes a perimeter ledge 1010 which extends from each positioning tab or flag 990 downwardly around each leg 986 and around the substantially U-shaped LED receiving channel 984. The surface of each leg 986 is recessed with respect to the perimeter ledge 1010 creating a pair of prong receiving pockets 1012.

A retaining clip 996 which may be formed of spring steel or stainless steel is preferably positioned over each LED mounting facet 962, insulator clip 980, and LED's 944. The retaining clip 996 slides downwardly over the top edge 994 of the LED mounting facets 962 and top edge 988 of the insulation clip 990 to restrain the insulator clip 980 to sandwich the LED's 994 between the insulator clip 980 and the exterior face of the first recessed area 972 of the LED mounting facets 962.

Each retaining clip 996 includes a pair of prongs 998 defining an upside down U-shaped slot 1000. The prongs 998 are positioned proximate to the exterior face, and are positioned proximate to the LED's 944 within a respective prong receiving pocket 1012 of an insulator clip 980. Each retaining clip 996 additionally includes a top transition bridge 1002 adapted for positioning over the top edge 994 of the LED mounting facets 962 and the top edge 988 between the positioning flags 990 of the insulator clip 980. A grasping tab 1004 extends downwardly from the transition bridge 1002 which is adapted for positioning within the interior of the mounting base 940 proximate to the interior surface of a respective LED mounting facet 962. Each grasping tab 1004 preferably extends downwardly and inwardly toward the rear surface of the prongs 998 to establish the grasping tension to secure the prongs 998 within the prong receiving pockets 1012 to securely hold the LED's 994 against the exterior face of a respective LED mounting facet 962. Each grasping tab 1004 may also include an outwardly diverging lower lip 1006 which may be used to assist in the downward placement of the retaining clip 996 and the separation of the grasping tab 1004 from the prongs 998, to establish the tension between the prongs 998 and the grasping tab 1004, to hold the LED's 944 and the insulator clip 980 against the LED mounting facets 962.

A plurality of Fresnel lens segments 1014 are positioned to the exterior of LED mounting facets 962 upon the mounting base 940. Each Fresnel lens segment 1014 is positioned on a lens receiving ledge 1016 which is substantially circular and which is adjacent to the LED mounting facets 962. A plurality of pin or peg holes 1018 are regularly spaced along the lens receiving ledge 1016 which are adapted to receivingly hold registration pegs or pins 1020 as integral to, and extending downwardly from the bottom of each Fresnel leg segment 1014.

Each Fresnel lens is preferably arcuate or curved in shape where a pair of curved Fresnel lens elements form each Fresnel lens segment 1014. Each Fresnel lens element is semi-circular in shape and includes horizontally extending ridges 1022. The Fresnel lens segments 1014 preferably function as the light spreaders to blend light emanating from adjacent LED light sources 944 into a homogenous observed light signal without observable hot spots.

Within the 360° pod 930 preferably six Fresnel lens segments 1014 are provided, where each Fresnel lens segment 1014 includes two Fresnel lenses. The Fresnel Lens segments 1014 are positioned in a substantially circular orientation around and proximate to the LED mounting facets 962. Each Fresnel lens segment 1014 preferably includes three registration pins or pegs 1020 for positioning within a respective pin or peg hole 1018.

Each Fresnel lens segment 1014 preferably includes an upper rib 1024. Each upper rib 1024 of adjacent Fresnel lens segments 1014 preferably joins to form a positioning ring. Each upper rib 1024 is preferably adapted to be inserted within a channel pocket 1026 which is depressed within the interior top surface of the lens cover 996. The channel pocket 1026 preferably receives the upper rib 1024 of each Fresnel lens segment 1014 to securely position the top of each Fresnel lens segment 1014 relative to the lens cover 996. Simultaneously, the registration pins or pegs 1020 as engaged to the pin holes 1018 function to securely position the bottom of each Fresnel lens segment 1014 relative to the lens receiving ledge 1016 and the mounting base 940.

Each Fresnel lens segment 1014 is substantially transparent permitting light passage therethrough as bent and blended with light illuminated from adjacent LED's 944 on LED mounting facets 962.

The Fresnel lens segments 1014 function as the primary optics for illuminated light for the LED's 944. The secondary optics for the 360° pod 930 are provided by the lens cover 966. The lens cover 966 is preferably formed of substantially transparent polycarbonate material or Lexan LS1 polycarbonate material.

The lens cover 966 includes a wall section 1028. To the interior of wall section 1028 are preferably located a plurality of vertically extending flutes 1030 which function as light spreaders to diffuse light as generated by the LED's 944 and as passing through the Fresnel lens segments 1014. The exterior of the wall section 1028 and lens cover 966 is preferably smooth. The fluting 1030 on the interior of the wall sections 1028 preferably optically sculpts the light for compliance with SAE codes and regulations.

The lens cover 966 includes a top 1032. A plurality of second screw bosses 1034 depend downwardly from the interior of the top 1032 for mating with the screw bosses 964 extending upwardly from the interior of the mounting base 940. Six second screw bosses 1034 preferably extend downwardly from the top 1032 for mating with the six screw bosses 964 extending upwardly from the mounting base 940. The second screw bosses 1034 are preferably molded and are integral to the top 1032 of the lens cover 966. The second screw bosses 1034 may include brass inserts.

The mounting base 940 preferably includes an outer gasket channel 1036 which is adapted to receive a circular gasket 1038. The circular gasket 1038 is preferably positioned between the mounting base 940 and the lens cover 966 to create a seal and to prevent moisture penetration and contamination therethrough. The gasket 1038 is preferably formed of silicone or other rubber material.

Referring to FIG. 90, an LED support 942 is shown. LED support 942 preferably includes 12 secondary LED's 1056 regularly spaced about LED support 942. The LED support 942 also preferably includes six affixation apertures 982 which are adapted to receive either screw bosses 964 or second screw bosses 1034. Controller 50 is preferably integral to LED support 942. Controller 50 includes a plurality of light illumination signals and/or patterns or combinations of light signals as earlier described.

Generally, secondary LED's 1056 are engaged to LED support 942 by affixation posts 1060. Proximate to controller 50 is the crystal oscillator or timer circuit 1062 which interacts with controller during the provision of a desired type of light signal. A shut-off 1064 or P-channel mosfet is used to deliver power for operation of the 360° pod 930. Shut-off 1064 terminates power on the occurrence of certain conditions such as an electrical power surge in excess of a pre-selected level and/or upon the receipt of a signal that the provision of a light signal is to cease. Regulators 1066 or N-channel mosfets are also provided on LED support 942. The regulators 1066 or N-channel mosfets monitor the current provided to the LED's 944 to insure that the LED's do not receive in excess of amount of electrical current sufficient to cause damage. A linear or voltage regulator 1068 functions to regulate the electrical current provided to the controller 50 and the oscillator 1062. Generally, the voltage regulator 1068 limits power to the controller 50 and oscillator 1062 to approximately five volts.

An access port 1070 is used for reprogramming of controller 50 to modify the pre-stored light signal patterns to be illuminated by 360° pod 930. The electrical inputs 1072 are the location on LED support 942 where coupler 946 attaches wire harness 932 to LED support 942. Power interface 1072 for LED support 942 is proximate to access port 1070. Ground interface 1074 is also proximate to power interface 1072 and access port 1070. LED support 942 also may include fuse 1076 to protect LED support 942 from a catastrophic electrical event. Fuse 1076 may be a 7 amp or 10 amp fuse at the discretion of an individual.

The 12 secondary LED's 1056 preferably provide illumination vertically upward out of the top 1032 of the lens cover 966. The secondary LED's 1056 may be continuously illuminated to provide a running light for a vehicle. The secondary LED's 1056 may also be in communication with a controller 50 to emit light as a portion of a warning light or other light signal for the 360° pod 930. When the 360° pod 930 is utilized in association with a law enforcement motorcycle, then secondary LED's 1056 may emit light in the blue wavelength region. Alternatively, the secondary LED lights 1056 may emit light in the amber wavelength region, or any other color wavelength to function as a running light or an anti-collision light for a vehicle. The interior and exterior of the top 1032 of the lens cover 966 may be frosted to assist in the provision of an even glow when the secondary LED's 1056 are utilized as a running and/or anti-collision light. The secondary LED's 1056 due to the primary illumination being emitted vertically, as opposed to horizontally, are generally not a component of a warning light signal and are therefore not required to satisfy SAE or J approval codes.

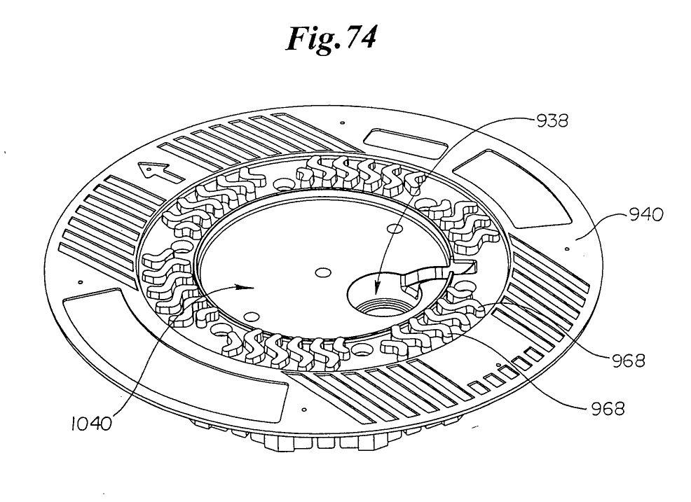

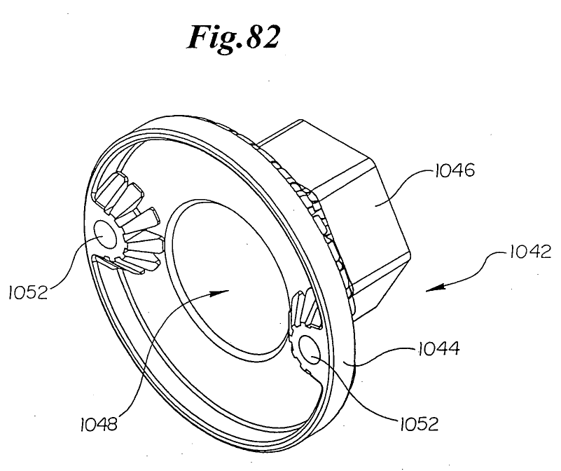

Referring to FIG. 74, the bottom of mounting base 940 includes a central recess 1040 which is preferably circular in shape. A pole mount 1042 (FIG. 82) includes a circular skirt 1044 which is sized and adapted for positioning within the central recess 1040 for releasable affixation thereto. The pole mount 1042 includes a pole supporting collar 1046 having a central opening 1048 therethrough. The central opening 1048 is adapted to receive a pole which, in turn, is utilized to support the 360° pod 930 at a desired location above or relative to a vehicle. Examples of types of vehicles include, but are not necessarily limited to, motorcycles, snow plows, road graders, dump trucks, or other types of utility or emergency vehicles.

The circular skirt 1044 preferably includes at least two affixation apertures 1052 which may be utilized to releasably secure the pole mount 1042 to the central recess 1040 and the mounting base 940. The pole support collar 1046 may also include a mechanical rotation restriction member which prevents rotation of the 360° pod 930 relative to a pole. The pole mount 1042 may be formed of nylon glass filled plastic material or any other type of metal and/or plastic material and may include a one inch straight pipe brass insert. The straight pipe brass insert preferably permits the pole mount 1042 to be screwed to a pipe having a one inch diameter.

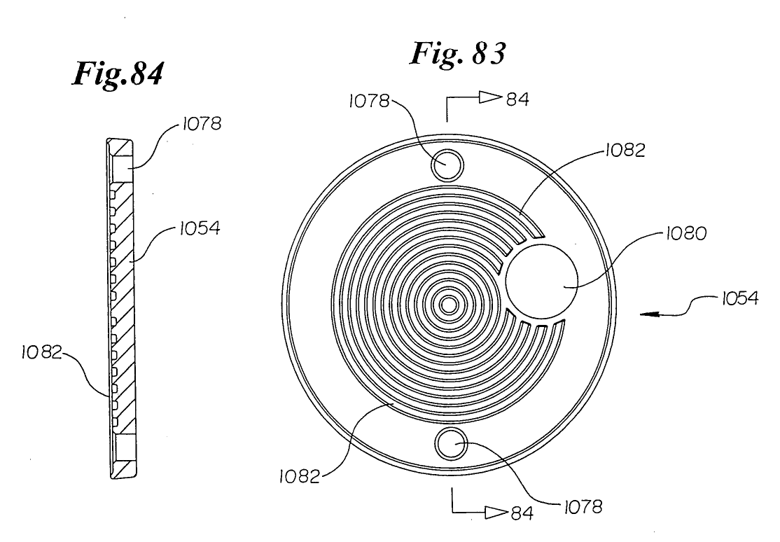

Referring to FIG. 83 a circular gasket 1054 may be stamped of neoprene or EPDM material which in essence is a rubber or rubberized pad. The circular gasket 1054 isolates the mounting base 940 which may be formed of aluminum from the surface of a vehicle or other surface in which the 360° pod 930 is to be mounted upon. The mounting base 940 may be secured to a surface of a vehicle by the positioning of the gasket 1054 within the central recess 1040 and then securing the mounting base 940 to the vehicle or other surface through the use of threaded bolts, bolts and nuts, and/or screws.

The circular gasket 1054 may include affixation apertures 1078 which are preferably aligned to apertures 1054. A wire harness 1080 is preferably aligned with apertures 938. The circular gasket 1054 also preferably includes a plurality of ribs 1082 which assist in preventing slipping of the gasket 1054 relative to a mounting surface such as a vehicle.

In an alternative embodiment, a circular gasket 1054 may be positioned within the central recess 1040 whereupon a substantially circular magnet 1058 may be screwed to the mounting base 940. In general, the circular magnet 1058 is of the ring or donut type as included within a ferrite cup which has been plated for attachment to a base. The magnet 1058 is initially believed to be of sufficient strength to exert an attractive force of 100 lbs. to an object. The magnet 1058 may include a protective coating of plastic or Mylar to reduce the scratching of a surface. The magnet 1058 may be positioned proximate to a surface for positioning of the 360° pod 930 relative to a vehicle through the use of magnetic attraction. A second gasket may be positioned between the magnet 1058 and the attachment surface to minimize risk of scratching. A circular gasket 1054 may also be positioned in the central recess 1040 prior to the positioning of the circular skirt 1044 of the pole mount 1042. Generally, the circular gasket 1054 electrically isolates either the pole mount 1042 and/or the mounting base 940 from a surface, while simultaneously providing vibration protection. In addition, the circular gasket 1054 avoids direct contact between dissimilar metals which may be in contact with each other to avoid metal degradation, stress, and/or fatigue.

In general, the overall dimensions for the 360° pod 930 are approximately 7¼ inches in diameter and 2 inches in height.

In one embodiment, disconnectable plug 936 is a cigarette lighter adapter which may include a rocker switch. In general, the rocker switch may have three positions, a forward position which may be for a continuous signal, a middle position which may be off, and a rear position which may be for a momentary signal, where as long as the rear position is retracted/depressed it will continue to be operational. However, upon release from the rear position, the switch will return to the middle or off position. In the forward position, the controller 50 will initiate illumination of a desired light signal and/or pattern of light signals which will repeat until such time as the rocker switch is returned to a middle and/or off position.

With respect to the rear position, in further detail, generally every time the rear position of the rocker switch is depressed, the switch will toggle through a different signal or flash pattern as integral to controller 50. Upon the selection of a desired signal and/or flash pattern as available for controller 50, the switch is rocked forward which will initiate the illumination of the selected signal until such time as a replacement signal is engaged. The toggle of the rocker switch to the rear position selects the default light signal pattern which is illuminated when the switch is manipulated into the operational or forward position for execution. The disconnectable plug 936 may also include an indicator to signal to an individual that power is available through the wire harness 932 to the 360° pod 930.

In general, controller 50 maintains the selected light signal and/or light signal pattern as the default signal upon actuation of the rocker switch from the forward position to the central off position and the reactivation of the rocker switch forward to the operational position. In this manner, the controller 50 includes a memory to avoid the necessity for an individual to re-toggle through all previous available light or signal patterns to reinitiate illumination of a desired signal. The light signal/pattern to be illuminated by the controller 50 generally is only changed through the toggle function of the rearward position of the rocker switch.

In general, the controller 50 includes a reprogrammable feature where light signals/patterns may be erased/eliminated and replaced with the identical and/or new light signals and/or patterns of light signals. In this instance a remote processing unit is required to be coupled to the LED support 942 via a port connector to effectuate downloading of light signals and/or patterns of light signals for the reprogramming of controller 50.

In general, it is contemplated that controller 50 will hold between 15 and 20 different light signals and/or patterns of light signals for selection through the use of the rocker switch of disconnectable plug 936. In an alternative embodiment, controller 50 may include as few as four or five signals and/or patterns of signals as approved by SAE for compliance with industry standards. However, in this embodiment, controller 50 is of sufficient size to hold additional non-SAE compliance light signals and/or patterns of light signals at the discretion of an end user. In a different embodiment, controller 50 may include light signals and/or patterns of light signals which are directed to specific applications for a particular industry and/or color of light signal.

In an alternative embodiment, the disconnectable plug 936 may be another type of electrical connector or may alternatively be eliminated for electrical connection directly into a power source. In the embodiment where the wire harness 932 does not utilize a disconnectable plug 936 and is directly wired into a power source, then controller 50 has been set to a desired number of default settings. In this embodiment, the power provided to the 360° pod 930 is applied when an electrical switch within a vehicle has been activated, which in turn triggers the controller 50 to initiate illumination of the default light signal and/or illumination pattern. For example, when the 360° pod 930 is utilized within a snow plow, the wire harness 932 may be electrically coupled to the headlight switch for the vehicle, where activation of the headlights simultaneously activates the default LED light signal and/or LED pattern of light signals as regulated by controller 50. In addition, a second electrical connection may be made to a switch for an accessory light signal within a vehicle which, when activated, would trigger the illumination of a second default light signal and/or pattern of light signals as directed by controller 50. In this embodiment, controller 50 may be programmed for any desired number of default LED light signals and/or patterns of light signals. In this embodiment, controller 50 is also programmed to establish a hierarchy for the default light signals and/or patterns of light signals. For example, when both a headlight switch is activated and an accessory light switch is activated, then the controller 50, depending upon the desired programming, may regulate the illumination of a first default light signal and/or pattern of light signals; a second default light signal and/or pattern of light signals; or may be programmed to initiate illumination of a third default light signal or pattern of light signals. The number of alternatives and options for the illumination of a desired type of LED light signal/patterns of light signals is extremely extensive.

In an alternative embodiment, the wire harness 932 may omit the use of the disconnectable plug 936, or may use a standard electrical connector, where the wire harness 932 is in communication with a central control or switch box. In this embodiment, an individual may select one of the many prestored illumination signals and/or patterns of light signals of the controller 50 by activation of switches upon the switch box. The switch box may include a plurality of pin high/pin lo switches which when activated provides an electrical pathway for generation of a signal or pattern of signals from the controller 50. In this embodiment, the controller 50 will also likely include a pre-programmed hierarchy of default illumination signals and/or patterns of light signals to assist in the provision of a desired signal or pattern of signals to comply with the selection of an end user.

Generally, the wire harness 932 and the 360° pod 930 is configured for operation upon receipt of a standard 12 volt power supply. In addition, the controller 50 generally contains prestored operational parameters for different types of LED's 944 and different colors of LED's 944 to maximize illumination output. The controller 50 is also generally sufficiently sophisticated to recognize electrical parameters for different colored LED's 944, however, the controller 50 may be coupled to an external controller 55 when information concerning the type and color of LED's 944 to be illuminated is provided. Generally, blue, white, and green, LED's 944 have a higher forward voltage as opposed to red and/or amber LED's 944. Therefore, LED light sources of blue, green, and/or white color are generally grouped for control by the controller 50 into circuits of two LED light sources 944. Red and/or amber LED's 944 are generally grouped for control by controller 50 into circuits of three LED light sources 944.

In one embodiment of the 360° pod 930, 50% of the LED light sources 944 will be of one color and the other 50% of the LED light sources 944 will be of a different color. In this embodiment, like colored LED's 944 will be adjacent to each other where the 360° pod 930 is generally divided in half. Alternatively, the LED's 944 may alternate in color within the 360° pod 930. In one embodiment, the 360° pod 930 may be divided where an arc between 0° and 180° is provided with red LED light sources 944 and the arc of 181° to 359° is provided with blue LED light sources 944.

The LED's 944 provided within the 360° pod 930 may be modular as earlier described and/or may be affixed to the circuit board/LED support 942 by conventional electrical connectors such as soldering.

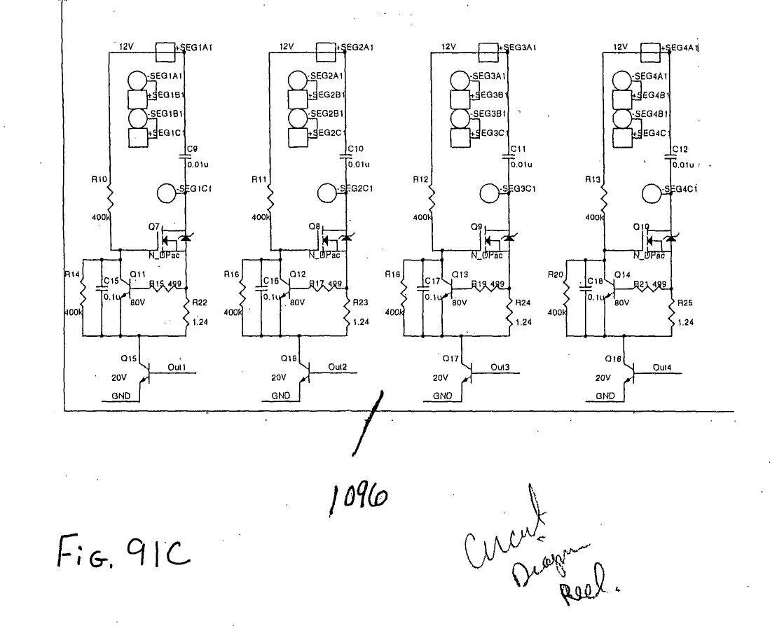

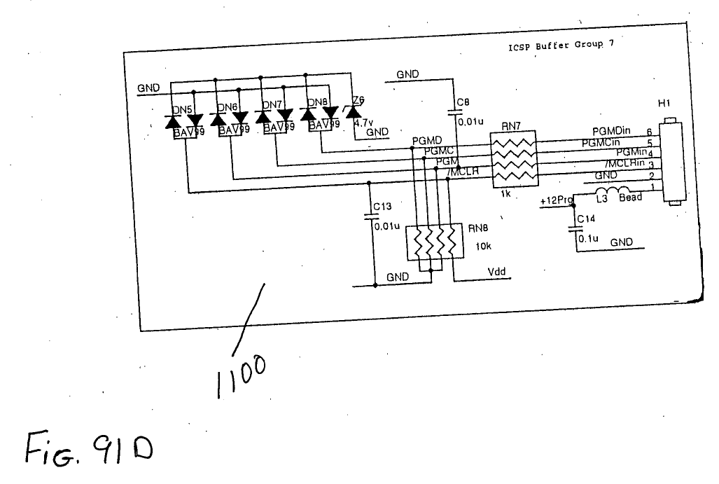

Referring to FIG. 91A-91E, an alternative electrical schematic for the 360° pod 930 is provided.

The electrical schematic for the 360° pod 930 generally begins with power inlet electrical connectors 1072. The power inlet connectors 1072 are proximate to the first line of input protection against electrical transience. Z-1 may be a bi-directional TVS to be utilized for protection against electrical transience. Directly below the power inlet 1072 is the input buffer group 1084. The input buffer group 1084 is formed of a plurality of diodes and may include a Zener diode to protect the microcontroller 50. The diodes may be independently utilized, or may be provided in one package. The input buffer group 1084 is preferably used as a buffer against electrical transience and is used to limit the voltage of the input signals going to the microcontroller or controller 50. Power protection group 1086 provides over voltage protection and monitors the inputs so that in the absence of inputs, the power protection group 1086 shuts power off to the system. The power protection group 1086 is also used to protect against electrical transience which are not rectified by the power group 1 and the bi-directional TVS. Power protection group 2 has over-voltage shut-off protection through R2, R3 designated at 1098 and the PNPBJT used in QN1. R5, R6 and the NPNBJT may be used to switch power to on only when an adequate voltage is applied to one of the inputs.

Regulator group 5-1088 regulates the power to the controller 50 and oscillator circuits. PIC group 9-1090 includes the controller 50 and the buffers for the inputs and outputs for the controller 50. Oscillator group 8-1092 provides the clock signal to the controller 50.

Indicator LED's 1094 is the circuit which provides electrical connection for the secondary LED's 1056. Operational LED's 1096 include the circuitry for the LED's 944 which include the slope control which assists to prevent the LED's 944 from being turned on at an undesirable level which may emit radio frequency noise. The current regulation system is generally identified as R11, Q5, Q9, R16, and R23 within one operational LED circuit 1096. The slope controls are generally identified as C9, C15, C14, and R14 within operational LED circuit 1096. An over-voltage shutoff 1098 is also provided to terminate power to the electrical system when the voltage is elevated to an undesirable level. The ICSP buffer group 7 1100 is a port which is used by the user to program the product employing the use of standard input buffering techniques.

Having thus described the preferred embodiments in sufficient detail as to permit those of skill in the art to practice the present invention without undue experimentation, those of skill in the art will readily appreciate other useful embodiments within the scope of the claims hereto attached. For example, although the present invention has been described as useful for the meat meal rendering industry, those of skill in the art will readily understand and appreciate that the present invention has substantial use and provides many benefits in other industries as well. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

In addition to being directed to the embodiments described above and claimed below, the present invention is further directed to embodiments having different combinations of the features described above and claimed below. As such, the invention is also directed to other embodiments having any other possible combination of the dependent features claimed below.

The above examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

The present invention may be embodied in other specific forms without departing from the spirit or essential attributes thereof; and it is, therefore, desired that the present embodiment be considered in all respects as illustrative and not restrictive, reference being made to the appended claims rather than to the foregoing description to indicate the scope of the invention.

1. A pod illumination device comprising:
a) a base having a plurality of LED mounting surfaces, said LED mounting surfaces extending upwardly from said base;
b) an LED support engaged to said base;
c) a plurality of light emitting diodes arranged about and attached to said LED mounting surfaces, said plurality of light emitting diodes being in communication with said LED support;
d) a controller in electric communication with said plurality of light emitting diodes, the controller constructed and arranged to activate said plurality of light emitting diodes to produce a light signal, said plurality of light emitting diodes receiving power from a power source; and
e) a cover, said cover enclosing said base, said LED support, said plurality of light emitting diodes, and said controller.

2. The pod illumination device according to claim 1, at least one of said LED mounting surfaces comprising at least one slot.

3. The pod illumination device according to claim 2, at least one of said plurality of light emitting diodes comprising a wire traversing said at least one slot.

4. The pod illumination device according to claim 3, wherein said LED mounting surfaces define an outward face, said plurality of light emitting diodes being engaged to said outward face.

5. The pod illumination device according to claim 4, said pod illumination device further comprising an insulator clip, said insulator clip being constructed and arranged to position one of said light emitting diodes between said insulator clip and said outward face.

6. The pod illumination device according to claim 5, said pod illumination device further comprising a retaining clip, said retaining clip being constructed and arranged to releasably secure said insulator clip and at least one of said plurality of light emitting diodes to said outward face of one of said LED mounting surfaces.

7. The pod illumination device according to claim 6, said pod illumination device further comprising a plurality of lens segments, said plurality of lens segments being engaged to said base proximate to said plurality of light emitting diodes.

8. The pod illumination device according to claim 7, wherein said lens segments are constructed and arranged to blend light emitted from said plurality of light emitting diodes.

9. The pod illumination device according to claim 6, said cover comprising a plurality of flutes, said flutes constructed and arranged to blend light emitted from said plurality of light emitting diodes.

10. The pod illumination device according to claim 7, said cover comprising a top, said top comprising a groove, a portion of said lens segments being engaged to said groove.

11. The pod illumination device according to claim 6, said pod illumination device further comprising a pole mount, said pole mount being engaged to said base.

12. The pod illumination device according to claim 6, said pod illumination device further comprising a magnet, said magnet being engaged to said base.

13. The pod illumination device according to claim 6, said pod illumination device further comprising a gasket engaged to said base.

14. The pod illumination device according to claim 6, said LED mounting surfaces comprising a plurality of second light emitting diode illumination sources, said second light emitting diode illumination sources constructed and arranged to illuminate light vertically from said LED support.
